(19) United States
(12) Patent Application Publication
(10) Pub. No.: US 2022/0129556 A1
(43) Pub. Date: Apr. 28, 2022

(54) Systems and Methods for Implementing Smart Assistant Systems

(71) Applicant: Facebook, Inc., Menlo Park, CA (US)

(72) Inventors: Zhiyu Chen, Goleta, CA (US); Honglei Liu, Santa Clara, CA (US); Hu Xu, Bellevue, WA (US); Seungwhan Moon, Seattle, CA (US); Hao Zhou, Menlo Park, CA (US); Bing Liu, Mountain View, CA (US); Zihang Meng, Madison, WI (US); Amy Lawson Bearman, Emerald Hills, CA (US); Ahmed Magdy Hamed Mohamed, Kirkland, WA (US); Eric Robert Northup, Zurich (CH); Jihang Li, Bothell, WA (US); Jinsong Yu, Bellevue, WA (US); Jeremy Gillmor Kahn, Seattle, WA (US); Lloyd Hilaiel, Denver, CO (US); Justin Denney, San Francisco, CA (US); Christophe Chaland, San Francisco, CA (US)

(21) Appl. No.: 17/512,478

(22) Filed: Oct. 27, 2021

Related U.S. Application Data
(60) Provisional application No. 63/106,819, filed on Oct. 28, 2020.
(60) Provisional application No. 63/133,021, filed on Dec. 31, 2020.
(60) Provisional application No. 63/136,162, filed on Jan. 11, 2021.
(60) Provisional application No. 63/162,398, filed on Mar. 17, 2021.
(60) Provisional application No. 63/165,058, filed on Mar. 23, 2021.

(51) Int. Cl. G06F 21/57; G06F 3/16; G06K 9/46; G06K 9/62; G06F 21/60

(52) U.S. Cl. CPC G06F 21/57; G06F 3/167; G06F 2221/033; G06K 9/6262; G06F 21/602; G06K 9/46

(57) ABSTRACT

In one embodiment, a system includes an automatic speech recognition (ASR) module, a natural-language understanding (NLU) module, a dialog manager, one or more agents, an arbitrator, a delivery system, one or more processors, and a non-transitory memory coupled to the processors comprising instructions executable by the processors, the processors operable when executing the instructions to receive a user input, process the user input using the ASR module, the NLU module, the dialog manager, one or more of the agents, the arbitrator, and the delivery system, and provide a response to the user input.

### PRIORITY

This application claims the benefit under 35 U.S.C. § 119(e) of U.S. Provisional Patent Application No. 63/106,819, filed 28 Oct. 2020, U.S. Provisional Patent Application No. 63/133,021, filed 31 Dec. 2020, U.S. Provisional Patent Application No. 63/136,162, filed 11 Jan. 2021, U.S. Provisional Patent Application No. 63/162,398, filed 17 Mar. 2021, U.S. Provisional Patent Application No. 63/165,058, filed 23 Mar. 2021, each of which is incorporated herein by reference.

### TECHNICAL FIELD

This disclosure generally relates to databases and file management within network environments, and in particular relates to hardware and software for smart assistant systems.

### BACKGROUND

An assistant system can provide information or services on behalf of a user based on a combination of user input, location awareness, and the ability to access information from a variety of online sources (such as weather conditions, traffic congestion, news, stock prices, user schedules, retail prices, etc.). The user input may include text (e.g., online chat), especially in an instant messaging application or other applications, voice, images, motion, or a combination of them. The assistant system may perform concierge-type services (e.g., making dinner reservations, purchasing event tickets, making travel arrangements) or provide information based on the user input. The assistant system may also perform management or data-handling tasks based on online information and events without user initiation or interaction. Examples of those tasks that may be performed by an assistant system may include schedule management (e.g., sending an alert to a dinner date that a user is running late due to traffic conditions, update schedules for both parties, and change the restaurant reservation time). The assistant system may be enabled by the combination of computing devices, application programming interfaces (APIs), and the proliferation of applications on user devices.

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. profile/news feed posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

In particular embodiments, the assistant system may assist a user to obtain information or services. The assistant system may enable the user to interact with the assistant system via user inputs of various modalities (e.g., audio, voice, text, image, video, gesture, motion, location, orientation) in stateful and multi-turn conversations to receive assistance from the assistant system. As an example and not by way of limitation, the assistant system may support mono-modal inputs (e.g., only voice inputs), multi-modal inputs (e.g., voice inputs and text inputs), hybrid/multi-modal inputs, or any combination thereof. User inputs provided by a user may be associated with particular assistant-related tasks, and may include, for example, user requests (e.g., verbal requests for information or performance of an action), user interactions with an assistant application associated with the assistant system (e.g., selection of UI elements via touch or gesture), or any other type of suitable user input that may be detected and understood by the assistant system (e.g., user movements detected by the client device of the user). The assistant system may create and store a user profile comprising both personal and contextual information associated with the user. In particular embodiments, the assistant system may analyze the user input using natural-language understanding (NLU). The analysis may be based on the user profile of the user for more personalized and context-aware understanding. The assistant system may resolve entities associated with the user input based on the analysis. In particular embodiments, the assistant system may interact with different agents to obtain information or services that are associated with the resolved entities. The assistant system may generate a response for the user regarding the information or services by using natural-language generation (NLG). Through the interaction with the user, the assistant system may use dialog-management techniques to manage and advance the conversation flow with the user. In particular embodiments, the assistant system may further assist the user to effectively and efficiently digest the obtained information by summarizing the information. The assistant system may also assist the user to be more engaging with an online social network by providing tools that help the user interact with the online social network (e.g., creating posts, comments, messages). The assistant system may additionally assist the user to manage different tasks such as keeping track of events. In particular embodiments, the assistant system may proactively execute, without a user input, tasks that are relevant to user interests and preferences based on the user profile, at a time relevant for the user. In particular embodiments, the assistant system may check privacy settings to ensure that accessing a user's profile or other user information and executing different tasks are permitted subject to the user's privacy settings.

In particular embodiments, the assistant system may assist the user via a hybrid architecture built upon both client-side processes and server-side processes. The client-side processes and the server-side processes may be two parallel workflows for processing a user input and providing assistance to the user. In particular embodiments, the client-side processes may be performed locally on a client system associated with a user. By contrast, the server-side processes may be performed remotely on one or more computing systems. In particular embodiments, an arbitrator on the client system may coordinate receiving user input (e.g., an audio signal), determine whether to use a client-side process, a server-side process, or both, to respond to the user input, and analyze the processing results from each process. The arbitrator may instruct agents on the client-side or server-side to execute tasks associated with the user input based on the aforementioned analyses. The execution results may be further rendered as output to the client system. By leveraging both client-side and server-side processes, the assistant system can effectively assist a user with optimal usage of computing resources while at the same time protecting user privacy and enhancing security.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with an assistant system.

FIG. 2 illustrates an example architecture of the assistant system.

FIG. 3 illustrates an example flow diagram of the assistant system.

FIG. 4 illustrates an example task-centric flow diagram of processing a user input.

FIG. 5 illustrates examples of traditional dataset and NUANCED.

FIG. 6 illustrates example limitations of previous conversational recommendation systems.

FIG. 7 illustrates an example gap between previous systems and real-world cases.

FIG. 8 illustrates example coarse slot-value tags.

FIG. 9 illustrates example nuanced estimated preference distributions.

FIG. 10 illustrates an example estimated preference distribution.

FIG. 11 illustrates an example comparison between full user history and sampled user history.

FIG. 12 illustrate an example comparison of three dialog scenarios for simulation.

FIG. 13 illustrates an example use case for simulating a straight dialog flow.

FIG. 14 illustrates an example use case for simulating user updating preference.

FIG. 15 illustrates an example use case for simulating system yes/no questions.

FIG. 16 illustrates example random selection of slots.

FIG. 17 illustrates an example annotation interface for rewriting.

FIG. 18 illustrates an example reasoning using entity/world knowledge.

FIG. 19 illustrates an example reasoning using user described situations or commonsense knowledge.

FIG. 20 illustrates an example reasoning using a mixture of entity/world knowledge and commonsense knowledge.

FIG. 21 illustrates example human evaluation results for the model outputs of Transformer, BERT, and BERT without context.

FIG. 22 illustrates example human evaluation results for different reasoning types.

FIG. 23 illustrates an example architecture of the BERT baseline.

FIGS. 24A and 24B illustrate an example of conventional bounding box annotation techniques.

FIG. 25 illustrates an example comparison of bounding box techniques and segmentation mask techniques.

FIGS. 26A and 26B illustrate example processes for identifying products with pixel-level segmentation masks.

FIG. 27 illustrates an example method for identifying products with pixel-level segmentations.

FIG. 28 illustrates an example framework for implementing a fuzzy testing infrastructure to certify privacy protections in a secure enclave application.

FIG. 29 illustrates an example method for implementing a fuzzy testing infrastructure to certify privacy protections in a secure enclave application.

FIG. 30 illustrates an example scoreboard.

FIG. 31 illustrates an example coverage scorecard.

FIG. 32 illustrates example symbol-counts extracted from interaction logs.

FIG. 33 illustrates example decision symbols.

FIG. 34 illustrates an example composing of decision symbols.

FIG. 35 illustrates an example extensible set of decision symbols.

FIG. 36 illustrates an example covering inventory from end-to-end tests.

FIG. 37 illustrates an example combination of symbol-counts with covering inventory.

FIGS. 38A-38G illustrate example user interface displays for real-time ASR parsing.

FIGS. 39A-39E illustrate example user interface displays for real-time ASR parsing in a multi-device environment.

FIG. 40 illustrates an example method for real-time ASR parsing

FIG. 41 illustrates an example social graph.

FIG. 42 illustrates an example view of an embedding space.

FIG. 43 illustrates an example artificial neural network.

FIG. 44 illustrates an example computer system.

### DESCRIPTION OF EXAMPLE EMBODIMENTS

### System Overview

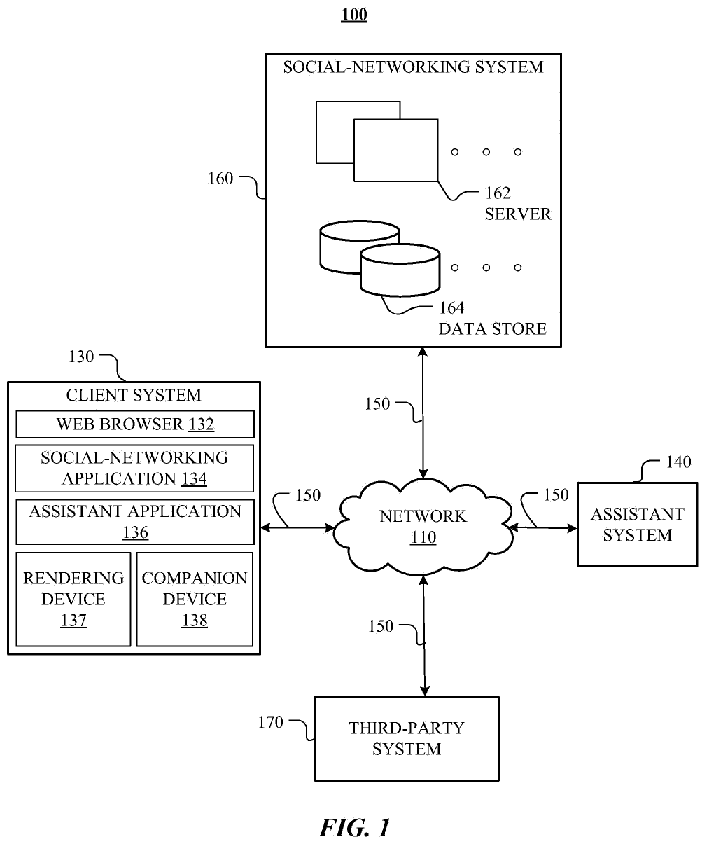

FIG. 1 illustrates an example network environment 100 associated with an assistant system. Network environment 100 includes a client system 130, an assistant system 140, a social-networking system 160, and a third-party system 170 connected to each other by a network 110. Although FIG. 1 illustrates a particular arrangement of a client system 130, an assistant system 140, a social-networking system 160, a third-party system 170, and a network 110, this disclosure contemplates any suitable arrangement of a client system 130, an assistant system 140, a social-networking system 160, a third-party system 170, and a network 110. As an example and not by way of limitation, two or more of a client system 130, a social-networking system 160, an assistant system 140, and a third-party system 170 may be connected to each other directly, bypassing a network 110. As another example, two or more of a client system 130, an assistant system 140, a social-networking system 160, and a third-party system 170 may be physically or logically co-located with each other in whole or in part. Moreover, although FIG. 1 illustrates a particular number of client systems 130, assistant systems 140, social-networking systems 160, third-party systems 170, and networks 110, this disclosure contemplates any suitable number of client systems 130, assistant systems 140, social-networking systems 160, third-party systems 170, and networks 110. As an example and not by way of limitation, network environment 100 may include multiple client systems 130, assistant systems 140, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular technology-based network, a satellite communications technology-based network, another network 110, or a combination of two or more such networks 110.

Links 150 may connect a client system 130, an assistant system 140, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, a client system 130 may be any suitable electronic device including hardware, software, or embedded logic components, or a combination of two or more such components, and may be capable of carrying out the functionalities implemented or supported by a client system 130. As an example and not by way of limitation, the client system 130 may include a computer system such as a desktop computer, notebook or laptop computer, netbook, a tablet computer, e-book reader, GPS device, camera, personal digital assistant (PDA), handheld electronic device, cellular telephone, smartphone, smart speaker, smart watch, smart glasses, augmented-reality (AR) smart glasses, virtual reality (VR) headset, other suitable electronic device, or any suitable combination thereof. In particular embodiments, the client system 130 may be a smart assistant device. More information on smart assistant devices may be found in U.S. patent application Ser. No. 15/949,011, filed 9 Apr. 2018, U.S. patent application Ser. No. 16/153,574, filed 5 Oct. 2018, U.S. Design patent application No. 29/631910, filed 3 Jan. 2018, U.S. Design patent application No. 29/631747, filed 2 Jan. 2018, U.S. Design patent application No. 29/631913, filed 3 Jan. 2018, and U.S. Design patent application No. 29/631914, filed 3 Jan. 2018, each of which is incorporated by reference. This disclosure contemplates any suitable client systems 130. In particular embodiments, a client system 130 may enable a network user at a client system 130 to access a network 110. The client system 130 may also enable the user to communicate with other users at other client systems 130.

In particular embodiments, a client system 130 may include a web browser 132, and may have one or more add-ons, plug-ins, or other extensions. A user at a client system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to a client system 130 one or more Hyper Text Markup Language (HTML) files responsive to the HTTP request. The client system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts, combinations of markup language and scripts, and the like. Herein, reference to a web interface encompasses one or more corresponding source files (which a browser may use to render the web interface) and vice versa, where appropriate.

In particular embodiments, a client system 130 may include a social-networking application 134 installed on the client system 130. A user at a client system 130 may use the social-networking application 134 to access on online social network. The user at the client system 130 may use the social-networking application 134 to communicate with the user's social connections (e.g., friends, followers, followed accounts, contacts, etc.). The user at the client system 130 may also use the social-networking application 134 to interact with a plurality of content objects (e.g., posts, news articles, ephemeral content, etc.) on the online social network. As an example and not by way of limitation, the user may browse trending topics and breaking news using the social-networking application 134.

In particular embodiments, a client system 130 may include an assistant application 136. A user at a client system 130 may use the assistant application 136 to interact with the assistant system 140. In particular embodiments, the assistant application 136 may include an assistant xbot functionality as a front-end interface for interacting with the user of the client system 130, including receiving user inputs and presenting outputs. In particular embodiments, the assistant application 136 may comprise a stand-alone application. In particular embodiments, the assistant application 136 may be integrated into the social-networking application 134 or another suitable application (e.g., a messaging application). In particular embodiments, the assistant application 136 may be also integrated into the client system 130, an assistant hardware device, or any other suitable hardware devices. In particular embodiments, the assistant application 136 may be also part of the assistant system 140. In particular embodiments, the assistant application 136 may be accessed via the web browser 132. In particular embodiments, the user may interact with the assistant system 140 by providing user input to the assistant application 136 via various modalities (e.g., audio, voice, text, vision, image, video, gesture, motion, activity, location, orientation). The assistant application 136 may communicate the user input to the assistant system 140 (e.g., via the assistant xbot). Based on the user input, the assistant system 140 may generate responses. The assistant system 140 may send the generated responses to the assistant application 136. The assistant application 136 may then present the responses to the user at the client system 130 via various modalities (e.g., audio, text, image, and video). As an example and not by way of limitation, the user may interact with the assistant system 140 by providing a user input (e.g., a verbal request for information regarding a current status of nearby vehicle traffic) to the assistant xbot via a microphone of the client system 130. The assistant application 136 may then communicate the user input to the assistant system 140 over network 110. The assistant system 140 may accordingly analyze the user input, generate a response based on the analysis of the user input (e.g., vehicle traffic information obtained from a third-party source), and communicate the generated response back to the assistant application 136. The assistant application 136 may then present the generated response to the user in any suitable manner (e.g., displaying a text-based push notification and/or image(s) illustrating a local map of nearby vehicle traffic on a display of the client system 130).

In particular embodiments, a client system 130 may implement wake-word detection techniques to allow users to conveniently activate the assistant system 140 using one or more wake-words associated with assistant system 140. As an example and not by way of limitation, the system audio API on client system 130 may continuously monitor user input comprising audio data (e.g., frames of voice data) received at the client system 130. In this example, a wake-word associated with the assistant system 140 may be the voice phrase “hey assistant.” In this example, when the system audio API on client system 130 detects the voice phrase “hey assistant” in the monitored audio data, the assistant system 140 may be activated for subsequent interaction with the user. In alternative embodiments, similar detection techniques may be implemented to activate the assistant system 140 using particular non-audio user inputs associated with the assistant system 140. For example, the non-audio user inputs may be specific visual signals detected by a low-power sensor (e.g., camera) of client system 130. As an example and not by way of limitation, the visual signals may be a static image (e.g., barcode, QR code, universal product code (UPC)), a position of the user (e.g., the user's gaze towards client system 130), a user motion (e.g., the user pointing at an object), or any other suitable visual signal.

In particular embodiments, a client system 130 may include a rendering device 137 and, optionally, a companion device 138. The rendering device 137 may be configured to render outputs generated by the assistant system 140 to the user. The companion device 138 may be configured to perform computations associated with particular tasks (e.g., communications with the assistant system 140) locally (i.e., on-device) on the companion device 138 in particular circumstances (e.g., when the rendering device 137 is unable to perform said computations). In particular embodiments, the client system 130, the rendering device 137, and/or the companion device 138 may each be a suitable electronic device including hardware, software, or embedded logic components, or a combination of two or more such components, and may be capable of carrying out, individually or cooperatively, the functionalities implemented or supported by the client system 130 described herein. As an example and not by way of limitation, the client system 130, the rendering device 137, and/or the companion device 138 may each include a computer system such as a desktop computer, notebook or laptop computer, netbook, a tablet computer, e-book reader, GPS device, camera, personal digital assistant (PDA), handheld electronic device, cellular telephone, smartphone, smart speaker, virtual reality (VR) headset, augmented-reality (AR) smart glasses, other suitable electronic device, or any suitable combination thereof. In particular embodiments, one or more of the client system 130, the rendering device 137, and the companion device 138 may operate as a smart assistant device. As an example and not by way of limitation, the rendering device 137 may comprise smart glasses and the companion device 138 may comprise a smart phone. As another example and not by way of limitation, the rendering device 137 may comprise a smart watch and the companion device 138 may comprise a smart phone. As yet another example and not by way of limitation, the rendering device 137 may comprise smart glasses and the companion device 138 may comprise a smart remote for the smart glasses. As yet another example and not by way of limitation, the rendering device 137 may comprise a VR/AR headset and the companion device 138 may comprise a smart phone.

In particular embodiments, a user may interact with the assistant system 140 using the rendering device 137 or the companion device 138, individually or in combination. In particular embodiments, one or more of the client system 130, the rendering device 137, and the companion device 138 may implement a multi-stage wake-word detection model to enable users to conveniently activate the assistant system 140 by continuously monitoring for one or more wake-words associated with assistant system 140. At a first stage of the wake-word detection model, the rendering device 137 may receive audio user input (e.g., frames of voice data). If a wireless connection between the rendering device 137 and the companion device 138 is available, the application on the rendering device 137 may communicate the received audio user input to the companion application on the companion device 138 via the wireless connection. At a second stage of the wake-word detection model, the companion application on the companion device 138 may process the received audio user input to detect a wake-word associated with the assistant system 140. The companion application on the companion device 138 may then communicate the detected wake-word to a server associated with the assistant system 140 via wireless network 110. At a third stage of the wake-word detection model, the server associated with the assistant system 140 may perform a keyword verification on the detected wake-word to verify whether the user intended to activate and receive assistance from the assistant system 140. In alternative embodiments, any of the processing, detection, or keyword verification may be performed by the rendering device 137 and/or the companion device 138. In particular embodiments, when the assistant system 140 has been activated by the user, an application on the rendering device 137 may be configured to receive user input from the user, and a companion application on the companion device 138 may be configured to handle user inputs (e.g., user requests) received by the application on the rendering device 137. In particular embodiments, the rendering device 137 and the companion device 138 may be associated with each other (i.e., paired) via one or more wireless communication protocols (e.g., Bluetooth).

The following example workflow illustrates how a rendering device 137 and a companion device 138 may handle a user input provided by a user. In this example, an application on the rendering device 137 may receive a user input comprising a user request directed to the rendering device 137. The application on the rendering device 137 may then determine a status of a wireless connection (i.e., tethering status) between the rendering device 137 and the companion device 138. If a wireless connection between the rendering device 137 and the companion device 138 is not available, the application on the rendering device 137 may communicate the user request (optionally including additional data and/or contextual information available to the rendering device 137) to the assistant system 140 via the network 110. The assistant system 140 may then generate a response to the user request and communicate the generated response back to the rendering device 137. The rendering device 137 may then present the response to the user in any suitable manner. Alternatively, if a wireless connection between the rendering device 137 and the companion device 138 is available, the application on the rendering device 137 may communicate the user request (optionally including additional data and/or contextual information available to the rendering device 137) to the companion application on the companion device 138 via the wireless connection. The companion application on the companion device 138 may then communicate the user request (optionally including additional data and/or contextual information available to the companion device 138) to the assistant system 140 via the network 110. The assistant system 140 may then generate a response to the user request and communicate the generated response back to the companion device 138. The companion application on the companion device 138 may then communicate the generated response to the application on the rendering device 137. The rendering device 137 may then present the response to the user in any suitable manner. In the preceding example workflow, the rendering device 137 and the companion device 138 may each perform one or more computations and/or processes at each respective step of the workflow. In particular embodiments, performance of the computations and/or processes disclosed herein may be adaptively switched between the rendering device 137 and the companion device 138 based at least in part on a device state of the rendering device 137 and/or the companion device 138, a task associated with the user input, and/or one or more additional factors. As an example and not by way of limitation, one factor may be signal strength of the wireless connection between the rendering device 137 and the companion device 138. For example, if the signal strength of the wireless connection between the rendering device 137 and the companion device 138 is strong, the computations and processes may be adaptively switched to be substantially performed by the companion device 138 in order to, for example, benefit from the greater processing power of the CPU of the companion device 138. Alternatively, if the signal strength of the wireless connection between the rendering device 137 and the companion device 138 is weak, the computations and processes may be adaptively switched to be substantially performed by the rendering device 137 in a standalone manner. In particular embodiments, if the client system 130 does not comprise a companion device 138, the aforementioned computations and processes may be performed solely by the rendering device 137 in a standalone manner.

In particular embodiments, an assistant system 140 may assist users with various assistant-related tasks. The assistant system 140 may interact with the social-networking system 160 and/or the third-party system 170 when executing these assistant-related tasks.

In particular embodiments, the social-networking system 160 may be a network-addressable computing system that can host an online social network. The social-networking system 160 may generate, store, receive, and send social-networking data, such as, for example, user profile data, concept-profile data, social-graph information, or other suitable data related to the online social network. The social-networking system 160 may be accessed by the other components of network environment 100 either directly or via a network 110. As an example and not by way of limitation, a client system 130 may access the social-networking system 160 using a web browser 132 or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. As an example and not by way of limitation, each server 162 may be a web server, a news server, a mail server, a message server, an advertising server, a file server, an application server, an exchange server, a database server, a proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, an assistant system 140, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects. In particular embodiments, a third-party content provider may use one or more third-party agents to provide content objects and/or services. A third-party agent may be an implementation that is hosted and executing on the third-party system 170.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from a client system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more client systems 130 or one or more third-party systems 170 via a network 110. The web server may include a mail server or other messaging functionality for receiving and routing messages between the social-networking system 160 and one or more client systems 130. An API-request server may allow, for example, an assistant system 140 or a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from a client system 130 responsive to a user input comprising a user request received from a client system 130. Authorization servers may be used to enforce one or more privacy settings of the users of the social-networking system 160. A privacy setting of a user may determine how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

### Assistant Systems

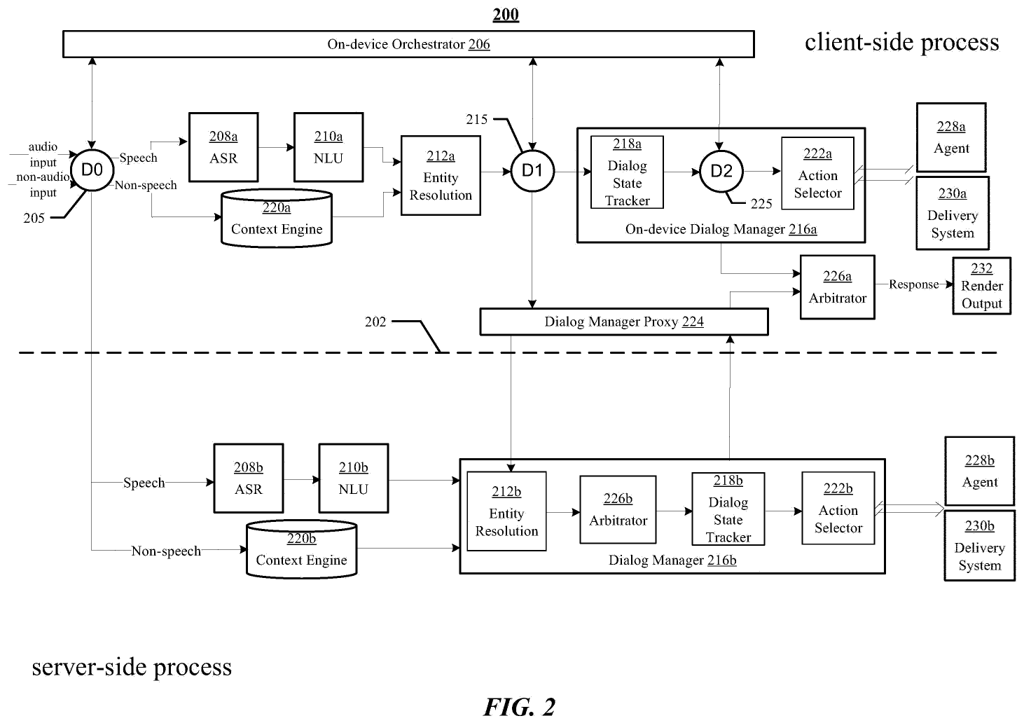

FIG. 2 illustrates an example architecture 200 of the assistant system 140. In particular embodiments, the assistant system 140 may assist a user to obtain information or services. The assistant system 140 may enable the user to interact with the assistant system 140 via user inputs of various modalities (e.g., audio, voice, text, vision, image, video, gesture, motion, activity, location, orientation) in stateful and multi-turn conversations to receive assistance from the assistant system 140. As an example and not by way of limitation, a user input may comprise an audio input based on the user's voice (e.g., a verbal command), which may be processed by a system audio API (application programming interface) on client system 130. The system audio API may perform techniques including echo cancellation, noise removal, beam forming, self-user voice activation, speaker identification, voice activity detection (VAD), and/or any other suitable acoustic technique in order to generate audio data that is readily processable by the assistant system 140. In particular embodiments, the assistant system 140 may support mono-modal inputs (e.g., only voice inputs), multi-modal inputs (e.g., voice inputs and text inputs), hybrid/multi-modal inputs, or any combination thereof. In particular embodiments, a user input may be a user-generated input that is sent to the assistant system 140 in a single turn. User inputs provided by a user may be associated with particular assistant-related tasks, and may include, for example, user requests (e.g., verbal requests for information or performance of an action), user interactions with the assistant application 136 associated with the assistant system 140 (e.g., selection of UI elements via touch or gesture), or any other type of suitable user input that may be detected and understood by the assistant system 140 (e.g., user movements detected by the client device 130 of the user).

In particular embodiments, the assistant system 140 may create and store a user profile comprising both personal and contextual information associated with the user. In particular embodiments, the assistant system 140 may analyze the user input using natural-language understanding (NLU) techniques. The analysis may be based at least in part on the user profile of the user for more personalized and context-aware understanding. The assistant system 140 may resolve entities associated with the user input based on the analysis. In particular embodiments, the assistant system 140 may interact with different agents to obtain information or services that are associated with the resolved entities. The assistant system 140 may generate a response for the user regarding the information or services by using natural-language generation (NLG). Through the interaction with the user, the assistant system 140 may use dialog management techniques to manage and forward the conversation flow with the user. In particular embodiments, the assistant system 140 may further assist the user to effectively and efficiently digest the obtained information by summarizing the information. The assistant system 140 may also assist the user to be more engaging with an online social network by providing tools that help the user interact with the online social network (e.g., creating posts, comments, messages). The assistant system 140 may additionally assist the user to manage different tasks such as keeping track of events. In particular embodiments, the assistant system 140 may proactively execute, without a user input, pre-authorized tasks that are relevant to user interests and preferences based on the user profile, at a time relevant for the user. In particular embodiments, the assistant system 140 may check privacy settings to ensure that accessing a user's profile or other user information and executing different tasks are permitted subject to the user's privacy settings. More information on assisting users subject to privacy settings may be found in U.S. patent application Ser. No. 16/182,542, filed 6 Nov. 2018, which is incorporated by reference.

In particular embodiments, the assistant system 140 may assist a user via an architecture built upon client-side processes and server-side processes which may operate in various operational modes. In FIG. 2, the client-side process is illustrated above the dashed line 202 whereas the server-side process is illustrated below the dashed line 202. A first operational mode (i.e., on-device mode) may be a workflow in which the assistant system 140 processes a user input and provides assistance to the user by primarily or exclusively performing client-side processes locally on the client system 130. For example, if the client system 130 is not connected to a network 110 (i.e., when client system 130 is offline), the assistant system 140 may handle a user input in the first operational mode utilizing only client-side processes. A second operational mode (i.e., cloud mode) may be a workflow in which the assistant system 140 processes a user input and provides assistance to the user by primarily or exclusively performing server-side processes on one or more remote servers (e.g., a server associated with assistant system 140). As illustrated in FIG. 2, a third operational mode (i.e., blended mode) may be a parallel workflow in which the assistant system 140 processes a user input and provides assistance to the user by performing client-side processes locally on the client system 130 in conjunction with server-side processes on one or more remote servers (e.g., a server associated with assistant system 140). For example, the client system 130 and the server associated with assistant system 140 may both perform automatic speech recognition (ASR) and natural-language understanding (NLU) processes, but the client system 130 may delegate dialog, agent, and natural-language generation (NLG) processes to be performed by the server associated with assistant system 140.

In particular embodiments, selection of an operational mode may be based at least in part on a device state, a task associated with a user input, and/or one or more additional factors. As an example and not by way of limitation, as described above, one factor may be a network connectivity status for client system 130. For example, if the client system 130 is not connected to a network 110 (i.e., when client system 130 is offline), the assistant system 140 may handle a user input in the first operational mode (i.e., on-device mode). As another example and not by way of limitation, another factor may be based on a measure of available battery power (i.e., battery status) for the client system 130. For example, if there is a need for client system 130 to conserve battery power (e.g., when client system 130 has minimal available battery power or the user has indicated a desire to conserve the battery power of the client system 130), the assistant system 140 may handle a user input in the second operational mode (i.e., cloud mode) or the third operational mode (i.e., blended mode) in order to perform fewer power-intensive operations on the client system 130. As yet another example and not by way of limitation, another factor may be one or more privacy constraints (e.g., specified privacy settings, applicable privacy policies). For example, if one or more privacy constraints limits or precludes particular data from being transmitted to a remote server (e.g., a server associated with the assistant system 140), the assistant system 140 may handle a user input in the first operational mode (i.e., on-device mode) in order to protect user privacy. As yet another example and not by way of limitation, another factor may be desynchronized context data between the client system 130 and a remote server (e.g., the server associated with assistant system 140). For example, the client system 130 and the server associated with assistant system 140 may be determined to have inconsistent, missing, and/or unreconciled context data, the assistant system 140 may handle a user input in the third operational mode (i.e., blended mode) to reduce the likelihood of an inadequate analysis associated with the user input. As yet another example and not by way of limitation, another factor may be a measure of latency for the connection between client system 130 and a remote server (e.g., the server associated with assistant system 140). For example, if a task associated with a user input may significantly benefit from and/or require prompt or immediate execution (e.g., photo capturing tasks), the assistant system 140 may handle the user input in the first operational mode (i.e., on-device mode) to ensure the task is performed in a timely manner. As yet another example and not by way of limitation, another factor may be, for a feature relevant to a task associated with a user input, whether the feature is only supported by a remote server (e.g., the server associated with assistant system 140). For example, if the relevant feature requires advanced technical functionality (e.g., high-powered processing capabilities, rapid update cycles) that is only supported by the server associated with assistant system 140 and is not supported by client system 130 at the time of the user input, the assistant system 140 may handle the user input in the second operational mode (i.e., cloud mode) or the third operational mode (i.e., blended mode) in order to benefit from the relevant feature.

In particular embodiments, an on-device orchestrator 206 on the client system 130 may coordinate receiving a user input and may determine, at one or more decision points in an example workflow, which of the operational modes described above should be used to process or continue processing the user input. As discussed above, selection of an operational mode may be based at least in part on a device state, a task associated with a user input, and/or one or more additional factors. As an example and not by way of limitation, with reference to the workflow architecture illustrated in FIG. 2, after a user input is received from a user, the on-device orchestrator 206 may determine, at decision point (D0) 205, whether to begin processing the user input in the first operational mode (i.e., on-device mode), the second operational mode (i.e., cloud mode), or the third operational mode (i.e., blended mode). For example, at decision point (D0) 205, the on-device orchestrator 206 may select the first operational mode (i.e., on-device mode) if the client system 130 is not connected to network 110 (i.e., when client system 130 is offline), if one or more privacy constraints expressly require on-device processing (e.g., adding or removing another person to a private call between users), or if the user input is associated with a task which does not require or benefit from server-side processing (e.g., setting an alarm or calling another user). As another example, at decision point (D0) 205, the on-device orchestrator 206 may select the second operational mode (i.e., cloud mode) or the third operational mode (i.e., blended mode) if the client system 130 has a need to conserve battery power (e.g., when client system 130 has minimal available battery power or the user has indicated a desire to conserve the battery power of the client system 130) or has a need to limit additional utilization of computing resources (e.g., when other processes operating on client device 130 require high CPU utilization (e.g., SMS messaging applications)).

In particular embodiments, if the on-device orchestrator 206 determines at decision point (D0) 205 that the user input should be processed using the first operational mode (i.e., on-device mode) or the third operational mode (i.e., blended mode), the client-side process may continue as illustrated in FIG. 2. As an example and not by way of limitation, if the user input comprises speech data, the speech data may be received at a local automatic speech recognition (ASR) module 208a on the client system 130. The ASR module 208a may allow a user to dictate and have speech transcribed as written text, have a document synthesized as an audio stream, or issue commands that are recognized as such by the system.

In particular embodiments, the output of the ASR module 208a may be sent to a local natural-language understanding (NLU) module 210a. The NLU module 210a may perform named entity resolution (NER), or named entity resolution may be performed by the entity resolution module 212a, as described below. In particular embodiments, one or more of an intent, a slot, or a domain may be an output of the NLU module 210a.

In particular embodiments, the user input may comprise non-speech data, which may be received at a local context engine 220a. As an example and not by way of limitation, the non-speech data may comprise locations, visuals, touch, gestures, world updates, social updates, contextual information, information related to people, activity data, and/or any other suitable type of non-speech data. The non-speech data may further comprise sensory data received by client system 130 sensors (e.g., microphone, camera), which may be accessed subject to privacy constraints and further analyzed by computer vision technologies. In particular embodiments, the computer vision technologies may comprise human reconstruction, face detection, facial recognition, hand tracking, eye tracking, and/or any other suitable computer vision technologies. In particular embodiments, the non-speech data may be subject to geometric constructions, which may comprise constructing objects surrounding a user using any suitable type of data collected by a client system 130. As an example and not by way of limitation, a user may be wearing AR glasses, and geometric constructions may be utilized to determine spatial locations of surfaces and items (e.g., a floor, a wall, a user's hands). In particular embodiments, the non-speech data may be inertial data captured by AR glasses or a VR headset, and which may be data associated with linear and angular motions (e.g., measurements associated with a user's body movements). In particular embodiments, the context engine 220a may determine various types of events and context based on the non-speech data.

In particular embodiments, the outputs of the NLU module 210a and/or the context engine 220a may be sent to an entity resolution module 212a. The entity resolution module 212a may resolve entities associated with one or more slots output by NLU module 210a. In particular embodiments, each resolved entity may be associated with one or more entity identifiers. As an example and not by way of limitation, an identifier may comprise a unique user identifier (ID) corresponding to a particular user (e.g., a unique username or user ID number for the social-networking system 160). In particular embodiments, each resolved entity may also be associated with a confidence score. More information on resolving entities may be found in U.S. Pat. No. 10,803,050, filed 27 Jul. 2018, and U.S. patent application Ser. No. 16/048,072, filed 27 Jul. 2018, each of which is incorporated by reference.

In particular embodiments, at decision point (D0) 205, the on-device orchestrator 206 may determine that a user input should be handled in the second operational mode (i.e., cloud mode) or the third operational mode (i.e., blended mode). In these operational modes, the user input may be handled by certain server-side modules in a similar manner as the client-side process described above.

In particular embodiments, if the user input comprises speech data, the speech data of the user input may be received at a remote automatic speech recognition (ASR) module 208b on a remote server (e.g., the server associated with assistant system 140). The ASR module 208b may allow a user to dictate and have speech transcribed as written text, have a document synthesized as an audio stream, or issue commands that are recognized as such by the system.

In particular embodiments, the output of the ASR module 208b may be sent to a remote natural-language understanding (NLU) module 210b. In particular embodiments, the NLU module 210b may perform named entity resolution (NER) or named entity resolution may be performed by entity resolution module 212b of dialog manager module 216b as described below. In particular embodiments, one or more of an intent, a slot, or a domain may be an output of the NLU module 210b.

In particular embodiments, the user input may comprise non-speech data, which may be received at a remote context engine 220b. In particular embodiments, the remote context engine 220b may determine various types of events and context based on the non-speech data. In particular embodiments, the output of the NLU module 210b and/or the context engine 220b may be sent to a remote dialog manager 216b.

In particular embodiments, as discussed above, an on-device orchestrator 206 on the client system 130 may coordinate receiving a user input and may determine, at one or more decision points in an example workflow, which of the operational modes described above should be used to process or continue processing the user input. As further discussed above, selection of an operational mode may be based at least in part on a device state, a task associated with a user input, and/or one or more additional factors. As an example and not by way of limitation, with continued reference to the workflow architecture illustrated in FIG. 2, after the entity resolution module 212a generates an output or a null output, the on-device orchestrator 206 may determine, at decision point (D1) 215, whether to continue processing the user input in the first operational mode (i.e., on-device mode), the second operational mode (i.e., cloud mode), or the third operational mode (i.e., blended mode). For example, at decision point (D1) 215, the on-device orchestrator 206 may select the first operational mode (i.e., on-device mode) if an identified intent is associated with a latency sensitive processing task (e.g., taking a photo, pausing a stopwatch). As another example and not by way of limitation, if a messaging task is not supported by on-device processing on the client system 130, the on-device orchestrator 206 may select the third operational mode (i.e., blended mode) to process the user input associated with a messaging request. As yet another example, at decision point (D1) 215, the on-device orchestrator 206 may select the second operational mode (i.e., cloud mode) or the third operational mode (i.e., blended mode) if the task being processed requires access to a social graph, a knowledge graph, or a concept graph not stored on the client system 130. Alternatively, the on-device orchestrator 206 may instead select the first operational mode (i.e., on-device mode) if a sufficient version of an informational graph including requisite information for the task exists on the client system 130 (e.g., a smaller and/or bootstrapped version of a knowledge graph).

In particular embodiments, if the on-device orchestrator 206 determines at decision point (D1) 215 that processing should continue using the first operational mode (i.e., on-device mode) or the third operational mode (i.e., blended mode), the client-side process may continue as illustrated in FIG. 2. As an example and not by way of limitation, the output from the entity resolution module 212a may be sent to an on-device dialog manager 216a. In particular embodiments, the on-device dialog manager 216a may comprise a dialog state tracker 218a and an action selector 222a. The on-device dialog manager 216a may have complex dialog logic and product-related business logic to manage the dialog state and flow of the conversation between the user and the assistant system 140. The on-device dialog manager 216a may include full functionality for end-to-end integration and multi-turn support (e.g., confirmation, disambiguation). The on-device dialog manager 216a may also be lightweight with respect to computing limitations and resources including memory, computation (CPU), and binary size constraints. The on-device dialog manager 216a may also be scalable to improve developer experience. In particular embodiments, the on-device dialog manager 216a may benefit the assistant system 140, for example, by providing offline support to alleviate network connectivity issues (e.g., unstable or unavailable network connections), by using client-side processes to prevent privacy-sensitive information from being transmitted off of client system 130, and by providing a stable user experience in high-latency sensitive scenarios.

In particular embodiments, the on-device dialog manager 216a may further conduct false trigger mitigation. Implementation of false trigger mitigation may detect and prevent false triggers from user inputs which would otherwise invoke the assistant system 140 (e.g., an unintended wake-word) and may further prevent the assistant system 140 from generating data records based on the false trigger that may be inaccurate and/or subject to privacy constraints. As an example and not by way of limitation, if a user is in a voice call, the user's conversation during the voice call may be considered private, and the false trigger mitigation may limit detection of wake-words to audio user inputs received locally by the user's client system 130. In particular embodiments, the on-device dialog manager 216a may implement false trigger mitigation based on a nonsense detector. If the nonsense detector determines with a high confidence that a received wake-word is not logically and/or contextually sensible at the point in time at which it was received from the user, the on-device dialog manager 216a may determine that the user did not intend to invoke the assistant system 140.

In particular embodiments, due to a limited computing power of the client system 130, the on-device dialog manager 216a may conduct on-device learning based on learning algorithms particularly tailored for client system 130. As an example and not by way of limitation, federated learning techniques may be implemented by the on-device dialog manager 216a. Federated learning is a specific category of distributed machine learning techniques which may train machine-learning models using decentralized data stored on end devices (e.g., mobile phones). In particular embodiments, the on-device dialog manager 216a may use federated user representation learning model to extend existing neural-network personalization techniques to implementation of federated learning by the on-device dialog manager 216a. Federated user representation learning may personalize federated learning models by learning task-specific user representations (i.e., embeddings) and/or by personalizing model weights. Federated user representation learning is a simple, scalable, privacy-preserving, and resource-efficient. Federated user representation learning may divide model parameters into federated and private parameters. Private parameters, such as private user embeddings, may be trained locally on a client system 130 instead of being transferred to or averaged by a remote server (e.g., the server associated with assistant system 140). Federated parameters, by contrast, may be trained remotely on the server. In particular embodiments, the on-device dialog manager 216a may use an active federated learning model, which may transmit a global model trained on the remote server to client systems 130 and calculate gradients locally on the client systems 130. Active federated learning may enable the on-device dialog manager 216a to minimize the transmission costs associated with downloading models and uploading gradients. For active federated learning, in each round, client systems 130 may be selected in a semi-random manner based at least in part on a probability conditioned on the current model and the data on the client systems 130 in order to optimize efficiency for training the federated learning model.

In particular embodiments, the dialog state tracker 218a may track state changes over time as a user interacts with the world and the assistant system 140 interacts with the user. As an example and not by way of limitation, the dialog state tracker 218a may track, for example, what the user is talking about, whom the user is with, where the user is, what tasks are currently in progress, and where the user's gaze is at subject to applicable privacy policies.

In particular embodiments, at decision point (D1) 215, the on-device orchestrator 206 may determine to forward the user input to the server for either the second operational mode (i.e., cloud mode) or the third operational mode (i.e., blended mode). As an example and not by way of limitation, if particular functionalities or processes (e.g., messaging) are not supported by on the client system 130, the on-device orchestrator 206 may determine at decision point (D1) 215 to use the third operational mode (i.e., blended mode). In particular embodiments, the on-device orchestrator 206 may cause the outputs from the NLU module 210a, the context engine 220a, and the entity resolution module 212a, via a dialog manager proxy 224, to be forwarded to an entity resolution module 212b of the remote dialog manager 216b to continue the processing. The dialog manager proxy 224 may be a communication channel for information/events exchange between the client system 130 and the server. In particular embodiments, the dialog manager 216b may additionally comprise a remote arbitrator 226b, a remote dialog state tracker 218b, and a remote action selector 222b. In particular embodiments, the assistant system 140 may have started processing a user input with the second operational mode (i.e., cloud mode) at decision point (D0) 205 and the on-device orchestrator 206 may determine to continue processing the user input based on the second operational mode (i.e., cloud mode) at decision point (D1) 215. Accordingly, the output from the NLU module 210b and the context engine 220b may be received at the remote entity resolution module 212b. The remote entity resolution module 212b may have similar functionality as the local entity resolution module 212a, which may comprise resolving entities associated with the slots. In particular embodiments, the entity resolution module 212b may access one or more of the social graph, the knowledge graph, or the concept graph when resolving the entities. The output from the entity resolution module 212b may be received at the arbitrator 226b.

In particular embodiments, the remote arbitrator 226b may be responsible for choosing between client-side and server-side upstream results (e.g., results from the NLU module 210a/b, results from the entity resolution module 212a/b, and results from the context engine 220a/b). The arbitrator 226b may send the selected upstream results to the remote dialog state tracker 218b. In particular embodiments, similarly to the local dialog state tracker 218a, the remote dialog state tracker 218b may convert the upstream results into candidate tasks using task specifications and resolve arguments with entity resolution.

In particular embodiments, at decision point (D2) 225, the on-device orchestrator 206 may determine whether to continue processing the user input based on the first operational mode (i.e., on-device mode) or forward the user input to the server for the third operational mode (i.e., blended mode). The decision may depend on, for example, whether the client-side process is able to resolve the task and slots successfully, whether there is a valid task policy with a specific feature support, and/or the context differences between the client-side process and the server-side process. In particular embodiments, decisions made at decision point (D2) 225 may be for multi-turn scenarios. In particular embodiments, there may be at least two possible scenarios. In a first scenario, the assistant system 140 may have started processing a user input in the first operational mode (i.e., on-device mode) using client-side dialog state. If at some point the assistant system 140 decides to switch to having the remote server process the user input, the assistant system 140 may create a programmatic/predefined task with the current task state and forward it to the remote server. For subsequent turns, the assistant system 140 may continue processing in the third operational mode (i.e., blended mode) using the server-side dialog state. In another scenario, the assistant system 140 may have started processing the user input in either the second operational mode (i.e., cloud mode) or the third operational mode (i.e., blended mode) and may substantially rely on server-side dialog state for all subsequent turns. If the on-device orchestrator 206 determines to continue processing the user input based on the first operational mode (i.e., on-device mode), the output from the dialog state tracker 218a may be received at the action selector 222a.

In particular embodiments, at decision point (D2) 225, the on-device orchestrator 206 may determine to forward the user input to the remote server and continue processing the user input in either the second operational mode (i.e., cloud mode) or the third operational mode (i.e., blended mode). The assistant system 140 may create a programmatic/predefined task with the current task state and forward it to the server, which may be received at the action selector 222b. In particular embodiments, the assistant system 140 may have started processing the user input in the second operational mode (i.e., cloud mode), and the on-device orchestrator 206 may determine to continue processing the user input in the second operational mode (i.e., cloud mode) at decision point (D2) 225. Accordingly, the output from the dialog state tracker 218b may be received at the action selector 222b.

In particular embodiments, the action selector 222a/b may perform interaction management. The action selector 222a/b may determine and trigger a set of general executable actions. The actions may be executed either on the client system 130 or at the remote server. As an example and not by way of limitation, these actions may include providing information or suggestions to the user. In particular embodiments, the actions may interact with agents 228a/b, users, and/or the assistant system 140 itself. These actions may comprise actions including one or more of a slot request, a confirmation, a disambiguation, or an agent execution. The actions may be independent of the underlying implementation of the action selector 222a/b. For more complicated scenarios such as, for example, multi-turn tasks or tasks with complex business logic, the local action selector 222a may call one or more local agents 228a, and the remote action selector 222b may call one or more remote agents 228b to execute the actions. Agents 228a/b may be invoked via task ID, and any actions may be routed to the correct agent 228a/b using that task ID. In particular embodiments, an agent 228a/b may be configured to serve as a broker across a plurality of content providers for one domain. A content provider may be an entity responsible for carrying out an action associated with an intent or completing a task associated with the intent. In particular embodiments, agents 228a/b may provide several functionalities for the assistant system 140 including, for example, native template generation, task specific business logic, and querying external APIs. When executing actions for a task, agents 228a/b may use context from the dialog state tracker 218a/b, and may also update the dialog state tracker 218a/b. In particular embodiments, agents 228a/b may also generate partial payloads from a dialog act.

In particular embodiments, the local agents 228a may have different implementations to be compiled/registered for different platforms (e.g., smart glasses versus a VR headset). In particular embodiments, multiple device-specific implementations (e.g., real-time calls for a client system 130 or a messaging application on the client system 130) may be handled internally by a single agent 228a. Alternatively, device-specific implementations may be handled by multiple agents 228a associated with multiple domains. As an example and not by way of limitation, calling an agent 228a on smart glasses may be implemented in a different manner than calling an agent 228a on a smart phone. Different platforms may also utilize varying numbers of agents 228a. The agents 228a may also be cross-platform (i.e., different operating systems on the client system 130). In addition, the agents 228a may have minimized startup time or binary size impact. Local agents 228a may be suitable for particular use cases. As an example and not by way of limitation, one use case may be emergency calling on the client system 130. As another example and not by way of limitation, another use case may be responding to a user input without network connectivity. As yet another example and not by way of limitation, another use case may be that particular domains/tasks may be privacy sensitive and may prohibit user inputs being sent to the remote server.

In particular embodiments, the local action selector 222a may call a local delivery system 230a for executing the actions, and the remote action selector 222b may call a remote delivery system 230b for executing the actions. The delivery system 230a/b may deliver a predefined event upon receiving triggering signals from the dialog state tracker 218a/b by executing corresponding actions. The delivery system 230a/b may ensure that events get delivered to a host with a living connection. As an example and not by way of limitation, the delivery system 230a/b may broadcast to all online devices that belong to one user. As another example and not by way of limitation, the delivery system 230a/b may deliver events to target-specific devices. The delivery system 230a/b may further render a payload using up-to-date device context.

In particular embodiments, the on-device dialog manager 216a may additionally comprise a separate local action execution module, and the remote dialog manager 216b may additionally comprise a separate remote action execution module. The local execution module and the remote action execution module may have similar functionality. In particular embodiments, the action execution module may call the agents 228a/b to execute tasks. The action execution module may additionally perform a set of general executable actions determined by the action selector 222a/b. The set of executable actions may interact with agents 228a/b, users, and the assistant system 140 itself via the delivery system 230a/b.

In particular embodiments, if the user input is handled using the first operational mode (i.e., on-device mode), results from the agents 228a and/or the delivery system 230a may be returned to the on-device dialog manager 216a. The on-device dialog manager 216a may then instruct a local arbitrator 226a to generate a final response based on these results. The arbitrator 226a may aggregate the results and evaluate them. As an example and not by way of limitation, the arbitrator 226a may rank and select a best result for responding to the user input. If the user request is handled in the second operational mode (i.e., cloud mode), the results from the agents 228b and/or the delivery system 230b may be returned to the remote dialog manager 216b. The remote dialog manager 216b may instruct, via the dialog manager proxy 224, the arbitrator 226a to generate the final response based on these results. Similarly, the arbitrator 226a may analyze the results and select the best result to provide to the user. If the user input is handled based on the third operational mode (i.e., blended mode), the client-side results and server-side results (e.g., from agents 228a/b and/or delivery system 230a/b) may both be provided to the arbitrator 226a by the on-device dialog manager 216a and remote dialog manager 216b, respectively. The arbitrator 226 may then choose between the client-side and server-side side results to determine the final result to be presented to the user. In particular embodiments, the logic to decide between these results may depend on the specific use-case.

In particular embodiments, the local arbitrator 226a may generate a response based on the final result and send it to a render output module 232. The render output module 232 may determine how to render the output in a way that is suitable for the client system 130. As an example and not by way of limitation, for a VR headset or AR smart glasses, the render output module 232 may determine to render the output using a visual-based modality (e.g., an image or a video clip) that may be displayed via the VR headset or AR smart glasses. As another example, the response may be rendered as audio signals that may be played by the user via a VR headset or AR smart glasses. As yet another example, the response may be rendered as augmented-reality data for enhancing user experience.

In particular embodiments, in addition to determining an operational mode to process the user input, the on-device orchestrator 206 may also determine whether to process the user input on the rendering device 137, process the user input on the companion device 138, or process the user request on the remote server. The rendering device 137 and/or the companion device 138 may each use the assistant stack in a similar manner as disclosed above to process the user input. As an example and not by, the on-device orchestrator 206 may determine that part of the processing should be done on the rendering device 137, part of the processing should be done on the companion device 138, and the remaining processing should be done on the remote server.

In particular embodiments, the assistant system 140 may have a variety of capabilities including audio cognition, visual cognition, signals intelligence, reasoning, and memories. In particular embodiments, the capability of audio cognition may enable the assistant system 140 to, for example, understand a user's input associated with various domains in different languages, understand and summarize a conversation, perform on-device audio cognition for complex commands, identify a user by voice, extract topics from a conversation and auto-tag sections of the conversation, enable audio interaction without a wake-word, filter and amplify user voice from ambient noise and conversations, and/or understand which client system 130 a user is talking to if multiple client systems 130 are in vicinity.

In particular embodiments, the capability of visual cognition may enable the assistant system 140 to, for example, perform face detection and tracking, recognize a user, recognize people of interest in major metropolitan areas at varying angles, recognize interesting objects in the world through a combination of existing machine-learning models and one-shot learning, recognize an interesting moment and auto-capture it, achieve semantic understanding over multiple visual frames across different episodes of time, provide platform support for additional capabilities in people, places, or objects recognition, recognize a full set of settings and micro-locations including personalized locations, recognize complex activities, recognize complex gestures to control a client system 130, handle images/videos from egocentric cameras (e.g., with motion, capture angles, resolution), accomplish similar levels of accuracy and speed regarding images with lower resolution, conduct one-shot registration and recognition of people, places, and objects, and/or perform visual recognition on a client system 130.

In particular embodiments, the assistant system 140 may leverage computer vision techniques to achieve visual cognition. Besides computer vision techniques, the assistant system 140 may explore options that may supplement these techniques to scale up the recognition of objects. In particular embodiments, the assistant system 140 may use supplemental signals such as, for example, optical character recognition (OCR) of an object's labels, GPS signals for places recognition, and/or signals from a user's client system 130 to identify the user. In particular embodiments, the assistant system 140 may perform general scene recognition (e.g., home, work, public spaces) to set a context for the user and reduce the computer-vision search space to identify likely objects or people. In particular embodiments, the assistant system 140 may guide users to train the assistant system 140. For example, crowdsourcing may be used to get users to tag objects and help the assistant system 140 recognize more objects over time. As another example, users may register their personal objects as part of an initial setup when using the assistant system 140. The assistant system 140 may further allow users to provide positive/negative signals for objects they interact with to train and improve personalized models for them.

In particular embodiments, the capability of signals intelligence may enable the assistant system 140 to, for example, determine user location, understand date/time, determine family locations, understand users' calendars and future desired locations, integrate richer sound understanding to identify setting/context through sound alone, and/or build signals intelligence models at runtime which may be personalized to a user's individual routines.

In particular embodiments, the capability of reasoning may enable the assistant system 140 to, for example, pick up previous conversation threads at any point in the future, synthesize all signals to understand micro and personalized context, learn interaction patterns and preferences from users' historical behavior and accurately suggest interactions that they may value, generate highly predictive proactive suggestions based on micro-context understanding, understand what content a user may want to see at what time of a day, and/or understand the changes in a scene and how that may impact the user's desired content.

In particular embodiments, the capabilities of memories may enable the assistant system 140 to, for example, remember which social connections a user previously called or interacted with, write into memory and query memory at will (i.e., open dictation and auto tags), extract richer preferences based on prior interactions and long-term learning, remember a user's life history, extract rich information from egocentric streams of data and auto catalog, and/or write to memory in structured form to form rich short, episodic and long-term memories.

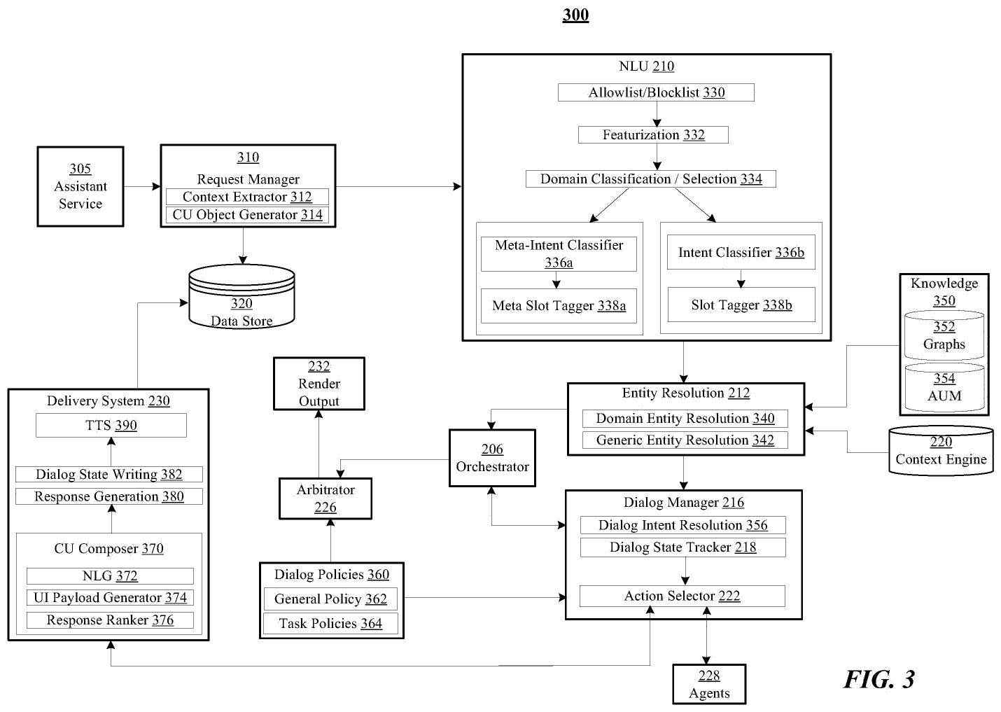

FIG. 3 illustrates an example flow diagram 300 of the assistant system 140. In particular embodiments, an assistant service module 305 may access a request manager 310 upon receiving a user input. In particular embodiments, the request manager 310 may comprise a context extractor 312 and a conversational understanding object generator (CU object generator) 314. The context extractor 312 may extract contextual information associated with the user input. The context extractor 312 may also update contextual information based on the assistant application 136 executing on the client system 130. As an example and not by way of limitation, the update of contextual information may comprise content items are displayed on the client system 130. As another example and not by way of limitation, the update of contextual information may comprise whether an alarm is set on the client system 130. As another example and not by way of limitation, the update of contextual information may comprise whether a song is playing on the client system 130. The CU object generator 314 may generate particular CU objects relevant to the user input. The CU objects may comprise dialog-session data and features associated with the user input, which may be shared with all the modules of the assistant system 140. In particular embodiments, the request manager 310 may store the contextual information and the generated CU objects in a data store 320 which is a particular data store implemented in the assistant system 140.

In particular embodiments, the request manger 310 may send the generated CU objects to the NLU module 210. The NLU module 210 may perform a plurality of steps to process the CU objects. The NLU module 210 may first run the CU objects through an allowlist/blocklist 330. In particular embodiments, the allowlist/blocklist 330 may comprise interpretation data matching the user input. The NLU module 210 may then perform a featurization 332 of the CU objects. The NLU module 210 may then perform domain classification/selection 334 on user input based on the features resulted from the featurization 332 to classify the user input into predefined domains. In particular embodiments, a domain may denote a social context of interaction (e.g., education), or a namespace for a set of intents (e.g., music). The domain classification/selection results may be further processed based on two related procedures. In one procedure, the NLU module 210 may process the domain classification/selection results using a meta-intent classifier 336a. The meta-intent classifier 336a may determine categories that describe the user's intent. An intent may be an element in a pre-defined taxonomy of semantic intentions, which may indicate a purpose of a user interaction with the assistant system 140. The NLU module 210a may classify a user input into a member of the pre-defined taxonomy. For example, the user input may be “Play Beethoven's 5th,” and the NLU module 210a may classify the input as having the intent [IN:play_music]. In particular embodiments, intents that are common to multiple domains may be processed by the meta-intent classifier 336a. As an example and not by way of limitation, the meta-intent classifier 336a may be based on a machine-learning model that may take the domain classification/selection results as input and calculate a probability of the input being associated with a particular predefined meta-intent. The NLU module 210 may then use a meta slot tagger 338a to annotate one or more meta slots for the classification result from the meta-intent classifier 336a. A slot may be a named sub-string corresponding to a character string within the user input representing a basic semantic entity. For example, a slot for “pizza” may be [SL:dish]. In particular embodiments, a set of valid or expected named slots may be conditioned on the classified intent. As an example and not by way of limitation, for the intent [IN:play_music], a valid slot may be [SL:song_name]. In particular embodiments, the meta slot tagger 338a may tag generic slots such as references to items (e.g., the first), the type of slot, the value of the slot, etc. In particular embodiments, the NLU module 210 may process the domain classification/selection results using an intent classifier 336b. The intent classifier 336b may determine the user's intent associated with the user input. In particular embodiments, there may be one intent classifier 336b for each domain to determine the most possible intents in a given domain. As an example and not by way of limitation, the intent classifier 336b may be based on a machine-learning model that may take the domain classification/selection results as input and calculate a probability of the input being associated with a particular predefined intent. The NLU module 210 may then use a slot tagger 338b to annotate one or more slots associated with the user input. In particular embodiments, the slot tagger 338b may annotate the one or more slots for the n-grams of the user input. As an example and not by way of limitation, a user input may comprise “change 500 dollars in my account to Japanese yen.” The intent classifier 336b may take the user input as input and formulate it into a vector. The intent classifier 336b may then calculate probabilities of the user input being associated with different predefined intents based on a vector comparison between the vector representing the user input and the vectors representing different predefined intents. In a similar manner, the slot tagger 338b may take the user input as input and formulate each word into a vector. The slot tagger 338b may then calculate probabilities of each word being associated with different predefined slots based on a vector comparison between the vector representing the word and the vectors representing different predefined slots. The intent of the user may be classified as “changing money”. The slots of the user input may comprise “500”, “dollars”, “account”, and “Japanese yen”. The meta-intent of the user may be classified as “financial service”. The meta slot may comprise “finance”.

In particular embodiments, the natural-language understanding (NLU) module 210 may additionally extract information from one or more of a social graph, a knowledge graph, or a concept graph, and may retrieve a user's profile stored locally on the client system 130. The NLU module 210 may additionally consider contextual information when analyzing the user input. The NLU module 210 may further process information from these different sources by identifying and aggregating information, annotating n-grams of the user input, ranking the n-grams with confidence scores based on the aggregated information, and formulating the ranked n-grams into features that may be used by the NLU module 210 for understanding the user input. In particular embodiments, the NLU module 210 may identify one or more of a domain, an intent, or a slot from the user input in a personalized and context-aware manner. As an example and not by way of limitation, a user input may comprise “show me how to get to the coffee shop.” The NLU module 210 may identify a particular coffee shop that the user wants to go to based on the user's personal information and the associated contextual information. In particular embodiments, the NLU module 210 may comprise a lexicon of a particular language, a parser, and grammar rules to partition sentences into an internal representation. The NLU module 210 may also comprise one or more programs that perform naive semantics or stochastic semantic analysis, and may further use pragmatics to understand a user input. In particular embodiments, the parser may be based on a deep learning architecture comprising multiple long-short term memory (LSTM) networks. As an example and not by way of limitation, the parser may be based on a recurrent neural network grammar (RNNG) model, which is a type of recurrent and recursive LSTM algorithm. More information on natural-language understanding (NLU) may be found in U.S. patent application Ser. No. 16/011,062, filed 18 Jun. 2018, U.S. patent application Ser. No. 16/025,317, filed 2 Jul. 2018, and U.S. patent application Ser. No. 16/038,120, filed 17 Jul. 2018, each of which is incorporated by reference.

In particular embodiments, the output of the NLU module 210 may be sent to the entity resolution module 212 to resolve relevant entities. Entities may include, for example, unique users or concepts, each of which may have a unique identifier (ID). The entities may include one or more of a real-world entity (from general knowledge base), a user entity (from user memory), a contextual entity (device context/dialog context), or a value resolution (numbers, datetime, etc.). In particular embodiments, the entity resolution module 212 may comprise domain entity resolution 340 and generic entity resolution 342. The entity resolution module 212 may execute generic and domain-specific entity resolution. The generic entity resolution 342 may resolve the entities by categorizing the slots and meta slots into different generic topics. The domain entity resolution 340 may resolve the entities by categorizing the slots and meta slots into different domains. As an example and not by way of limitation, in response to the input of an inquiry of the advantages of a particular brand of electric car, the generic entity resolution 342 may resolve the referenced brand of electric car as vehicle and the domain entity resolution 340 may resolve the referenced brand of electric car as electric car.

In particular embodiments, entities may be resolved based on knowledge 350 about the world and the user. The assistant system 140 may extract ontology data from the graphs 352. As an example and not by way of limitation, the graphs 352 may comprise one or more of a knowledge graph, a social graph, or a concept graph. The ontology data may comprise the structural relationship between different slots/meta-slots and domains. The ontology data may also comprise information of how the slots/meta-slots may be grouped, related within a hierarchy where the higher level comprises the domain, and subdivided according to similarities and differences. For example, the knowledge graph may comprise a plurality of entities. Each entity may comprise a single record associated with one or more attribute values. The particular record may be associated with a unique entity identifier. Each record may have diverse values for an attribute of the entity. Each attribute value may be associated with a confidence probability and/or a semantic weight. A confidence probability for an attribute value represents a probability that the value is accurate for the given attribute. A semantic weight for an attribute value may represent how the value semantically appropriate for the given attribute considering all the available information. For example, the knowledge graph may comprise an entity of a book titled “BookName”, which may include information extracted from multiple content sources (e.g., an online social network, online encyclopedias, book review sources, media databases, and entertainment content sources), which may be deduped, resolved, and fused to generate the single unique record for the knowledge graph. In this example, the entity titled “BookName” may be associated with a “fantasy” attribute value for a “genre” entity attribute. More information on the knowledge graph may be found in U.S. patent application Ser. No. 16/048,049, filed 27 Jul. 2018, and U.S. patent application Ser. No. 16/048,101, filed 27 Jul. 2018, each of which is incorporated by reference.

In particular embodiments, the assistant user memory (AUM) 354 may comprise user episodic memories which help determine how to assist a user more effectively. The AUM 354 may be the central place for storing, retrieving, indexing, and searching over user data. As an example and not by way of limitation, the AUM 354 may store information such as contacts, photos, reminders, etc. Additionally, the AUM 354 may automatically synchronize data to the server and other devices (only for non-sensitive data). As an example and not by way of limitation, if the user sets a nickname for a contact on one device, all devices may synchronize and get that nickname based on the AUM 354. In particular embodiments, the AUM 354 may first prepare events, user sate, reminder, and trigger state for storing in a data store. Memory node identifiers (ID) may be created to store entry objects in the AUM 354, where an entry may be some piece of information about the user (e.g., photo, reminder, etc.) As an example and not by way of limitation, the first few bits of the memory node ID may indicate that this is a memory node ID type, the next bits may be the user ID, and the next bits may be the time of creation. The AUM 354 may then index these data for retrieval as needed. Index ID may be created for such purpose. In particular embodiments, given an “index key” (e.g., PHOTO_LOCATION) and “index value” (e.g., “San Francisco”), the AUM 354 may get a list of memory IDs that have that attribute (e.g., photos in San Francisco). As an example and not by way of limitation, the first few bits may indicate this is an index ID type, the next bits may be the user ID, and the next bits may encode an “index key” and “index value”. The AUM 354 may further conduct information retrieval with a flexible query language. Relation index ID may be created for such purpose. In particular embodiments, given a source memory node and an edge type, the AUM 354 may get memory IDs of all target nodes with that type of outgoing edge from the source. As an example and not by way of limitation, the first few bits may indicate this is a relation index ID type, the next bits may be the user ID, and the next bits may be a source node ID and edge type. In particular embodiments, the AUM 354 may help detect concurrent updates of different events. More information on episodic memories may be found in U.S. patent application Ser. No. 16/552,559, filed 27 Aug. 2019, which is incorporated by reference.

In particular embodiments, the entity resolution module 212 may use different techniques to resolve different types of entities. For real-world entities, the entity resolution module 212 may use a knowledge graph to resolve the span to the entities, such as “music track”, “movie”, etc. For user entities, the entity resolution module 212 may use user memory or some agents to resolve the span to user-specific entities, such as “contact”, “reminders”, or “relationship”. For contextual entities, the entity resolution module 212 may perform coreference based on information from the context engine 220 to resolve the references to entities in the context, such as “him”, “her”, “the first one”, or “the last one”. In particular embodiments, for coreference, the entity resolution module 212 may create references for entities determined by the NLU module 210. The entity resolution module 212 may then resolve these references accurately. As an example and not by way of limitation, a user input may comprise “find me the nearest grocery store and direct me there”. Based on coreference, the entity resolution module 212 may interpret “there” as “the nearest grocery store”. In particular embodiments, coreference may depend on the information from the context engine 220 and the dialog manager 216 so as to interpret references with improved accuracy. In particular embodiments, the entity resolution module 212 may additionally resolve an entity under the context (device context or dialog context), such as, for example, the entity shown on the screen or an entity from the last conversation history. For value resolutions, the entity resolution module 212 may resolve the mention to exact value in standardized form, such as numerical value, date time, address, etc.

In particular embodiments, the entity resolution module 212 may first perform a check on applicable privacy constraints in order to guarantee that performing entity resolution does not violate any applicable privacy policies. As an example and not by way of limitation, an entity to be resolved may be another user who specifies in their privacy settings that their identity should not be searchable on the online social network. In this case, the entity resolution module 212 may refrain from returning that user's entity identifier in response to a user input. By utilizing the described information obtained from the social graph, the knowledge graph, the concept graph, and the user profile, and by complying with any applicable privacy policies, the entity resolution module 212 may resolve entities associated with a user input in a personalized, context-aware, and privacy-protected manner.

In particular embodiments, the entity resolution module 212 may work with the ASR module 208 to perform entity resolution. The following example illustrates how the entity resolution module 212 may resolve an entity name. The entity resolution module 212 may first expand names associated with a user into their respective normalized text forms as phonetic consonant representations which may be phonetically transcribed using a double metaphone algorithm. The entity resolution module 212 may then determine an n-best set of candidate transcriptions and perform a parallel comprehension process on all of the phonetic transcriptions in the n-best set of candidate transcriptions. In particular embodiments, each transcription that resolves to the same intent may then be collapsed into a single intent. Each intent may then be assigned a score corresponding to the highest scoring candidate transcription for that intent. During the collapse, the entity resolution module 212 may identify various possible text transcriptions associated with each slot, correlated by boundary timing offsets associated with the slot's transcription. The entity resolution module 212 may then extract a subset of possible candidate transcriptions for each slot from a plurality (e.g., 1000) of candidate transcriptions, regardless of whether they are classified to the same intent. In this manner, the slots and intents may be scored lists of phrases. In particular embodiments, a new or running task capable of handling the intent may be identified and provided with the intent (e.g., a message composition task for an intent to send a message to another user). The identified task may then trigger the entity resolution module 212 by providing it with the scored lists of phrases associated with one of its slots and the categories against which it should be resolved. As an example and not by way of limitation, if an entity attribute is specified as “friend,” the entity resolution module 212 may run every candidate list of terms through the same expansion that may be run at matcher compilation time. Each candidate expansion of the terms may be matched in the precompiled trie matching structure. Matches may be scored using a function based at least in part on the transcribed input, matched form, and friend name. As another example and not by way of limitation, if an entity attribute is specified as “celebrity/notable person,” the entity resolution module 212 may perform parallel searches against the knowledge graph for each candidate set of terms for the slot output from the ASR module 208. The entity resolution module 212 may score matches based on matched person popularity and ASR-provided score signal. In particular embodiments, when the memory category is specified, the entity resolution module 212 may perform the same search against user memory. The entity resolution module 212 may crawl backward through user memory and attempt to match each memory (e.g., person recently mentioned in conversation, or seen and recognized via visual signals, etc.). For each entity, the entity resolution module 212 may employ matching similarly to how friends are matched (i.e., phonetic). In particular embodiments, scoring may comprise a temporal decay factor associated with a recency with which the name was previously mentioned. The entity resolution module 212 may further combine, sort, and dedupe all matches. In particular embodiments, the task may receive the set of candidates. When multiple high scoring candidates are present, the entity resolution module 212 may perform user-facilitated disambiguation (e.g., getting real-time user feedback from users on these candidates).

In particular embodiments, the context engine 220 may help the entity resolution module 212 improve entity resolution. The context engine 220 may comprise offline aggregators and an online inference service. The offline aggregators may process a plurality of data associated with the user that are collected from a prior time window. As an example and not by way of limitation, the data may include news feed posts/comments, interactions with news feed posts/comments, search history, etc., that are collected during a predetermined timeframe (e.g., from a prior 90-day window). The processing result may be stored in the context engine 220 as part of the user profile. The user profile of the user may comprise user profile data including demographic information, social information, and contextual information associated with the user. The user profile data may also include user interests and preferences on a plurality of topics, aggregated through conversations on news feed, search logs, messaging platforms, etc. The usage of a user profile may be subject to privacy constraints to ensure that a user's information can be used only for his/her benefit, and not shared with anyone else. More information on user profiles may be found in U.S. patent application Ser. No. 15/967,239, filed 30 Apr. 2018, which is incorporated by reference. In particular embodiments, the online inference service may analyze the conversational data associated with the user that are received by the assistant system 140 at a current time. The analysis result may be stored in the context engine 220 also as part of the user profile. In particular embodiments, both the offline aggregators and online inference service may extract personalization features from the plurality of data. The extracted personalization features may be used by other modules of the assistant system 140 to better understand user input. In particular embodiments, the entity resolution module 212 may process the information from the context engine 220 (e.g., a user profile) in the following steps based on natural-language processing (NLP). In particular embodiments, the entity resolution module 212 may tokenize text by text normalization, extract syntax features from text, and extract semantic features from text based on NLP. The entity resolution module 212 may additionally extract features from contextual information, which is accessed from dialog history between a user and the assistant system 140. The entity resolution module 212 may further conduct global word embedding, domain-specific embedding, and/or dynamic embedding based on the contextual information. The processing result may be annotated with entities by an entity tagger. Based on the annotations, the entity resolution module 212 may generate dictionaries. In particular embodiments, the dictionaries may comprise global dictionary features which can be updated dynamically offline. The entity resolution module 212 may rank the entities tagged by the entity tagger. In particular embodiments, the entity resolution module 212 may communicate with different graphs 352 including one or more of the social graph, the knowledge graph, or the concept graph to extract ontology data that is relevant to the retrieved information from the context engine 220. In particular embodiments, the entity resolution module 212 may further resolve entities based on the user profile, the ranked entities, and the information from the graphs 352.

In particular embodiments, the entity resolution module 212 may be driven by the task (corresponding to an agent 228). This inversion of processing order may make it possible for domain knowledge present in a task to be applied to pre-filter or bias the set of resolution targets when it is obvious and appropriate to do so. As an example and not by way of limitation, for the utterance “who is John?” no clear category is implied in the utterance. Therefore, the entity resolution module 212 may resolve “John” against everything. As another example and not by way of limitation, for the utterance “send a message to John”, the entity resolution module 212 may easily determine “John” refers to a person that one can message. As a result, the entity resolution module 212 may bias the resolution to a friend. As another example and not by way of limitation, for the utterance “what is John's most famous album?” To resolve “John”, the entity resolution module 212 may first determine the task corresponding to the utterance, which is finding a music album. The entity resolution module 212 may determine that entities related to music albums include singers, producers, and recording studios. Therefore, the entity resolution module 212 may search among these types of entities in a music domain to resolve “John.”

In particular embodiments, the output of the entity resolution module 212 may be sent to the dialog manager 216 to advance the flow of the conversation with the user. The dialog manager 216 may be an asynchronous state machine that repeatedly updates the state and selects actions based on the new state. The dialog manager 216 may additionally store previous conversations between the user and the assistant system 140. In particular embodiments, the dialog manager 216 may conduct dialog optimization. Dialog optimization relates to the challenge of understanding and identifying the most likely branching options in a dialog with a user. As an example and not by way of limitation, the assistant system 140 may implement dialog optimization techniques to obviate the need to confirm who a user wants to call because the assistant system 140 may determine a high confidence that a person inferred based on context and available data is the intended recipient. In particular embodiments, the dialog manager 216 may implement reinforcement learning frameworks to improve the dialog optimization. The dialog manager 216 may comprise dialog intent resolution 356, the dialog state tracker 218, and the action selector 222. In particular embodiments, the dialog manager 216 may execute the selected actions and then call the dialog state tracker 218 again until the action selected requires a user response, or there are no more actions to execute. Each action selected may depend on the execution result from previous actions. In particular embodiments, the dialog intent resolution 356 may resolve the user intent associated with the current dialog session based on dialog history between the user and the assistant system 140. The dialog intent resolution 356 may map intents determined by the NLU module 210 to different dialog intents. The dialog intent resolution 356 may further rank dialog intents based on signals from the NLU module 210, the entity resolution module 212, and dialog history between the user and the assistant system 140.

In particular embodiments, the dialog state tracker 218 may use a set of operators to track the dialog state. The operators may comprise necessary data and logic to update the dialog state. Each operator may act as delta of the dialog state after processing an incoming user input. In particular embodiments, the dialog state tracker 218 may a comprise a task tracker, which may be based on task specifications and different rules. The dialog state tracker 218 may also comprise a slot tracker and coreference component, which may be rule based and/or recency based. The coreference component may help the entity resolution module 212 to resolve entities. In alternative embodiments, with the coreference component, the dialog state tracker 218 may replace the entity resolution module 212 and may resolve any references/mentions and keep track of the state. In particular embodiments, the dialog state tracker 218 may convert the upstream results into candidate tasks using task specifications and resolve arguments with entity resolution. Both user state (e.g., user's current activity) and task state (e.g., triggering conditions) may be tracked. Given the current state, the dialog state tracker 218 may generate candidate tasks the assistant system 140 may process and perform for the user. As an example and not by way of limitation, candidate tasks may include “show suggestion,” “get weather information,” or “take photo.” In particular embodiments, the dialog state tracker 218 may generate candidate tasks based on available data from, for example, a knowledge graph, a user memory, and a user task history. In particular embodiments, the dialog state tracker 218 may then resolve the triggers object using the resolved arguments. As an example and not by way of limitation, a user input “remind me to call mom when she's online and I'm home tonight” may perform the conversion from the NLU output to the triggers representation by the dialog state tracker 218 as illustrated in Table 1 below:

TABLE 1
Example Conversion from NLU Output to Triggers Representation

| NLU Ontology Representation: | | Triggers Representation: |
|---|---|---|
| [IN:CREATE_SMART_REMINDER | → | Triggers: { |
| Remind me to | | andTriggers: [ |
| [SL:TODO call mom] when | | condition: {ContextualEvent(mom is |
| [SL:TRIGGER_CONJUNCTION | | online)}, |
| [IN:GET_TRIGGER | | condition: {ContextualEvent(location |
| [SL:TRIGGER_SOCIAL_UPDATE | | is home)}, |
| she's online] and I'm | | condition: {ContextualEvent(time is |
| [SL:TRIGGER_LOCATION home] | | tonight)}]))]} |
| [SL:DATE_TIME tonight] | | |
| ] | | |
| ] | | |
| ] | | |

In the above example, “mom,” “home,” and “tonight” are represented by their respective entities: personEntity, locationEntity, datetimeEntity.

In particular embodiments, the dialog manager 216 may map events determined by the context engine 220 to actions. As an example and not by way of limitation, an action may be a natural-language generation (NLG) action, a display or overlay, a device action, or a retrieval action. The dialog manager 216 may also perform context tracking and interaction management. Context tracking may comprise aggregating real-time stream of events into a unified user state. Interaction management may comprise selecting optimal action in each state. In particular embodiments, the dialog state tracker 218 may perform context tracking (i.e., tracking events related to the user). To support processing of event streams, the dialog state tracker 218a may use an event handler (e.g., for disambiguation, confirmation, request) that may consume various types of events and update an internal assistant state. Each event type may have one or more handlers. Each event handler may be modifying a certain slice of the assistant state. In particular embodiments, the event handlers may be operating on disjoint subsets of the state (i.e., only one handler may have write-access to a particular field in the state). In particular embodiments, all event handlers may have an opportunity to process a given event. As an example and not by way of limitation, the dialog state tracker 218 may run all event handlers in parallel on every event, and then may merge the state updates proposed by each event handler (e.g., for each event, most handlers may return a NULL update).

In particular embodiments, the dialog state tracker 218 may work as any programmatic handler (logic) that requires versioning. In particular embodiments, instead of directly altering the dialog state, the dialog state tracker 218 may be a side-effect free component and generate n-best candidates of dialog state update operators that propose updates to the dialog state. The dialog state tracker 218 may comprise intent resolvers containing logic to handle different types of NLU intent based on the dialog state and generate the operators. In particular embodiments, the logic may be organized by intent handler, such as a disambiguation intent handler to handle the intents when the assistant system 140 asks for disambiguation, a confirmation intent handler that comprises the logic to handle confirmations, etc. Intent resolvers may combine the turn intent together with the dialog state to generate the contextual updates for a conversation with the user. A slot resolution component may then recursively resolve the slots in the update operators with resolution providers including the knowledge graph and domain agents. In particular embodiments, the dialog state tracker 218 may update/rank the dialog state of the current dialog session. As an example and not by way of limitation, the dialog state tracker 218 may update the dialog state as “completed” if the dialog session is over. As another example and not by way of limitation, the dialog state tracker 218 may rank the dialog state based on a priority associated with it.

In particular embodiments, the dialog state tracker 218 may communicate with the action selector 222 about the dialog intents and associated content objects. In particular embodiments, the action selector 222 may rank different dialog hypotheses for different dialog intents. The action selector 222 may take candidate operators of dialog state and consult the dialog policies 360 to decide what actions should be executed. In particular embodiments, a dialog policy 360 may a tree-based policy, which is a pre-constructed dialog plan. Based on the current dialog state, a dialog policy 360 may choose a node to execute and generate the corresponding actions. As an example and not by way of limitation, the tree-based policy may comprise topic grouping nodes and dialog action (leaf) nodes. In particular embodiments, a dialog policy 360 may also comprise a data structure that describes an execution plan of an action by an agent 228. A dialog policy 360 may further comprise multiple goals related to each other through logical operators. In particular embodiments, a goal may be an outcome of a portion of the dialog policy and it may be constructed by the dialog manager 216. A goal may be represented by an identifier (e.g., string) with one or more named arguments, which parameterize the goal. As an example and not by way of limitation, a goal with its associated goal argument may be represented as {confirm artist, args:{artist: “Madonna”}}. In particular embodiments, goals may be mapped to leaves of the tree of the tree-structured representation of the dialog policy 360.

In particular embodiments, the assistant system 140 may use hierarchical dialog policies 360 with general policy 362 handling the cross-domain business logic and task policies 364 handling the task/domain specific logic. The general policy 362 may be used for actions that are not specific to individual tasks. The general policy 362 may be used to determine task stacking and switching, proactive tasks, notifications, etc. The general policy 362 may comprise handling low-confidence intents, internal errors, unacceptable user response with retries, and/or skipping or inserting confirmation based on ASR or NLU confidence scores. The general policy 362 may also comprise the logic of ranking dialog state update candidates from the dialog state tracker 218 output and pick the one to update (such as picking the top ranked task intent). In particular embodiments, the assistant system 140 may have a particular interface for the general policy 362, which allows for consolidating scattered cross-domain policy/business-rules, especial those found in the dialog state tracker 218, into a function of the action selector 222. The interface for the general policy 362 may also allow for authoring of self-contained sub-policy units that may be tied to specific situations or clients (e.g., policy functions that may be easily switched on or off based on clients, situation). The interface for the general policy 362 may also allow for providing a layering of policies with back-off, i.e., multiple policy units, with highly specialized policy units that deal with specific situations being backed up by more general policies 362 that apply in wider circumstances. In this context the general policy 362 may alternatively comprise intent or task specific policy.

In particular embodiments, a task policy 364 may comprise the logic for action selector 222 based on the task and current state. The task policy 364 may be dynamic and ad-hoc. In particular embodiments, the types of task policies 364 may include one or more of the following types: (1) manually crafted tree-based dialog plans; (2) coded policy that directly implements the interface for generating actions; (3) configurator-specified slot-filling tasks; or (4) machine-learning model based policy learned from data. In particular embodiments, the assistant system 140 may bootstrap new domains with rule-based logic and later refine the task policies 364 with machine-learning models. In particular embodiments, the general policy 362 may pick one operator from the candidate operators to update the dialog state, followed by the selection of a user facing action by a task policy 364. Once a task is active in the dialog state, the corresponding task policy 364 may be consulted to select right actions.

In particular embodiments, the action selector 222 may select an action based on one or more of the event determined by the context engine 220, the dialog intent and state, the associated content objects, and the guidance from dialog policies 360. Each dialog policy 360 may be subscribed to specific conditions over the fields of the state. After an event is processed and the state is updated, the action selector 222 may run a fast search algorithm (e.g., similarly to the Boolean satisfiability) to identify which policies should be triggered based on the current state. In particular embodiments, if multiple policies are triggered, the action selector 222 may use a tie-breaking mechanism to pick a particular policy. Alternatively, the action selector 222 may use a more sophisticated approach which may dry-run each policy and then pick a particular policy which may be determined to have a high likelihood of success. In particular embodiments, mapping events to actions may result in several technical advantages for the assistant system 140. One technical advantage may include that each event may be a state update from the user or the user's physical/digital environment, which may or may not trigger an action from assistant system 140. Another technical advantage may include possibilities to handle rapid bursts of events (e.g., user enters a new building and sees many people) by first consuming all events to update state, and then triggering action(s) from the final state. Another technical advantage may include consuming all events into a single global assistant state.

In particular embodiments, the action selector 222 may take the dialog state update operators as part of the input to select the dialog action. The execution of the dialog action may generate a set of expectations to instruct the dialog state tracker 218 to handle future turns. In particular embodiments, an expectation may be used to provide context to the dialog state tracker 218 when handling the user input from next turn. As an example and not by way of limitation, slot request dialog action may have the expectation of proving a value for the requested slot. In particular embodiments, both the dialog state tracker 218 and the action selector 222 may not change the dialog state until the selected action is executed. This may allow the assistant system 140 to execute the dialog state tracker 218 and the action selector 222 for processing speculative ASR results and to do n-best ranking with dry runs.

In particular embodiments, the action selector 222 may call different agents 228 for task execution. Meanwhile, the dialog manager 216 may receive an instruction to update the dialog state. As an example and not by way of limitation, the update may comprise awaiting agents' 228 response. An agent 228 may select among registered content providers to complete the action. The data structure may be constructed by the dialog manager 216 based on an intent and one or more slots associated with the intent. In particular embodiments, the agents 228 may comprise first-party agents and third-party agents. In particular embodiments, first-party agents may comprise internal agents that are accessible and controllable by the assistant system 140 (e.g. agents associated with services provided by the online social network, such as messaging services or photo-share services). In particular embodiments, third-party agents may comprise external agents that the assistant system 140 has no control over (e.g., third-party online music application agents, ticket sales agents). The first-party agents may be associated with first-party providers that provide content objects and/or services hosted by the social-networking system 160. The third-party agents may be associated with third-party providers that provide content objects and/or services hosted by the third-party system 170. In particular embodiments, each of the first-party agents or third-party agents may be designated for a particular domain. As an example and not by way of limitation, the domain may comprise weather, transportation, music, shopping, social, videos, photos, events, locations, and/or work. In particular embodiments, the assistant system 140 may use a plurality of agents 228 collaboratively to respond to a user input. As an example and not by way of limitation, the user input may comprise “direct me to my next meeting.” The assistant system 140 may use a calendar agent to retrieve the location of the next meeting. The assistant system 140 may then use a navigation agent to direct the user to the next meeting.

In particular embodiments, the dialog manager 216 may support multi-turn compositional resolution of slot mentions. For a compositional parse from the NLU module 210, the resolver may recursively resolve the nested slots. The dialog manager 216 may additionally support disambiguation for the nested slots. As an example and not by way of limitation, the user input may be “remind me to call Alex”. The resolver may need to know which Alex to call before creating an actionable reminder to-do entity. The resolver may halt the resolution and set the resolution state when further user clarification is necessary for a particular slot. The general policy 362 may examine the resolution state and create corresponding dialog action for user clarification. In dialog state tracker 218, based on the user input and the last dialog action, the dialog manager 216 may update the nested slot. This capability may allow the assistant system 140 to interact with the user not only to collect missing slot values but also to reduce ambiguity of more complex/ambiguous utterances to complete the task. In particular embodiments, the dialog manager 216 may further support requesting missing slots in a nested intent and multi-intent user inputs (e.g., “take this photo and send it to Dad”). In particular embodiments, the dialog manager 216 may support machine-learning models for more robust dialog experience. As an example and not by way of limitation, the dialog state tracker 218 may use neural network based models (or any other suitable machine-learning models) to model belief over task hypotheses. As another example and not by way of limitation, for action selector 222, highest priority policy units may comprise white-list/black-list overrides, which may have to occur by design; middle priority units may comprise machine-learning models designed for action selection; and lower priority units may comprise rule-based fallbacks when the machine-learning models elect not to handle a situation. In particular embodiments, machine-learning model based general policy unit may help the assistant system 140 reduce redundant disambiguation or confirmation steps, thereby reducing the number of turns to execute the user input.

In particular embodiments, the determined actions by the action selector 222 may be sent to the delivery system 230. The delivery system 230 may comprise a CU composer 370, a response generation component 380, a dialog state writing component 382, and a text-to-speech (TTS) component 390. Specifically, the output of the action selector 222 may be received at the CU composer 370. In particular embodiments, the output from the action selector 222 may be formulated as a <k,c,u,d> tuple, in which k indicates a knowledge source, c indicates a communicative goal, u indicates a user model, and d indicates a discourse model.

In particular embodiments, the CU composer 370 may generate a communication content for the user using a natural-language generation (NLG) component 372. In particular embodiments, the NLG component 372 may use different language models and/or language templates to generate natural-language outputs. The generation of natural-language outputs may be application specific. The generation of natural-language outputs may be also personalized for each user. In particular embodiments, the NLG component 372 may comprise a content determination component, a sentence planner, and a surface realization component. The content determination component may determine the communication content based on the knowledge source, communicative goal, and the user's expectations. As an example and not by way of limitation, the determining may be based on a description logic. The description logic may comprise, for example, three fundamental notions which are individuals (representing objects in the domain), concepts (describing sets of individuals), and roles (representing binary relations between individuals or concepts). The description logic may be characterized by a set of constructors that allow the natural-language generator to build complex concepts/roles from atomic ones. In particular embodiments, the content determination component may perform the following tasks to determine the communication content. The first task may comprise a translation task, in which the input to the NLG component 372 may be translated to concepts. The second task may comprise a selection task, in which relevant concepts may be selected among those resulted from the translation task based on the user model. The third task may comprise a verification task, in which the coherence of the selected concepts may be verified. The fourth task may comprise an instantiation task, in which the verified concepts may be instantiated as an executable file that can be processed by the NLG component 372. The sentence planner may determine the organization of the communication content to make it human understandable. The surface realization component may determine specific words to use, the sequence of the sentences, and the style of the communication content.

In particular embodiments, the CU composer 370 may also determine a modality of the generated communication content using the UI payload generator 374. Since the generated communication content may be considered as a response to the user input, the CU composer 370 may additionally rank the generated communication content using a response ranker 376. As an example and not by way of limitation, the ranking may indicate the priority of the response. In particular embodiments, the CU composer 370 may comprise a natural-language synthesis (NLS) component that may be separate from the NLG component 372. The NLS component may specify attributes of the synthesized speech generated by the CU composer 370, including gender, volume, pace, style, or register, in order to customize the response for a particular user, task, or agent. The NLS component may tune language synthesis without engaging the implementation of associated tasks. In particular embodiments, the CU composer 370 may check privacy constraints associated with the user to make sure the generation of the communication content follows the privacy policies. More information on customizing natural-language generation (NLG) may be found in U.S. patent application Ser. No. 15/967,279, filed 30 Apr. 2018, and U.S. patent application Ser. No. 15/966,455, filed 30 Apr. 2018, which is incorporated by reference.

In particular embodiments, the delivery system 230 may perform different tasks based on the output of the CU composer 370. These tasks may include writing (i.e., storing/updating) the dialog state into the data store 330 using the dialog state writing component 382 and generating responses using the response generation component 380. In particular embodiments, the output of the CU composer 370 may be additionally sent to the TTS component 390 if the determined modality of the communication content is audio. In particular embodiments, the output from the delivery system 230 comprising one or more of the generated responses, the communication content, or the speech generated by the TTS component 390 may be then sent back to the dialog manager 216.

In particular embodiments, the orchestrator 206 may determine, based on the output of the entity resolution module 212, whether to processing a user input on the client system 130 or on the server, or in the third operational mode (i.e., blended mode) using both. Besides determining how to process the user input, the orchestrator 206 may receive the results from the agents 228 and/or the results from the delivery system 230 provided by the dialog manager 216. The orchestrator 206 may then forward these results to the arbitrator 226. The arbitrator 226 may aggregate these results, analyze them, select the best result, and provide the selected result to the render output module 232. In particular embodiments, the arbitrator 226 may consult with dialog policies 360 to obtain the guidance when analyzing these results. In particular embodiments, the render output module 232 may generate a response that is suitable for the client system 130.

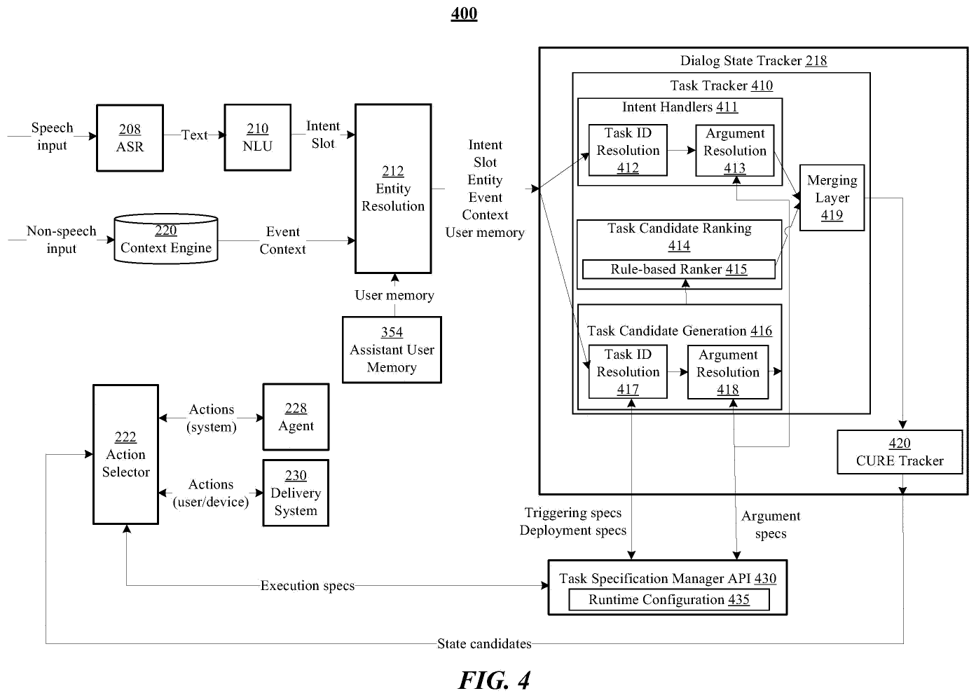

FIG. 4 illustrates an example task-centric flow diagram 400 of processing a user input. In particular embodiments, the assistant system 140 may assist users not only with voice-initiated experiences but also more proactive, multi-modal experiences that are initiated on understanding user context. In particular embodiments, the assistant system 140 may rely on assistant tasks for such purpose. An assistant task may be a central concept that is shared across the whole assistant stack to understand user intention, interact with the user and the world to complete the right task for the user. In particular embodiments, an assistant task may be the primitive unit of assistant capability. It may comprise data fetching, updating some state, executing some command, or complex tasks composed of a smaller set of tasks. Completing a task correctly and successfully to deliver the value to the user may be the goal that the assistant system 140 is optimized for. In particular embodiments, an assistant task may be defined as a capability or a feature. The assistant task may be shared across multiple product surfaces if they have exactly the same requirements so it may be easily tracked. It may also be passed from device to device, and easily picked up mid-task by another device since the primitive unit is consistent. In addition, the consistent format of the assistant task may allow developers working on different modules in the assistant stack to more easily design around it. Furthermore, it may allow for task sharing. As an example and not by way of limitation, if a user is listening to music on smart glasses, the user may say “play this music on my phone.” In the event that the phone hasn't been woken or has a task to execute, the smart glasses may formulate a task that is provided to the phone, which may then be executed by the phone to start playing music. In particular embodiments, the assistant task may be retained by each surface separately if they have different expected behaviors. In particular embodiments, the assistant system 140 may identify the right task based on user inputs in different modality or other signals, conduct conversation to collect all necessary information, and complete that task with action selector 222 implemented internally or externally, on server or locally product surfaces. In particular embodiments, the assistant stack may comprise a set of processing components from wake-up, recognizing user inputs, understanding user intention, reasoning about the tasks, fulfilling a task to generate natural-language response with voices.

In particular embodiments, the user input may comprise speech input. The speech input may be received at the ASR module 208 for extracting the text transcription from the speech input. The ASR module 208 may use statistical models to determine the most likely sequences of words that correspond to a given portion of speech received by the assistant system 140 as audio input. The models may include one or more of hidden Markov models, neural networks, deep learning models, or any combination thereof. The received audio input may be encoded into digital data at a particular sampling rate (e.g., 16, 44.1, or 96 kHz) and with a particular number of bits representing each sample (e.g., 8, 16, of 24 bits).

In particular embodiments, the ASR module 208 may comprise one or more of a grapheme-to-phoneme (G2P) model, a pronunciation learning model, a personalized acoustic model, a personalized language model (PLM), or an end-pointing model. In particular embodiments, the grapheme-to-phoneme (G2P) model may be used to determine a user's grapheme-to-phoneme style (i.e., what it may sound like when a particular user speaks a particular word). In particular embodiments, the personalized acoustic model may be a model of the relationship between audio signals and the sounds of phonetic units in the language. Therefore, such personalized acoustic model may identify how a user's voice sounds. The personalized acoustical model may be generated using training data such as training speech received as audio input and the corresponding phonetic units that correspond to the speech. The personalized acoustical model may be trained or refined using the voice of a particular user to recognize that user's speech. In particular embodiments, the personalized language model may then determine the most likely phrase that corresponds to the identified phonetic units for a particular audio input. The personalized language model may be a model of the probabilities that various word sequences may occur in the language. The sounds of the phonetic units in the audio input may be matched with word sequences using the personalized language model, and greater weights may be assigned to the word sequences that are more likely to be phrases in the language. The word sequence having the highest weight may be then selected as the text that corresponds to the audio input. In particular embodiments, the personalized language model may also be used to predict what words a user is most likely to say given a context. In particular embodiments, the end-pointing model may detect when the end of an utterance is reached. In particular embodiments, based at least in part on a limited computing power of the client system 130, the assistant system 140 may optimize the personalized language model at runtime during the client-side process. As an example and not by way of limitation, the assistant system 140 may pre-compute a plurality of personalized language models for a plurality of possible subjects a user may talk about. When a user input is associated with a request for assistance, the assistant system 140 may promptly switch between and locally optimize the pre-computed language models at runtime based on user activities. As a result, the assistant system 140 may preserve computational resources while efficiently identifying a subject matter associated with the user input. In particular embodiments, the assistant system 140 may also dynamically re-learn user pronunciations at runtime.

In particular embodiments, the user input may comprise non-speech input. The non-speech input may be received at the context engine 220 for determining events and context from the non-speech input. The context engine 220 may determine multi-modal events comprising voice/text intents, location updates, visual events, touch, gaze, gestures, activities, device/application events, and/or any other suitable type of events. The voice/text intents may depend on the ASR module 208 and the NLU module 210. The location updates may be consumed by the dialog manager 216 to support various proactive/reactive scenarios. The visual events may be based on person or object appearing in the user's field of view. These events may be consumed by the dialog manager 216 and recorded in transient user state to support visual co-reference (e.g., resolving “that” in “how much is that shirt?” and resolving “him” in “send him my contact”). The gaze, gesture, and activity may result in flags being set in the transient user state (e.g., user is running) which may condition the action selector 222. For the device/application events, if an application makes an update to the device state, this may be published to the assistant system 140 so that the dialog manager 216 may use this context (what is currently displayed to the user) to handle reactive and proactive scenarios. As an example and not by way of limitation, the context engine 220 may cause a push notification message to be displayed on a display screen of the user's client system 130. The user may interact with the push notification message, which may initiate a multi-modal event (e.g., an event workflow for replying to a message received from another user). Other example multi-modal events may include seeing a friend, seeing a landmark, being at home, running, faces being recognized in a photo, starting a call with touch, taking a photo with touch, opening an application, etc. In particular embodiments, the context engine 220 may also determine world/social events based on world/social updates (e.g., weather changes, a friend getting online). The social updates may comprise events that a user is subscribed to, (e.g., friend's birthday, posts, comments, other notifications). These updates may be consumed by the dialog manager 216 to trigger proactive actions based on context (e.g., suggesting a user call a friend on their birthday, but only if the user is not focused on something else). As an example and not by way of limitation, receiving a message may be a social event, which may trigger the task of reading the message to the user.

In particular embodiments, the text transcription from the ASR module 208 may be sent to the NLU module 210. The NLU module 210 may process the text transcription and extract the user intention (i.e., intents) and parse the slots or parsing result based on the linguistic ontology. In particular embodiments, the intents and slots from the NLU module 210 and/or the events and contexts from the context engine 220 may be sent to the entity resolution module 212. In particular embodiments, the entity resolution module 212 may resolve entities associated with the user input based on the output from the NLU module 210 and/or the context engine 220. The entity resolution module 212 may use different techniques to resolve the entities, including accessing user memory from the assistant user memory (AUM) 354. In particular embodiments, the AUM 354 may comprise user episodic memories helpful for resolving the entities by the entity resolution module 212. The AUM 354 may be the central place for storing, retrieving, indexing, and searching over user data.

In particular embodiments, the entity resolution module 212 may provide one or more of the intents, slots, entities, events, context, or user memory to the dialog state tracker 218. The dialog state tracker 218 may identify a set of state candidates for a task accordingly, conduct interaction with the user to collect necessary information to fill the state, and call the action selector 222 to fulfill the task. In particular embodiments, the dialog state tracker 218 may comprise a task tracker 410. The task tracker 410 may track the task state associated with an assistant task. In particular embodiments, a task state may be a data structure persistent cross interaction turns and updates in real time to capture the state of the task during the whole interaction. The task state may comprise all the current information about a task execution status, such as arguments, confirmation status, confidence score, etc. Any incorrect or outdated information in the task state may lead to failure or incorrect task execution. The task state may also serve as a set of contextual information for many other components such as the ASR module 208, the NLU module 210, etc.

In particular embodiments, the task tracker 410 may comprise intent handlers 411, task candidate ranking module 414, task candidate generation module 416, and merging layer 419. In particular embodiments, a task may be identified by its ID name. The task ID may be used to associate corresponding component assets if it is not explicitly set in the task specification, such as dialog policy 360, agent execution, NLG dialog act, etc. Therefore, the output from the entity resolution module 212 may be received by a task ID resolution component 417 of the task candidate generation module 416 to resolve the task ID of the corresponding task. In particular embodiments, the task ID resolution component 417 may call a task specification manager API 430 to access the triggering specifications and deployment specifications for resolving the task ID. Given these specifications, the task ID resolution component 417 may resolve the task ID using intents, slots, dialog state, context, and user memory.

In particular embodiments, the technical specification of a task may be defined by a task specification. The task specification may be used by the assistant system 140 to trigger a task, conduct dialog conversation, and find a right execution module (e.g., agents 228) to execute the task. The task specification may be an implementation of the product requirement document. It may serve as the general contract and requirements that all the components agreed on. It may be considered as an assembly specification for a product, while all development partners deliver the modules based on the specification. In particular embodiments, an assistant task may be defined in the implementation by a specification. As an example and not by way of limitation, the task specification may be defined as the following categories. One category may be a basic task schema which comprises the basic identification information such as ID, name, and the schema of the input arguments. Another category may be a triggering specification, which is about how a task can be triggered, such as intents, event message ID, etc. Another category may be a conversational specification, which is for dialog manager 216 to conduct the conversation with users and systems. Another category may be an execution specification, which is about how the task will be executed and fulfilled. Another category may be a deployment specification, which is about how a feature will be deployed to certain surfaces, local, and group of users.

In particular embodiments, the task specification manager API 430 may be an API for accessing a task specification manager. The task specification manager may be a module in the runtime stack for loading the specifications from all the tasks and providing interfaces to access all the tasks specifications for detailed information or generating task candidates. In particular embodiments, the task specification manager may be accessible for all components in the runtime stack via the task specification manager API 430. The task specification manager may comprise a set of static utility functions to manage tasks with the task specification manager, such as filtering task candidates by platform. Before landing the task specification, the assistant system 140 may also dynamically load the task specifications to support end-to-end development on the development stage.

In particular embodiments, the task specifications may be grouped by domains and stored in runtime configurations 435. The runtime stack may load all the task specifications from the runtime configurations 435 during the building time. In particular embodiments, in the runtime configurations 435, for a domain, there may be a cconf file and a cinc file (e.g., sidechef_task.cconf and sidechef_task.inc). As an example and not by way of limitation, <domain>_tasks.cconf may comprise all the details of the task specifications. As another example and not by way of limitation, <domain>_tasks.cinc may provide a way to override the generated specification if there is no support for that feature yet.

In particular embodiments, a task execution may require a set of arguments to execute. Therefore, an argument resolution component 418 may resolve the argument names using the argument specifications for the resolved task ID. These arguments may be resolved based on NLU outputs (e.g., slot [SL:contact]), dialog state (e.g., short-term calling history), user memory (such as user preferences, location, long-term calling history, etc.), or device context (such as timer states, screen content, etc.). In particular embodiments, the argument modality may be text, audio, images or other structured data. The slot to argument mapping may be defined by a filling strategy and/or language ontology. In particular embodiments, given the task triggering specifications, the task candidate generation module 416 may look for the list of tasks to be triggered as task candidates based on the resolved task ID and arguments.

In particular embodiments, the generated task candidates may be sent to the task candidate ranking module 414 to be further ranked. The task candidate ranking module 414 may use a rule-based ranker 415 to rank them. In particular embodiments, the rule-based ranker 415 may comprise a set of heuristics to bias certain domain tasks. The ranking logic may be described as below with principles of context priority. In particular embodiments, the priority of a user specified task may be higher than an on-foreground task. The priority of the on-foreground task may be higher than a device-domain task when the intent is a meta intent. The priority of the device-domain task may be higher than a task of a triggering intent domain. As an example and not by way of limitation, the ranking may pick the task if the task domain is mentioned or specified in the utterance, such as “create a timer in TIMER app”. As another example and not by way of imitation, the ranking may pick the task if the task domain is on foreground or active state, such as “stop the timer” to stop the timer while the TIMER app is on foreground and there is an active timer. As yet another example and not by way of imitation, the ranking may pick the task if the intent is general meta intent, and the task is device control while there is no other active application or active state. As yet another example and not by way of imitation, the ranking may pick the task if the task is the same as the intent domain. In particular embodiments, the task candidate ranking module 414 may customize some more logic to check the match of intent/slot/entity types. The ranked task candidates may be sent to the merging layer 419.

In particular embodiments, the output from the entity resolution module 212 may also sent to a task ID resolution component 412 of the intent handlers 411. The task ID resolution component 412 may resolve the task ID of the corresponding task similarly to the task ID resolution component 417. In particular embodiments, the intent handlers 411 may additionally comprise an argument resolution component 413. The argument resolution component 413 may resolve the argument names using the argument specifications for the resolved task ID similarly to the argument resolution component 418. In particular embodiments, intent handlers 411 may deal with task agnostic features and may not be expressed within the task specifications which are task specific. Intent handlers 411 may output state candidates other than task candidates such as argument update, confirmation update, disambiguation update, etc. In particular embodiments, some tasks may require very complex triggering conditions or very complex argument filling logic that may not be reusable by other tasks even if they were supported in the task specifications (e.g., in-call voice commands, media tasks via [IN:PLAY_MEDIA], etc.). Intent handlers 411 may be also suitable for such type of tasks. In particular embodiments, the results from the intent handlers 411 may take precedence over the results from the task candidate ranking module 414. The results from the intent handlers 411 may be also sent to the merging layer 419.

In particular embodiments, the merging layer 419 may combine the results from the intent handlers 411 and the results from the task candidate ranking module 414. The dialog state tracker 218 may suggest each task as a new state for the dialog policies 360 to select from, thereby generating a list of state candidates. The merged results may be further sent to a conversational understanding reinforcement engine (CURE) tracker 420. In particular embodiments, the CURE tracker 420 may be a personalized learning process to improve the determination of the state candidates by the dialog state tracker 218 under different contexts using real-time user feedback. More information on conversational understanding reinforcement engine may be found in U.S. patent application Ser. No. 17/186,459, filed 26 Feb. 2021, which is incorporated by reference.

In particular embodiments, the state candidates generated by the CURE tracker 420 may be sent to the action selector 222. The action selector 222 may consult with the task policies 364, which may be generated from execution specifications accessed via the task specification manager API 430. In particular embodiments, the execution specifications may describe how a task should be executed and what actions the action selector 222 may need to take to complete the task.

In particular embodiments, the action selector 222 may determine actions associated with the system. Such actions may involve the agents 228 to execute. As a result, the action selector 222 may send the system actions to the agents 228 and the agents 228 may return the execution results of these actions. In particular embodiments, the action selector may determine actions associated with the user or device. Such actions may need to be executed by the delivery system 230. As a result, the action selector 222 may send the user/device actions to the delivery system 230 and the delivery system 230 may return the execution results of these actions.

The embodiments disclosed herein may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

Natural Utterance Annotation for Nuanced Conversation with Estimated Distribution for Assistant Systems

Abstract

Existing datasets in conversational recommendation are mostly constructed in a way that the user utterances closely follow the system ontology. However, in real-world scenarios, the users can speak freely without restrictions. In particular embodiments, the assistant system 140 may model user preference with estimated distributions from natural responses. To learn such a preference distribution, new challenges are posed combining the reasonings from user situations, common sense knowledge, and world/entity knowledge. The embodiments disclosed herein construct a new dataset named NUANCED, that focuses on such realistic settings. The embodiments disclosed herein design a pipeline to build the dataset combining dialogue simulation and human annotator rewriting. Employing the professional linguistics team, the embodiments disclosed herein provide a dataset consisting 5.1k dialogues, 26k turns of high-quality user responses. The embodiments disclosed herein design various baselines and conduct comprehensive experiments, demonstrating the usefulness and challenges of our dataset. Our new dataset may serve as a valuable resource to bridge the gap between current research status and real-world usages, so as to help advance a more intelligent, natural, and engaging assistant system 140.

Introduction

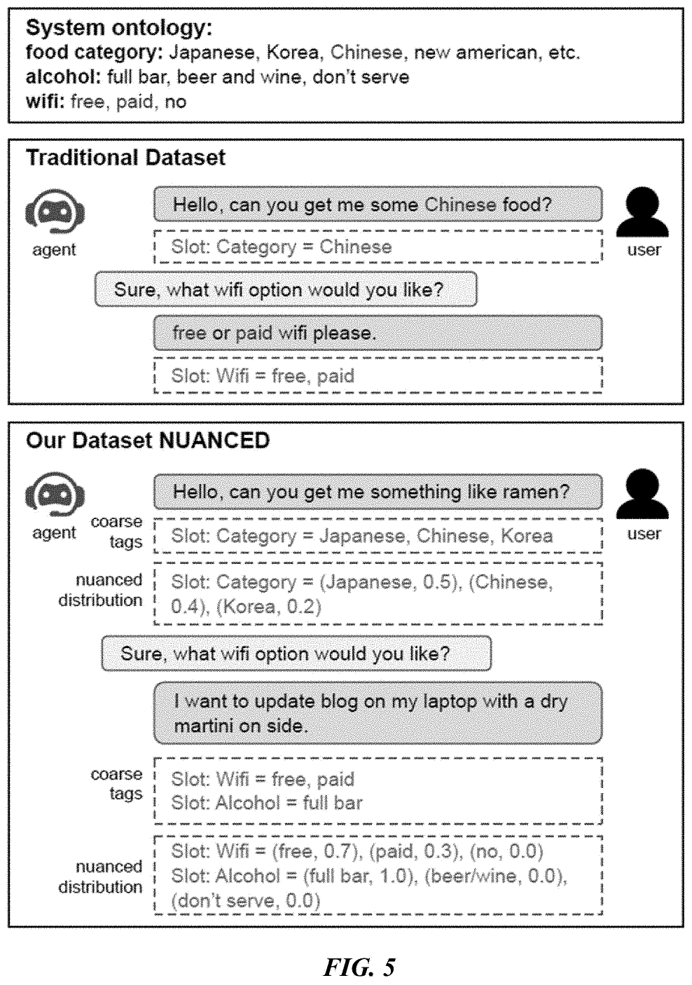

FIG. 5 illustrates examples of traditional dataset and NUANCED. Conversational artificial intelligence (ConvAI) is one of the long-standing research problems in natural language processing. With the surge of neural models recently, there have been increasing interests in building intelligent dialogue agents to assist users, such as task-oriented dialogue system (Wen et al., 2017; Mrksic et al., 2017; Budzianowski et al., 2018; Hosseini-Asl et al., 2020), conversational recommendation systems (Fu et al., 2020; Sun and Zhang, 2018; Zhang et al., 2018) and chi-chat (Adiwardana et al., 2020; Roller et al., 2020) etc. However, most existing dialogue systems are agent centric. Such systems require the users to unnaturally adapt to and even have a learn curve on the system ontology, which is largely unknown to the users (such as the sample instructions for most smart speakers). For example, FIG. 5 shows a dialogue snippet commonly found in traditional datasets: the user is expected to closely follow the system ontology and provide the exact ontology terms, or at most with minor variations like synonyms. In real-world scenarios, the free form user utterances often mismatch with system ontology. In NUANCED, we model the user preferences (or dialogue state) as distributions over the ontology, therefore, to allow mapping of entities unknown to the system to multiple values and slots for efficient conversation.

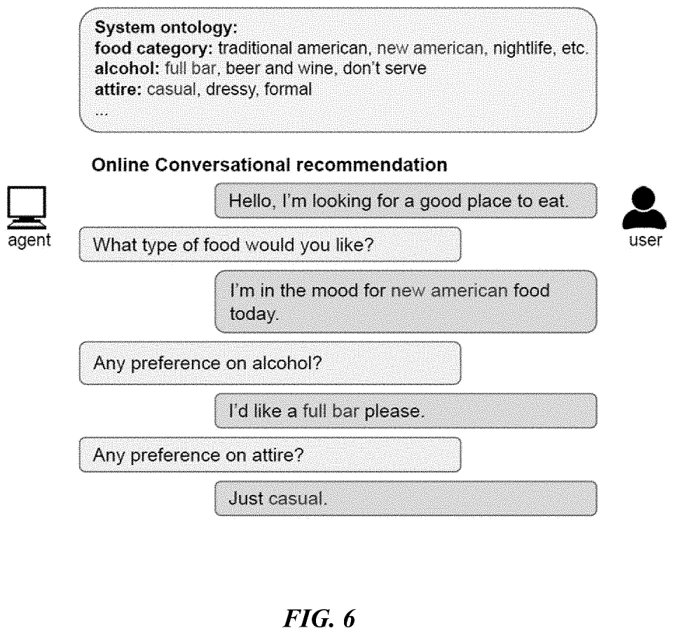

FIG. 6 illustrates example limitations of previous conversational recommendation systems. As shown in FIG. 6, previous systems assume the user knows the system ontology and mostly rely on simple NLU modules to handle ER, surface match or synonyms. FIG. 6 also reflects that existing datasets are mostly constructed in a way that the user utterances closely follow the system ontology.

In the real-world use cases, such formulation obviously suffers from the following issues. (1) It easily results in information loss or breaks a conversation if the user speaks anything out of the system ontology; (2) it greatly limits the expressive power of the user because of the rigid pipeline of following a complex routine on system ontology. As an example in conversational recommendation in the restaurant domain, a user may prefer to speak freely as “I want to have a date wearing my shorts”, where “date” and “shorts” may not be defined in the system ontology but powerfully indicates multiple slots ambience=romantic and attire=casual simultaneously.

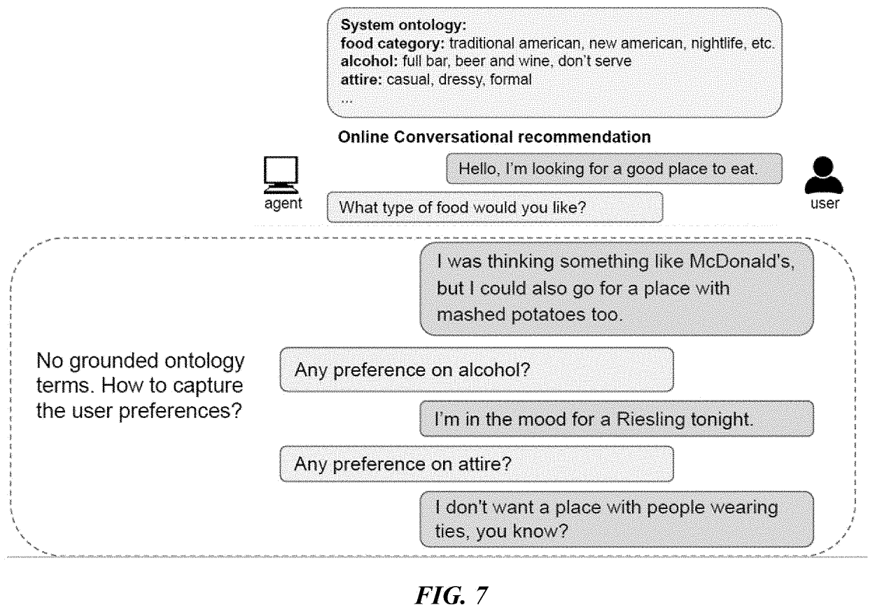

FIG. 7 illustrates an example gap between previous systems and real-world cases. In real-world use cases, the user is unaware of the system ontology and the user can speak anything freely, not restricted to system ontology.

In the embodiments disclosed herein, we argue that a smart agent can ideally be more user-centric: to allow the user to speak in their own way without restrictions. The system is expected to understand the user's utterances in various forms, and more importantly, to reason the connection between one utterance to one or more values and slots defined by the system ontology. This further unleashes the expressive power of the user's utterances and thus simplify the conversation. The lower part of FIG. 5 gives examples of such free form user utterances. In the first turn, the entity “ramen” is in the user's mind but (we assume) not in the system ontology. From this single word “ramen”, we humans can naturally (using our world knowledge to) have an estimate about this user's preference on multiple values of the slot “Category” defined by the system ontology. In the third turn, what is even more powerful is that words such as “blog”, “laptop” and “martini” naturally picture the scene that the user wishes to have and imply two slots with multiple values in addition to what the system queried in the second turn. As such, it is highly desirable that a system is capable of reasoning and mapping the user's entities to system ontology as we humans do. This is also a viable way of shortening the gap between chit-chat and task-oriented dialogue.

To build a user-centric dialogue system, we propose to model the mapping from the free form user utterances to the system ontology as probability distributions over system ontology. We demonstrate that such representation can be much easier to capture fine-grained user preferences. To learn the probability distributions, we construct a new dataset, named NUANCED (Natural Utterance Annotation for Nuanced Conversation with Estimated Distribution). NUANCED targets conversational recommendation because such type of dialogue system encourages more modeling of soft matching, implicit reasoning for user preference, although the idea is generally applicable to other forms of dialogue systems. We employ the professional linguists to annotate the dataset, and end up with 5.1k dialogues, 26k turns of high-quality user utterances. Our dataset captures a wide range of phenomena naturally occurring in the realistic user utterances, including specified factoid knowledge, commonsense knowledge and users' own situations. We conduct comprehensive experiments and analyses to demonstrate the challenges in our new dataset. We hope NUANCED can serve as a valuable resource to help to bridge the gap between current dialogue systems and real-world applications. To summarize, we make the following contributions:
We study the important problem of building user-centric conversational agents, through modeling the mapping between the system ontology and the user utterances as probability distributions.
We propose a new large-scale dataset, NUANCED, with high-quality user utterances paired with the estimated distributions on preference. The user utterances involve complex reasoning types, which raises more challenges in modeling user preferences.
We conduct in-depth experiments and analysis on our new dataset to show insights, challenges, and open problems for future research.

Related Work

i Dialogue System

Over the recent years there have been a surge of works on conversational artificial intelligence (Con-vAI). Task-oriented dialogue systems are typically divided into several sub modules, including user intent detection (Liu and Lane, 2016; Gangadhara-iah and Narayanaswamy, 2019), dialogue state tracking (Mrksic et al., 2017; Rastogi et al., 2017; Heck et al., 2020), dialogue policy learning (Peng et al., 2017; Su et al., 2016), and response generation (Dusek et al., 2018; Wen et al., 2015). More recent approaches begin to build unified models that bring the pipeline together (Chen et al., 2019; Hosseini-Asl et al., 2020). Conversational recommendation focus on combining the recommendation system with online conversation to capture user preference (Fu et al., 2020; Sun and Zhang, 2018; Zhang et al., 2018). Previous works mostly focus on learning the agent side policy to ask the right questions and make accurate recommendations, such as (Li et al., 2018; Kang et al., 2019; Xu et al., 2020; Lei et al., 2020; Li et al., 2020; Penha and Hauff, 2020). Chit-Chat (Adiwardana et al., 2020; Roller et al., 2020) is the most free form dialogue but almost with no knowledge grounding or state tracking. Both existing task-oriented, conversational recommendation systems have a predefined system ontology as a representation connected to the back-end database. The ontology defines all entity attributes as slots and the option values for each slot. In existing datasets, such as the DSTC challenges (Williams et al., 2014), Multi-WOZ (Budzianowski et al., 2018), MGCon-vRex (Xu et al., 2020), etc, the utterances from the users mostly follow the system ontology to make responses. While in task-oriented dialogue systems, parsing the user preferences into dialogue states is more on hard matching, in conversational recommendation systems soft matching is more encouraged since the user preferences are more salient and diverse in this type of conversations. In this work, we encourage implicit reasoning for grounded system ontology for both hard and soft matching to maximize the freedom from the user side.

ii Dialogue State Tracking

As a core component in dialogue systems, dialogue state tracking (DST) estimates the state of the conversation in the form of a set of discrete <domain-slot, value> pairs, which is passed to back-end system for database query and dialogue policy generation. Traditional approaches for DST mostly employ feature engineering and domain-specific lexicons (Henderson et al., 2014; Sun et al., 2014); Recent neural based approaches (Mrksic et al., 2017; Wu et al., 2019) have shown promising results on many benchmarks. They can be roughly categorized into classification with pre-defined slot-values (Zhong et al., 2018), span prediction from the dialogue context (Gao et al., 2019), hybrid approaches (Zhang et al., 2019), and generative approaches (Wu et al., 2019), etc. However, especially for the applications with strong freedom, diversity and uncertainty in user utterances such as recommendation tasks, a state in the discrete labeling or span space may not be able to capture nuanced implicit reasoning during a conversation. For example, in the dialogue snippet from FIG. 5, given the utterance of “update blog on laptop”, we cannot take a span prediction as state because it is not defined by system ontology. In this work, the proposed to expand the state representation as continuous probability distributions over the system ontology, which allows for larger scope of grounding and implicit reasoning from the freestyle user utterances.

iii Entity Linking and Taxonomy Construction

Our work is also related to the studies in entity linking and taxonomy construction. Entity linking is the task of linking entity mentions in text with their corresponding entities in a knowledge base (Shen et al., 2015; Hachey et al., 2013; Han et al., 2011). The key difference is that our work has no clear one-to-one mapping but implicit reasoning between multiple entities in utterances to multiple entities defined in system ontology. Taxonomy construction focuses on organizing entities or concepts into hierarchical categories (Liu et al., 2012; Shen et al., 2018; Luu et al., 2014). In our work, one of the reasoning types requires resolving entities in the user utterances and mapping to the system ontology. A part of them can be conceptually similar as taxonomy construction (or requires external taxonomy as discussed in the last section), e.g., in FIG. 5, we need the knowledge that the entity “ramen” has the upper level entity “Japanese”, “Chinese”, and “Korea”. In addition to such hierarchical relations, we use distributions to capture more fine-grained user preferences, i.e., the user is more likely to choose a Japanese restaurant that has Ramen.

The NUANCED Dataset

To build the mappings between the system ontology and the user utterances as probability distributions, our solution is to collect a large-scale dataset and learn the estimated distributions. The embodiments disclosed herein start from conversation recommendation in the restaurant domain since the user's preferences are more salient in such type of dialogue systems.

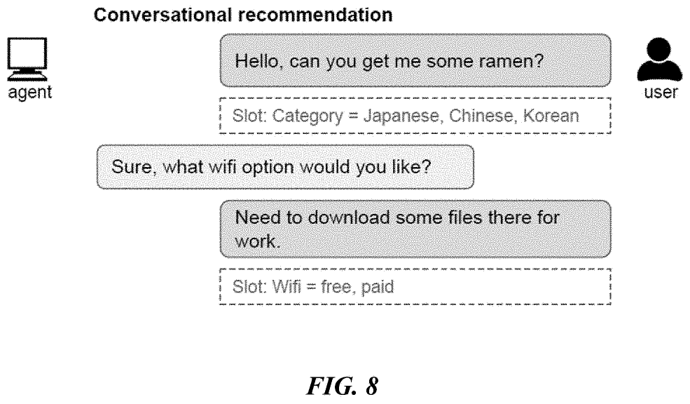

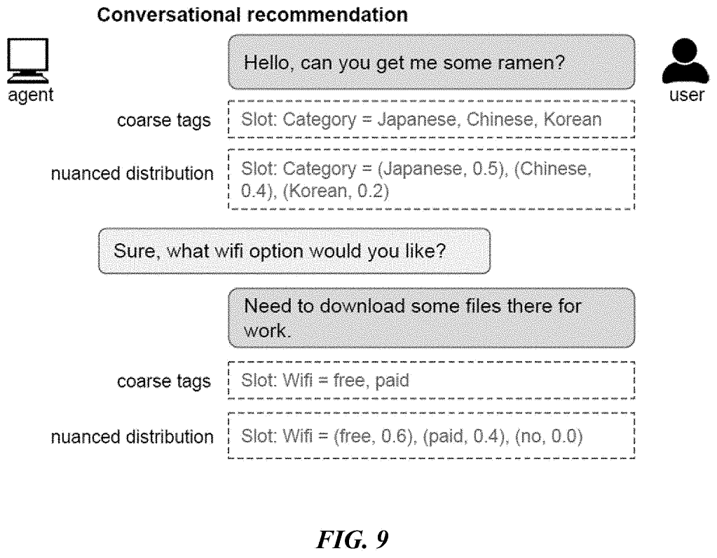

The embodiments disclosed herein impose no assumption on user utterances and learn to infer user preferences from such free-form utterances. NUANCED has two sets of annotations: coarse slot-value tags and nuanced preference distributions. FIG. 8 illustrates example coarse slot-value tags. As shown in FIG. 8, all possible values inferred from user utterance may be marked. FIG. 9 illustrates example nuanced estimated preference distributions. As shown in FIG. 9, user utterances imply different preference weights over the values and use distribution over each value may capture such ‘nuanced’ information.

i User Preference Modeling

For a given system ontology, without loss of generality, we denote the set of all slots as {Sᵢ}; For each slot Sᵢ, denote the set of its option values as {Vᵢ^{j}}. In a dialogue between user and agent, denote the current user utterance as T and dialogue context (of past turns) as H. In the realistic setting where T does not necessarily have grounded ontology terms, we model the user preference as a distribution over each slot-value, namely preference distribution:

Pᵢ^{j}=P((Vᵢ^{j}|T,H). (1)

Note that we expect the representation to be general, expandable, and holds the least assumptions, i.e., there is no assumption on the dependency among slot-values, neither the completeness of the value set. Therefore, we model the distribution as a Bernoulli distribution over each slot-value, independent of the others. Intuitively, Pᵢ^{j} represents the probability that the user chooses an item with attributes Vᵢ^{j}, under the observed condition of the dialogue up to the current turn. Note that the preference distributions may differ among individuals which causes variances, for example, for the same situation ‘I need to download some files there before work’, some people may prefer paid Wi-Fi more because they want high speed while others may do not care. In this work, we aim to aggregate estimated distributions from large-scale data collected from multiple workers as “commonsense” distributions.

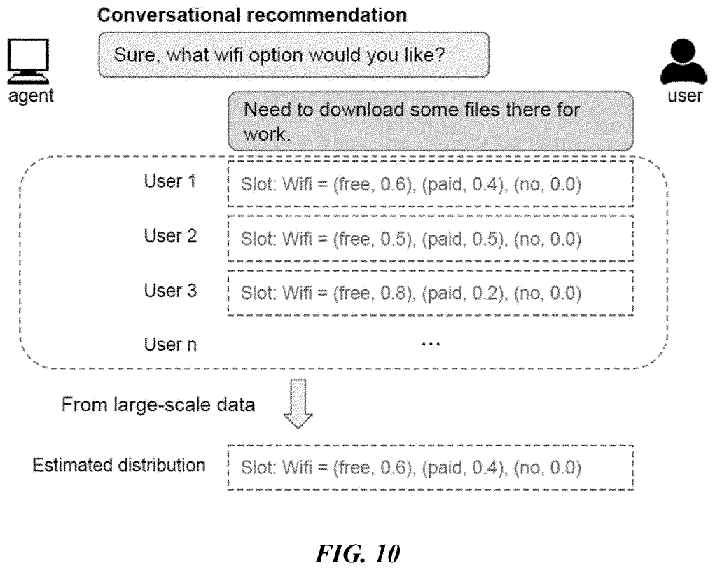

FIG. 10 illustrates an example estimated preference distribution. The preference distribution may vary among individuals. There may be no exact one-one mapping. The embodiments disclosed herein annotate large-scale data to learn an estimated distribution.

ii Dataset Construction

To construct our dataset, we first simulate the dialogue flow with the user turns filled with the preference distributions, then we ask the human annotators to compose (or paraphrase) utterances that imply the given distribution. We employ the process of simulation followed by rewriting to cover abundant cases of preference distribution and reduce annotation bias, as suggested by the previous work (Shah et al., 2018b,a).

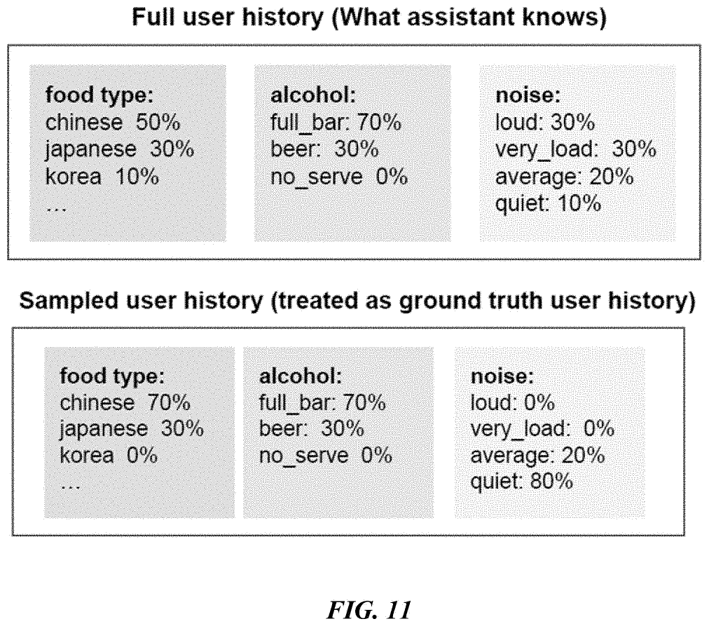

The construction of the dataset may comprise two steps, i.e., simulator and annotator rewriting. We simulate the distribution flows over the dialogue, produce the semantic representations (preference weights), and then ask human annotator to re-write into natural language. The steps to do the simulation may be as follows. Step1: Extract full user history from real dataset. Step2: Assume Assistant knows this full user history. Step3: Sample a subset of the full user history and treat it as the ground truth user preference. Step4: Generate a simulated dialog. The goal of the assistant system 140 is to use dialog context and user full history (if available) to infer the user's ground truth preference. FIG. 11 illustrates an example comparison between full user history and sampled user history.

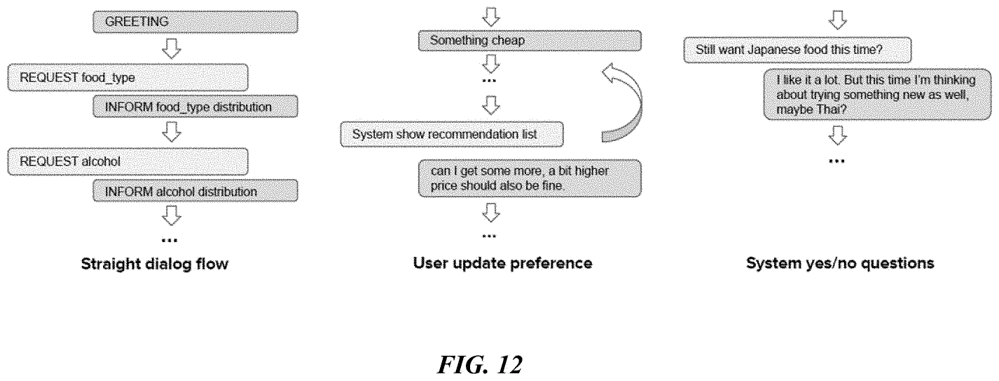

To obtain more valid and natural distributions, we start from the real user data from the MGConvRex dataset (Xu et al., 2020). Specifically, for each user with its visiting history as a list of restaurants with corresponding slot-values, we randomly sample a subset of the history and aggregate to get a value distribution for each slot. FIG. 12 illustrate an example comparison of three dialog scenarios for simulation. Using the sampled distribution as the ground truth distribution, we simulate the dialogue skeletons of the following scenarios: 1) Straight dialogue flow: the system asks each slot, followed by the user response filled as the corresponding preference distributions; 2) User updating preference: the user updates the preference distributions in a previous turn; 3) System yes/no questions: the system can choose to ask confirmation questions based on the user history.

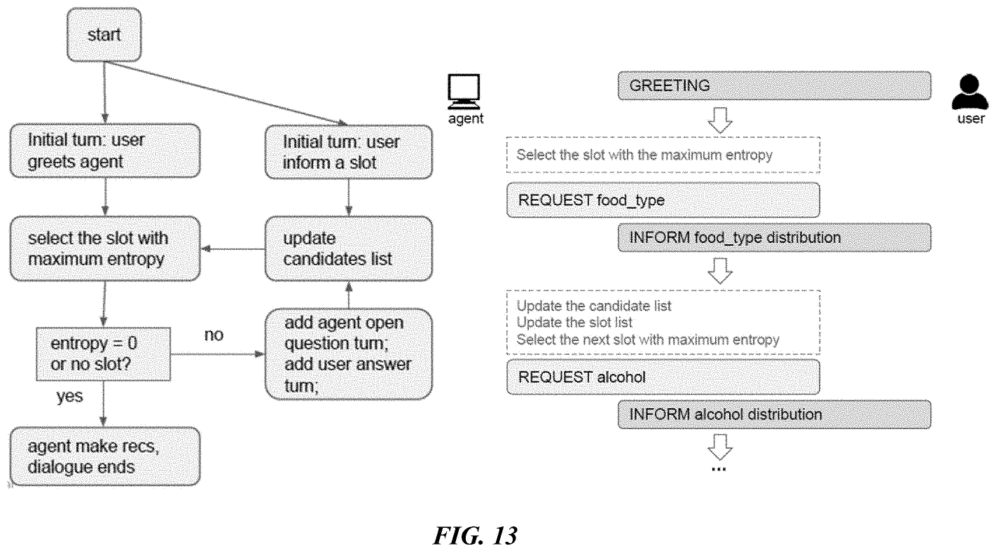

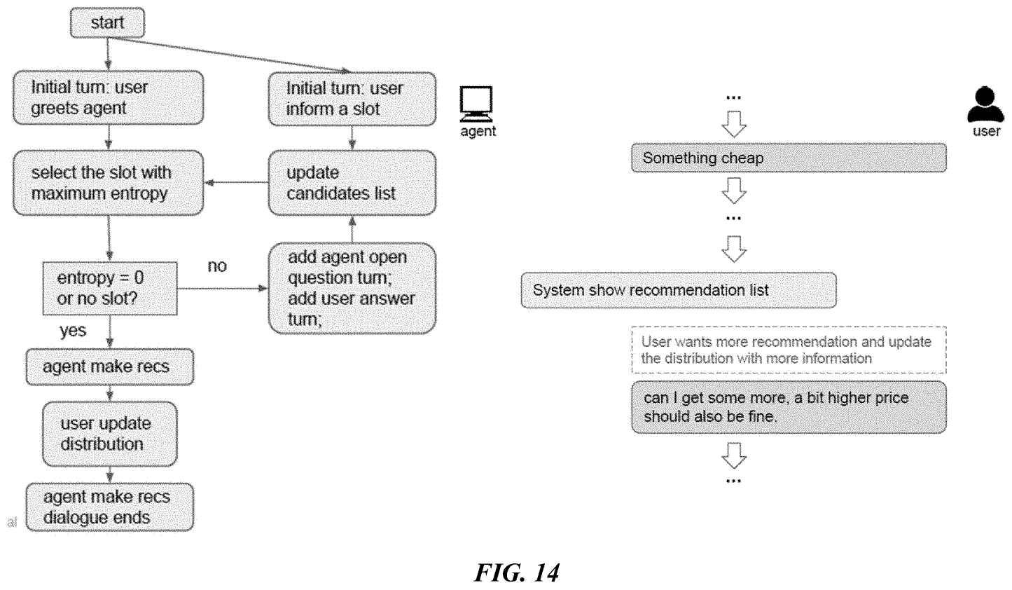

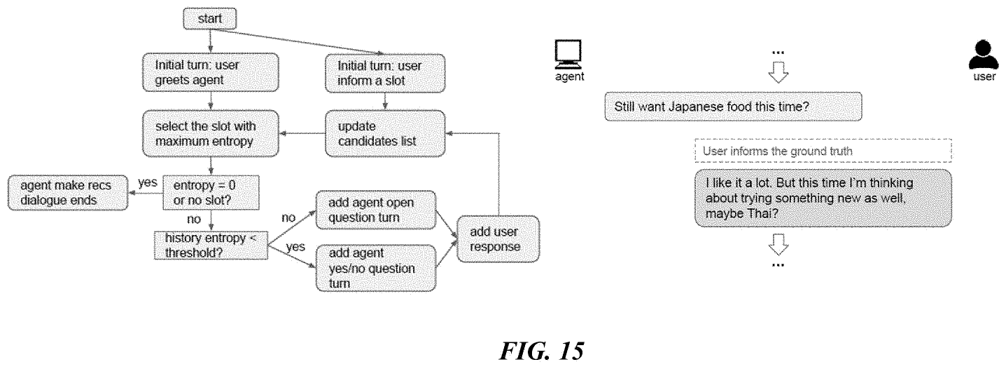

FIG. 13 illustrates an example use case for simulating a straight dialog flow. At each step, the agent always chooses to ask the slot with the maximum entropy over the current candidates, until all slots are traversed or no remaining slot has non-zero entropy. FIG. 14 illustrates an example use case for simulating user updating preference. We choose one or two slots and sample a partial distribution as the initial distribution. Then the user updates the distribution with more information. FIG. 15 illustrates an example use case for simulating system yes/no questions. Based on user history, the system changes open questions to yes/no questions and the user responds to the question based on the ground truth distribution, which may differ from the history.

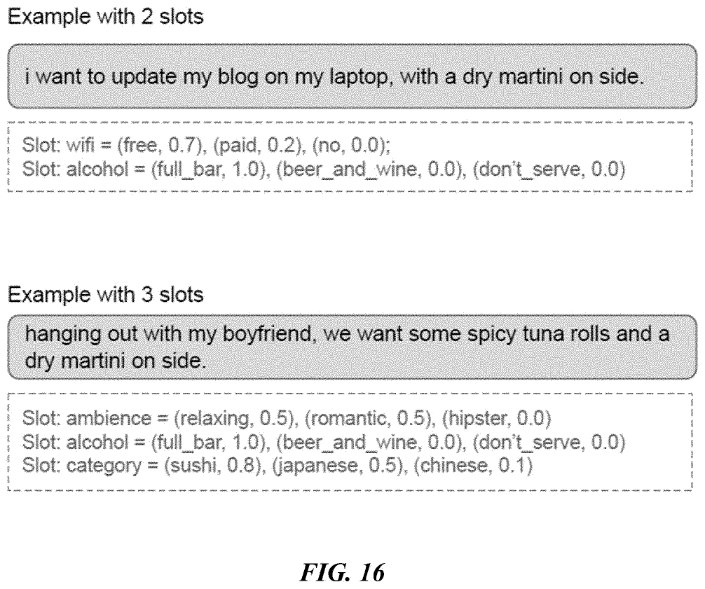

For each turn, we randomly select 1 to 3 slots, corresponding to the cases that the user utterances naturally (and powerfully) imply multiple slot-values. Since in this work our focus is on natural language understanding or dialogue state tracking, we adopt the above simple strategy and do not consider a complex policy on the system side. The system turns are composed using templates. FIG. 16 illustrates example random selection of slots.

After simulating the dialogue skeletons, where each user utterance is formulated as distributions for user preferences, we employ crowdsourcing to compose corresponding user utterances. To get a high-quality dataset, we employ professional linguistics to do the composition. Specifically, we provide two composing strategies to the linguistics:

Implicit Reasoning: not explicitly mention the slot-value terms. This is the focus of the embodiments disclosed herein since we expect the users have no idea of system ontology and free to depict their wishes that are less likely to overlap with the formally defined system ontology.

Explicitly Mention: use the slot-value terms (or synonyms), as a backup option when the first one is not applicable.

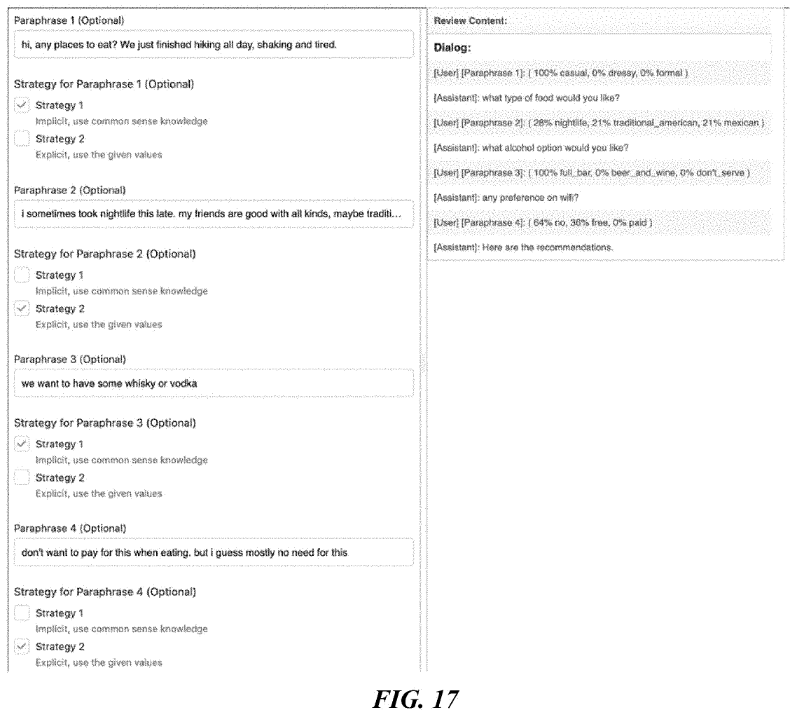

During the composition, we emphasize the following aspects: 1) Diversity is the most important. Try to compose as diversified utterances as possible; 2) Read the whole dialogue first and have an overall “story” in mind, then begin to compose each utterance, to keep consistent with the dialogue context; 3) Since the dialogue skeleton is automatically simulated, there must be a certain number of invalid cases. Reject any cases with invalid or unnatural preference distributions. We provide detailed explanations and examples, as well as learning sessions to make sure all the linguistics well-mastering the task. We launched 5,784 simulated dialogue skeletons to the linguistics and end up with 5,100 completed dialogues after post-processing. FIG. 17 illustrates an example annotation interface for rewriting.

TABLE 1
Examples of different reasoning types. In the Type I utterance, we need to reason from
the factoid knowledge that G&T is only served in a full bar, while Riesling is a kind
of wine and tonic water does not require alcohol options. In the Type II utterance, based
on commonsense knowledge we know that ‘place without people wearing ties’ indicates
casual attire, and ‘five to ten dollars’ indicates a price range of cheap or affordable.
In the Type III utterance, we need both kinds of reasoning to infer the preferences.

| Reasoning types | Example user utterance | Example preference distribution |
|---|---|---|
| Type I Factoid | I really want a G&T or a Riesling, | Slot: Alcohol = (full_bar, 0.7), |
| Knowledge | but I could also have a tonic water. | (beer_and_wine, 02), (don't_serve, |
| (37.3%) | | 0.1) |
| Type II Commonsense | five to ten dollars, I don't want a | Slot: Price = (cheap, 0.6), affordable, |
| knowledge or User | place with people wearing ties, you | 0.4), (moderately_priced, 0.0), |
| Situations | know? | (expensive, 0.0) |
| (43.8%) | | Slot: Attire = (casual, 1.0), (dressy, |
| | | 0.0), (formal, 0.0) |
| Type III Mixed Type | I want to update blog on my laptop, | Slot: Wifi = (free, 0.7), (paid, 0.3), (no, |
| I & II | with a dry martini on side. | 0.0) |
| (19.0%) | | Slot: Alcohol = (full_bar, 1.0), |
| | | (beer_and_wine, 0.0), (don't_serve, |
| | | 0.0) |

iii Dataset Statistics and Analysis

With an average of 5.39 user turns per dialogue, we have 5,100 dialogues of 25,757 user turns in total. The user utterances have an average length of 19.43 tokens. In terms composing strategies, 84.7% of the utterances are composed using the strategy of implicit reasoning, i.e., the utterance does not have any grounded ontology term; 6.5% of the utterances explicitly mention the ontology terms, and the remaining 8.8% use mixed strategies. This demonstrates the uniqueness and challenge of our dataset, compared with previous ones that the user utterances mostly closely follow the predefined ontology.

Table 2 shows the train/valid/test split in the number of dialogues and turns. To evaluate the quality of our dataset, we randomly sample 500 examples and ask humans whether a preference distribution is reasonable based on the corresponding utterance. We end up with a correctness rate of 90.2%, which is the percentage of turns with a reasonable preference distribution.

TABLE 2
Train/Valid/Test Split of the dataset

| | All | Train | Valid | Test |
|---|---|---|---|---|
| # dialogues | 5.100 | 3.600 | 500 | 1.000 |
| # user turns | 25.757 | 18.182 | 2.529 | 5.046 |

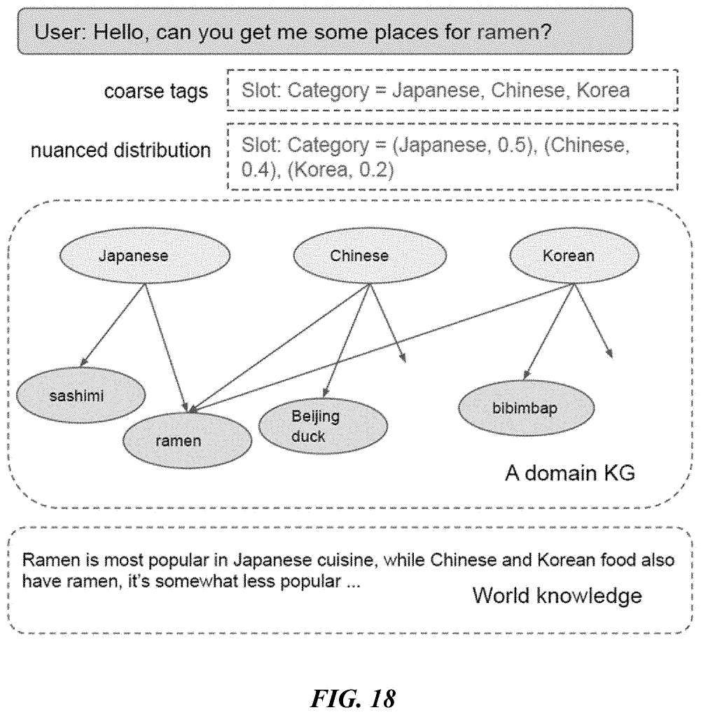

One major challenge of maximizing the freedom for users is to encourage implicit reasoning. As such, understanding different types of implicit reasoning is crucial for the success of building a user-centric dialogue system. Among the utterances involving implicit reasoning, we summarize 3 basic reasoning types for utterances from our dataset. Type 1 (Factoid Knowledge) is the hidden backbone to build the connection between user utterances and the preference distribution. Such factoid knowledge is largely agreed by humans and stable, such as knowledge from Wikipedia. To learn the distributions involving such type, certain techniques such as pre-trained LMs or external knowledge base may be needed. FIG. 18 illustrates an example reasoning using entity/world knowledge.

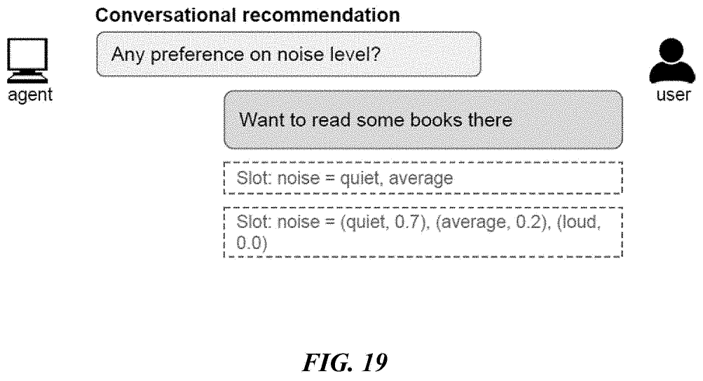

Type II (Commonsense Knowledge or User Situations) is also important and frequent in utterances. The major difference between common sense knowledge and factoid knowledge is that commonsense knowledge may not be formally defined and may change in future. For example, a food item that is less than $10 is cheap. In many cases, such commonsense knowledge may need to be inferred from a situation described by the users at the current moment. FIG. 19 illustrates an example reasoning using user described situations or commonsense knowledge.

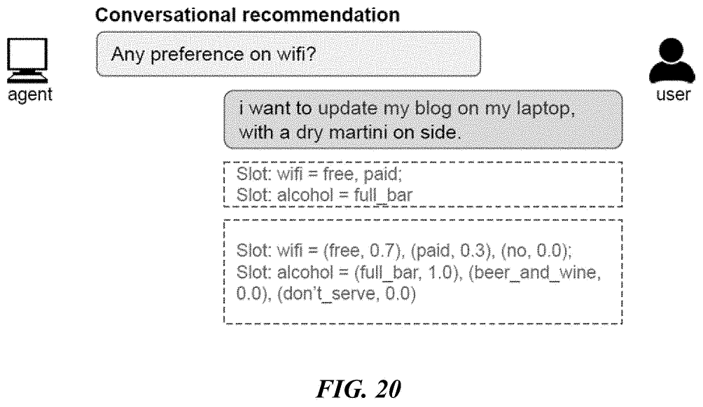

Type III (Mix of Type I and II) may appear in a single utterance. The examples and distributions of these 3 types are shown in Table 1. Note that this is not a comprehensive list of types of implicit reasoning. For example, there could also be user-specific knowledge that has no agreements among human beings but are important for mapping entities from user to system ontology. FIG. 20 illustrates an example reasoning using a mixture of entity/world knowledge and commonsense knowledge.

Further, we are interested in the connection between the discrete states (used in existing dialogue state tracking) and our novel from continuous states (in continuous distributions). As such, we also provide a reduced variant called NUANCE-reduced, by discretizing the distributions for preference into binary numbers. Specifically, for all slot-values with a positive preference distribution we label them as 1.0, otherwise 0.0. For example, the preference distribution Wi-Fi=(free, 0.7),(paid, 0.3),(no, 0.0) is turned into Wi-Fi=(free, 1.0),(paid, 1.0),(no, 0.0), indicating preferences over the value free and paid. In practice we set a threshold of 10%, because in the utterance composition stage a preference distribution lower than 10% is generally considered ignorable. As a result, this reduced variant does not have continuous probabilities to tell the nuanced differences on positive labels, but it still needs to map free form utterances to binary labels.

We further conduct a study based on a human evaluation to obtain insight into these two versions of the datasets. Specifically, we present the utterances with both the preference distributions and the coarse (binary) labels, then we ask the annotators to decide which representation can better capture more fine-grained user preferences. Table 3 shows the evaluation results and NUANCED can better capture the nuanced information underlying user utterances. Note that in real applications, which version of the data to use may depends on requirements of the system, i.e., level of granularity for state representation. In experiment, we further explore the impacts of two versions of datasets on models.

TABLE 3
Human evaluation results of comparing two versions
of the dataset: the version using the (continuous) probability
distributions can better capture fine-grained user preferences.

| NUANCED win | NUANCED-reduced win | Tied |
|---|---|---|
| 54.7% | 16.7% | 28.6% |

Experiments

The embodiments disclosed herein conduct experiments on both versions of datasets, respectively. We primarily focus on getting insights into patterns inside the dataset and providing baseline approaches to estimating the challenges of building a more user-centric system. As NUANCED-reduced is closer to existing datasets in dialogue state tracking, we first follow a similar evaluation as in previous datasets to have a better understanding of the challenges; then we explore NUANCED with the continuous distributions and perform a human evaluation on predicted distributions from models to understand the modeling challenges.

i NUANCED-Reduced

We design the following baselines for NUANCED reduced to estimate how NUANCED can work in a similar fashion as in existing dialogue state tracking but is more powerful in drawing connections between users' (unrecognized) entities and slots and values defined by system ontology.

Exact match & Random guess This is a rule-based baseline. For each turn we follow the preceding system query to make slot prediction; then we use exact match to predict the slot-values and additionally mentioned slots; If no match is found, we apply random guess. We use this baseline to estimate how a simple rule-based method can cover both explicit and implicit mapping.

BERT Following (Devlin et al., 2019), we adopt a pre-trained LM to enrich the features of utterances for better tracking of binary labels in NUANCED reduced. The input is the concatenation of the slot name, current turn system question and user utterance, and optionally dialogue context of past turns (as in −w/o context). We add two (2) types of prediction heads on the [CLS] token of BERT, one head for slot prediction (whether the input slot is updated or not), and the other type is for the value prediction of each slot. The loss is a combination of cross-entropy loss for slot prediction and mean squared error (MSE) loss for value prediction. During inference, we set up a threshold to decide positive or negative predictions.

Transformer (Devlin et al., 2019; Vaswani et al., 2017) To study the effect of pre-training weights, we use the same architecture as BERT but train the weights from scratch.

Train-MGConvRex As MGConvRex dataset (Xu et al., 2020) has similar domain and ontology, we compare BERT model trained on MGConvRex with that trained on NUANCED-reduced. We use this baseline to demonstrate the open challenge from users' freestyle speaking and to what degree NUANCED reduced can alleviate this issue.

More details of the model implementation and hyper-parameter settings can be found in Appendix A. For all baselines, we evaluate in a similar way as in dialogue state tracking on the turn level slot prediction accuracy and joint accuracy.

The results are shown in Table 4. A pre-trained LM (BERT) achieves the best performance (compared to Transformer) as pre-training on large-scale corpus can draw a better relevance or mapping between unrecognized entities from the user and entities (such as slots, values) from the agent. We believe, for certain types of reasoning discussed in Table 1, some knowledge about entities such as factoid knowledge or even commonsense knowledge may have already seen by BERT during the pre-training. Noticeably, Train-MGConvRex limits (or even overfit) such mapping to system ontology. As a comparison, we further test Train-MGConvRex on the testing set of MGConvRex, resulting in 96.52% for slot accuracy and 91.35% for joint accuracy. This huge performance loss indicates that existing dialogue datasets (not just for conversational recommendation) may limit what an agent can understand from humans. What is even worse is that Train-MGConvRex probably overfits the training data that closely following a system ontology because a random solution may perform better on unrecognized entities, as indicated by Exact match & Random guess. Lastly, by comparing with BERT without dialogue context (or past turns), we notice that context may help on learning better values but yield more noises for slot prediction. This may be caused by diverse out-of-ontology entities spanning across multiple utterances making a model harder to identify the correct slot in a consistent way.

TABLE 4
Evaluation results on the NUANCED-reduced.

| Baselines | Slot Accuracy (%) | Joint Accuracy (%) |
|---|---|---|
| Exact match & | 48.83 | 4.84 |
| Random guess | | |
| Train-MGConvRex | 38.70 | 4.02 |
| Transformer | 74.14 | 21.52 |
| BERT | 88.21 | 36.56 |
| BERT w/o context | 88.78 | 34.99 |

Slot Accuracy: percentage of turns that all slots and values are correctly predicted. Train-MGConvRex: BERT trained on MGConvRex but evaluated on the testing set of NUANCED-reduced; Transformer: the same architecture as BERT without pre-trained weights; w/o context: without past turns.

Table 5 shows the automatic evaluation results for different slots.

TABLE 5
Automatic evaluation results for different slots.

| | Avg precision | Avg recall | Avg f1 |
|---|---|---|---|
| category | 72.12 | 63.76 | 65.46 |
| price | 88.12 | 85.23 | 83.81 |
| parking | 85.48 | 77.33 | 78.17 |
| noise | 87.52 | 81.48 | 80.75 |
| ambience | 89.71 | 76.16 | 79.71 |
| alcohol | 89.25 | 90.28 | 87.05 |
| wifi | 92.49 | 89.40 | 88.53 |
| attire | 96.01 | 85.44 | 87.03 |

ii NUANCED

Next, we focus on the ideal setting of continuous distributions as states for dialogues. As a reminder, the major difference between NUANCED and NUANCED-reduced is on the set a value can take, with the former as a 0/1 binary label and the latter as a continuous number between 0.0 and 1.0. As such, we detail the major differences of experiment setup compared with NUANCED reduced.

We keep the same evaluation for slot prediction. To reflect the differences in a value assigned with different continuous numbers, we evaluate the soft average mean absolute error (MAE) between the ground truth distribution and that from the predictions, instead of the hard metric on classification.

Exact match & Random guess Similar to NUANCED reduced, for matched values, we assign a hard probability of 1.0; otherwise, we randomly assign a probability between 0.0 and 1.0.

BERT, Transformer Similar to NUANCED reduced, we use MSE loss between the distribution of ground truth and predicted distribution. During inference, we take the predicted distribution as the results.

Train-reduced-X Further, we are interested in the connection between states in continuous space and binary space. We train the model on NUANCED-reduced and test on NUANCED to see how data with binary labeled states can infer states in the continuous space. We define a fixed number of X as the continuous number for all positive predictions. We experiment with X=0.5 and 1.0.

Table 6 shows the overall results. As expected, a pre-trained BERT reaches the best performance. One interesting observation is that using the same model BERT, the slot prediction accuracy increases (from 88.21% to 89.62%) compared with training on the reduced version, even though its own loss function does not change. NUANCED helps to reduce the noise of sparse entities in context (past turns). This is probably because numbers in continuous space can help to draw more relevance among different entities.

As we can see, Train-reduced-X has a much larger error on MAE because of the information loss when turning numbers in the continuous space into binary numbers. This indicates simply adapting the results from the reduced state labels suffers from information loss, i.e., the nuanced differences in continuous distributions. It is very important to model dialogue state with numbers in the continuous space to cover the uncertainty derived from unrecognized entities from the users.

TABLE 6
Evaluation results on NUANCED.

| | | Correct slots |
|---|---|---|
| Baselines | Slot Accuracy (%) | mean MAE (1e−2) |
| Exact match & | 48.83 | 46.84 |
| Random guess | | |
| Train-reduced-1.0 | 88.21 | 40.72 |
| Train-reduced-0.5 | 88.21 | 21.62 |
| Transformer | 78.42 | 16.78 |
| BERT | 89.62 | 14.20 |
| BERT w/o context | 88.08 | 14.49 |

Slot Accuracy: percentage of turns that all slots are correctly predicted; Correct slots mean MAE (lower the better): mean absolute error of predicted distribution for all correctly predicted updated slots; Train-reduced-X: train the model on NUANCED-reduced, and test on NUANCED with all positive predictions set as a distribution value of X.

To get more insights of how users can provide information efficiently in our dataset, we study how the model's performance on updating different number of slots per turn. The results are shown in Table 7. Generally speaking, the turns with more slots implied by the utterance are relatively harder to learn. The turns involving 1 slot are mostly following the system query, which contains the slot name, thus the slot prediction accuracy is very high. The turns involving multiple slots, in addition to the system query, becomes harder to predict with the increasing number of slots. The turns that update the preference in previous turns have the highest error for distribution prediction. In such kind of turns, the preference distribution needs to be inferred from the previous mention and the current turn jointly.

We also study how the model performs on each slot in the domain, shown in Table 8. Generally, slots that may involve more factoid knowledge or more choices of values are harder to learn, such as food category parking. These may require learning long-tailed knowledge from external data, as we discussed in the next section. We provide some case studies in Appendix B.

We further conduct a human evaluation on baseline models. Although the automatic evaluations can generally tell the overall performance, it could be fuzzy since it takes an average overall correctly predicted slots. As a reminder, we perform human evaluations to ensure the quality of ground-truth which serves as the basis to compare the predictions of models with ground truths.

TABLE 7
Performance for different number of slots per turn:

| | | | | | updating |
|---|---|---|---|---|---|
| Type of turn | all | 1 slot | 2 slots | 3 slots | preferences |
| Slot Accuracy(%) | 89.62 | 96.67 | 78.91 | 67.65 | 90.61 |
| Mean MAE(1e−2) | 14.12 | 14.06 | 13.55 | 14.20 | 15.63 |

all: all kinds of turns; n slots: turns that the user utterance jointly implies n slots; updating preferences: turns that the user utterance updates the preference in previous turns. Slot Accuracy: percentage of turns that all slots are correctly predicted. Mean MAE: Here the mean MAE is measured for all correctly predicted slots.

TABLE 8
Performance for each slot of our dataset. Here the mean
MAE is measured for all correctly predicted slots.

| Slot | food category | price | parking | noise |
|---|---|---|---|---|
| Mean MAE(1e−2) | 15.48 | 15.29 | 16.94 | 13.34 |
| Slot | ambience | alcohol | wifi | attire |
| Mean MAE(1e−2) | 15.04 | 13.88 | 12.30 | 8.95 |

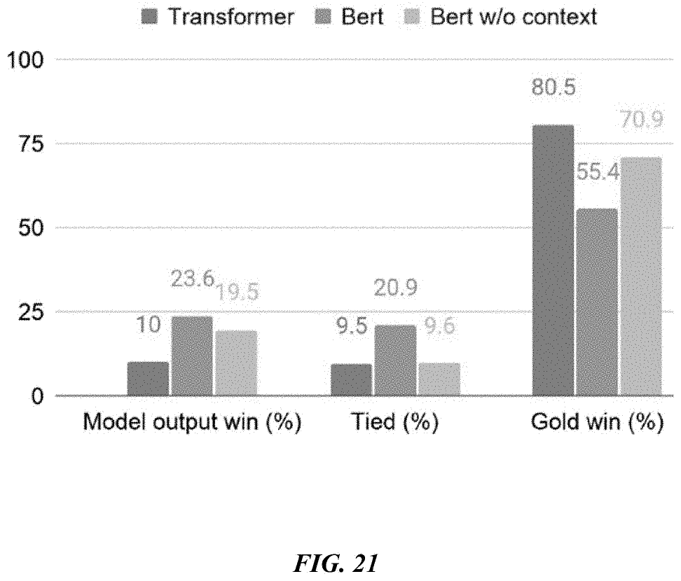

FIG. 21 illustrates example human evaluation results for the model outputs of Transformer, BERT, and BERT without context. We first evaluate the model outputs of Transformer, BERT, and BERT w/o context, through pairwise comparison between the model predictions and the gold ones. The results on 200 samples are shown in FIG. 21. One can easily notice the large gap between the best-performing baseline and the gold reference. This indicates a large room for improvement on modeling or data augmentation for future research.

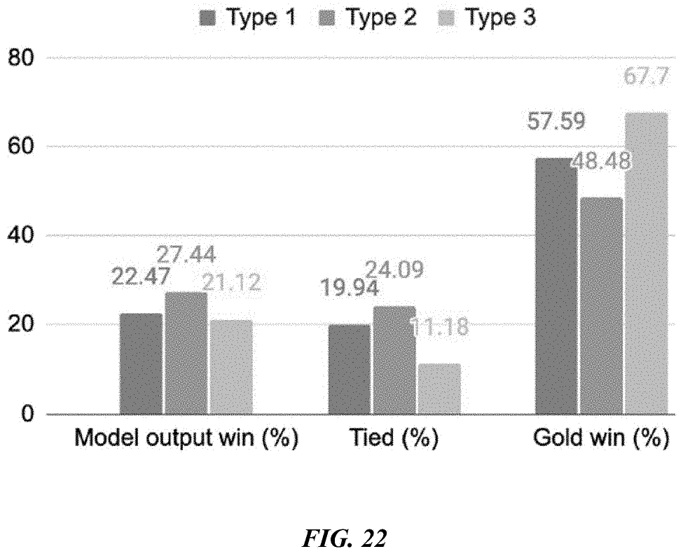

Further, we study the breakdown of predictions of BERT on 3 different types of reasoning. As a reminder, we discussed 3 basic types of reasoning in the user utterances in ×3.3. FIG. 22 illustrates example human evaluation results for different reasoning types. As shown in FIG. 22, the type 1 utterances, that involve factoid knowledge, are relatively harder to learn. This is close to our intuition as factoid knowledge is in huge amount (and keeps increasing) and our limited utterances may not cover all of them. Type 2 is commonsense knowledge or user situations. Type 3 is a mixture of type 1 and type 2.

Conclusion and Open Problems

The embodiments disclosed herein study to build user-centric conversational systems. We take the first attempt to bridge the gap between the system ontology and the users' freestyle preferences, through learning continuous probability distributions as an in-between mapping. To this end, we build a new dataset named NUANCED focusing on such a challenge. Starting from our datasets, we believe a user-centric dialogue system is open-ended problems and the following directions can be promising:
1) Preliminary experiments results indicate that to improve performance, it is promising to incorporate external domain texts into pre-trained models, for example, pre-training the model on domain corpora like restaurant descriptions and reviews. This will improve both Type I and Type II knowledge discussed in Table 1.
2) To cover the vast amount of unknown entities, we may incorporate a knowledge base (KB) as Type I knowledge. This can be in both the form of training data (data augmentation of utterances in NUANCED) and modeling (e.g., via a graph-based model to infer probability distributions in a structured way).
3) Through our large-scale dataset, although one can learn a general agreement of estimated distributions from workers, a more user specific distribution would be more desirable in reality. For example, when talking about “beef,” different users may actually refer to different parts or types of beef. Knowledge such different user-specific distributions requires the system to also build user ontology besides the formal and stable system ontology. Therefore, we believe providing a personalized solution is another proper next step to consider, i.e., learning and maintaining user ontology when interacting with the user and further learning preference distributions over user ontology.

### REFERENCES

The following list of references correspond to the citations above:
Daniel Adiwardana, Minh-Thang Luong, David R So, Jamie Hall, Noah Fiedel, Romal Thoppilan, Zi Yang, Apoory Kulshreshtha, Gaurav Nemade, Yifeng Lu, et al. 2020. Towards a human-like open-domain chatbot. arXiv preprint arXiv:2001.09977.
Pawel Budzianowski, Tsung-Hsien Wen, Bo-Hsiang Tseng, Inĩgo Casanueva, Stefan Ultes, Osman Ramadan, and Milica Gasic. 2018. Multiwoz—A large-scale multi-domain wizard-of-oz dataset for task-oriented dialogue modelling. In Proceedings of the 2018 Conference on Empirical Methods in Natural Language Processing, Brussels, Belgium, Oct. 31-Nov. 4, 2018, pages 5016-5026. Association for Computational Linguistics.
Wenhu Chen, Jianshu Chen, Pengda Qin, Xifeng Yan, and William Yang Wang. 2019. Semantically conditioned dialog response generation via hierarchical disentangled self-attention. In Proceedings of the 57th Conference of the Association for Computational Linguistics, ACL 2019, Florence, Italy, Jul. 28-Aug. 2, 2019, Volume 1: Long Papers, pages 3696-3709. Association for Computational Linguistics.
Jacob Devlin, Ming-Wei Chang, Kenton Lee, and Kristina Toutanova. 2019. BERT: pre-training of deep bidirectional transformers for language understanding. In Proceedings of the 2019 Conference of the North American Chapter of the Association for Computational Linguistics: Human Language Technologies, NAACL-HLT 2019, Minneapolis, Minn., USA, Jun. 2-7, 2019, Volume 1 (Long and Short Papers), pages 4171-4186. Association for Computational Linguistics.
Ondrej Dusek, Jekaterina Novikova, and Verena Rieser. 2018. Findings of the E2E NLG challenge. In Proceedings of the 11th International Conference on Natural Language Generation, Tilburg University, The Netherlands, Nov. 5-8, 2018, pages 322-328. Association for Computational Linguistics.
Zuohui Fu, Yikun Xian, Yongfeng Zhang, and Yi Zhang. 2020. Tutorial on conversational recommendation systems. In RecSys 2020: Fourteenth ACM Conference on Recommender Systems, Virtual Event, Brazil, Sep. 22-26, 2020, pages 751-753. ACM.
Rashmi Gangadharaiah and Balakrishnan Narayanaswamy. 2019. Joint multiple intent detection and slot labeling for goal-oriented dialog. In Proceedings of the 2019 Conference of the North American Chapter of the Association for Computational Linguistics: Human Language Technologies, NAACL-HLT 2019, Minneapolis, Minn., USA, Jun. 2-7, 2019, Volume 1 (Long and Short Papers), pages 564-569. Association for Computational Linguistics.
Shuyang Gao, Abhishek Sethi, Sanchit Agarwal, Tagy-oung Chung, and Dilek Hakkani-Tür. 2019. Dialog state tracking: A neural reading comprehension approach. In Proceedings of the 20th Annual SIG-dial Meeting on Discourse and Dialogue, SIGdial 2019, Stockholm, Sweden, Sep. 11-13, 2019, pages 264-273. Association for Computational Linguistics.
Ben Hachey, Will Radford, Joel Nothman, Matthew Honnibal, and James R. Curran. 2013. Evaluating entity linking with wikipedia. Artif. Intell., 194:130-150.
Xianpei Han, Le Sun, and Jun Zhao. 2011. Collective entity linking in web text: a graph-based method. In Proceeding of the 34th International ACM SIGIR Conference on Research and Development in Information Retrieval, SIGIR 2011, Beijing, China, Jul. 25-29, 2011, pages 765-774. ACM.
Michael Heck, Carel van Niekerk, Nurul Lubis, Christian Geishauser, Hsien-Chin Lin, Marco Moresi, and Milica Gasic. 2020. Trippy: A triple copy strategy for value independent neural dialog state tracking. In Proceedings of the 21th Annual Meeting of the Special Interest Group on Discourse and Dialogue, SIGdial 2020, 1st virtual meeting, Jul. 1-3, 2020, pages 35-44. Association for Computational Linguistics.
Matthew Henderson, Blaise Thomson, and Steve J. Young. 2014. Word-based dialog state tracking with recurrent neural networks. In Proceedings of the SIGDIAL 2014 Conference, The 15th Annual Meeting of the Special Interest Group on Discourse and Dialogue, 18-20 Jun. 2014, Philadelphia, Pa., USA, pages 292-299. The Association for Computer Linguistics.
Ehsan Hosseini-Asl, Bryan McCann, Chien-Sheng Wu, Semih Yavuz, and Richard Socher. 2020. A simple language model for task-oriented dialogue. CoRR, abs/2005.00796.
Dongyeop Kang, Anusha Balakrishnan, Pararth Shah, Paul Crook, Y-Lan Boureau, and Jason Weston. 2019. Recommendation as a communication game: Self-supervised bot-play for goal-oriented dialogue. In Proceedings of the 2019 Conference on Empirical Methods in Natural Language Processing and the 9th International Joint Conference on Natural Language Processing, EMNLP-IJCNLP 2019, Hong Kong, China, Nov. 3-7, 2019, pages 1951-1961. Association for Computational Linguistics.
Wenqiang Lei, Gangyi Zhang, Xiangnan He, Yisong Miao, Xiang Wang, Liang Chen, and Tat-Seng Chua. 2020. Interactive path reasoning on graph for conversational recommendation. In KDD '20: The 26th ACM SIGKDD Conference on Knowledge Discovery and Data Mining, Virtual Event, Calif., USA, Aug. 23-27, 2020, pages 2073-2083. ACM.
Raymond Li, Samira Ebrahimi Kahou, Hannes Schulz, Vincent Michalski, Laurent Charlin, and Chris Pal. 2018. Towards deep conversational recommendations. In Advances in Neural Information Processing Systems 31: Annual Conference on Neural Information Processing Systems 2018, NeurIPS 2018, 38 December 2018, Montreal, Canada, pages 9748-9758.
Shijun Li, Wenqiang Lei, Qingyun Wu, Xiangnan He, Peng Jiang, and Tat-Seng Chua. 2020. Seamlessly unifying attributes and items: Conversational recommendation for cold-start users. CoRR, abs/2005.12979.
Bing Liu and Ian Lane. 2016. Attention-based recurrent neural network models for joint intent detection and slot filling. In Interspeech 2016, 17th Annual Conference of the International Speech Communication Association, San Francisco, Calif., USA, Sep. 8-12, 2016, pages 685-689. ISCA.
Xueqing Liu, Yangqiu Song, Shixia Liu, and Haixun Wang. 2012. Automatic taxonomy construction from keywords. In The 18th ACM SIGKDD International Conference on Knowledge Discovery and Data Mining, KDD 12, Beijing, China, August 1216, 2012, pages 1433-1441. ACM.
Anh Tuan Luu, Jung-jae Kim, and See-Kiong Ng. 2014. Taxonomy construction using syntactic contextual evidence. In Proceedings of the 2014 Conference on Empirical Methods in Natural Language Processing, EMNLP 2014, Oct. 25-29, 2014, Doha, Qatar, A meeting of SIGDAT, a Special Interest Group of the ACL, pages 810-819. ACL.
Nikola Mrksic, Diarmuid O'Séaghdha, Tsung-Hsien Wen, Blaise Thomson, and Steve J. Young. 2017. Neural belief tracker: Data-driven dialogue state tracking. In Proceedings of the 55th Annual Meeting of the Association for Computational Linguistics, A C L 2017, Vancouver, Canada, July 30-August 4, Volume 1: Long Papers, pages 1777-1788. Association for Computational Linguistics.
Baolin Peng, Xiujun Li, Lihong Li, Jianfeng Gao, Asli C, elikyilmaz, Sungjin Lee, and Kam-Fai Wong. 2017. Composite task-completion dialogue policy learning via hierarchical deep reinforcement learning. In Proceedings of the 2017 Conference on Empirical Methods in Natural Language Processing, EMNLP 2017, Copenhagen, Denmark, September 911, 2017, pages 2231-2240. Association for Computational Linguistics.
Gustavo Penha and Claudia Hauff. 2020. What does BERT know about books, movies and music? probing BERT for conversational recommendation. In RecSys 2020: Fourteenth ACM Conference on Recommender Systems, Virtual Event, Brazil, Sep. 22-26, 2020, pages 388-397. ACM.
Abhinav Rastogi, Dilek Hakkani-Tur, and Larry P. Heck. 2017. Scalable multi-domain dialogue state tracking. In 2017 IEEE Automatic Speech Recognition and Understanding Workshop, ASRU 2017, Okinawa, Japan, Dec. 16-20, 2017, pages 561-568. IEEE.
Stephen Roller, Emily Dinan, Naman Goyal, Da Ju, Mary Williamson, Yinhan Liu, Jing Xu, Myle Ott, Kurt Shuster, Eric M Smith, et al. 2020. Recipes for building an open domain chatbot. arXiv preprint arXiv:2004.13637.
Pararth Shah, Dilek Hakkani-Tur, Bing Liu, and Gökhan Tür. 2018a. Bootstrapping a neural conversational agent with dialogue self-play, crowdsourc-ing and on-line reinforcement learning. In Proceedings of the 2018 Conference of the North American Chapter of the Association for Computational Linguistics: Human Language Technologies, NAACL-HLT 2018, New Orleans, La., USA, Jun. 1-6, 2018, Volume 3 (Industry Papers), pages 41-51. Association for Computational Linguistics.
Pararth Shah, Dilek Hakkani-Tür, Gökhan Tür, Ab-hinav Rastogi, Ankur Bapna, Neha Nayak, and Larry P. Heck. 2018b. Building a conversational agent overnight with dialogue self-play. CoRR, abs/1801.04871.
Jiaming Shen, Zeqiu Wu, Dongming Lei, Chao Zhang, Xiang Ren, Michelle T. Vanni, Brian M. Sadler, and Jiawei Han. 2018. Hiexpan: Task-guided taxonomy construction by hierarchical tree expansion. In Proceedings of the 24th ACM SIGKDD International Conference on Knowledge Discovery & Data Mining, K D D 2018, London, UK, Aug. 19-23, 2018, pages 2180-2189. ACM.
Wei Shen, Jianyong Wang, and Jiawei Han. 2015. Entity linking with a knowledge base: Issues, techniques, and solutions. IEEE Trans. Knowl. Data Eng., 27(2):443-460.
Pei-Hao Su, Milica Gasic, Nikola Mrksic, Lina Maria Rojas-Barahona, Stefan Ultes, David Vandyke, Tsung-Hsien Wen, and Steve J. Young. 2016. Online active reward learning for policy optimisation in spoken dialogue systems. In Proceedings of the 54th Annual Meeting of the Association for Computational Linguistics, A C L 2016, Aug. 7-12, 2016, Berlin, Germany, Volume 1: Long Papers. The Association for Computer Linguistics.
Kai Sun, Lu Chen, Su Zhu, and Kai Yu. 2014. A generalized rule based tracker for dialogue state tracking. In 2014 IEEE Spoken Language Technology Workshop, S L T 2014, South Lake Tahoe, Nev., USA, Dec. 7-10, 2014, pages 330-335. IEEE.
Yueming Sun and Yi Zhang. 2018. Conversational recommender system. In The 41st International ACM SIGIR Conference on Research & Development in Information Retrieval, SIGIR 2018, Ann Arbor, Mich., USA, Jul. 8-12, 2018, pages 235-244. ACM.
Ashish Vaswani, Noam Shazeer, Niki Parmar, Jakob Uszkoreit, Llion Jones, Aidan N. Gomez, Lukasz Kaiser, and Illia Polosukhin. 2017. Attention is all you need. In Advances in Neural Information Processing Systems 30: Annual Conference on Neural Information Processing Systems 2017, 4-9 Dec. 2017, Long Beach, Calif., USA, pages 5998-6008.
Tsung-Hsien Wen, Milica Gasic, Nikola Mrksic, Pei-hao Su, David Vandyke, and Steve J. Young. 2015. Semantically conditioned lstm-based natural language generation for spoken dialogue systems. In Proceedings of the 2015 Conference on Empirical Methods in Natural Language Processing, EMNLP 2015, Lisbon, Portugal, Sep. 17-21, 2015, pages 1711-1721. The Association for Computational Linguistics.
Tsung-Hsien Wen, Yishu Miao, Phil Blunsom, and Steve J. Young. 2017. Latent intention dialogue models. In Proceedings of the 34th International Conference on Machine Learning, ICML 2017, Sydney, NSW, Australia, 6-11 Aug. 2017, volume 70 of Proceedings of Machine Learning Research, pages 3732-3741. PMLR.
Jason D. Williams, Matthew Henderson, Antoine Raux, Blaise Thomson, Alan W. Black, and Deepak Ra-machandran. 2014. The dialog state tracking challenge series. AI Mag., 35(4): 121-124.
Chien-Sheng Wu, Andrea Madotto, Ehsan Hosseini-Asl, Caiming Xiong, Richard Socher, and Pascale Fung. 2019. Transferable multi-domain state generator for task-oriented dialogue systems. In Proceedings of the 57th Conference of the Association for Computational Linguistics, ACL 2019, Florence, Italy, Jul. 28-Aug. 2, 2019, Volume 1: Long Papers, pages 808-819. Association for Computational Linguistics.
Hu Xu, Seungwhan Moon, Honglei Liu, Bing Liu, Pararth Shah, Bing Liu, and Philip S. Yu. 2020. User memory reasoning for conversational recommendation. CoRR, abs/2006.00184.
Jianguo Zhang, Kazuma Hashimoto, Chien-Sheng Wu, Yao Wan, Philip S. Yu, Richard Socher, and Caim-ing Xiong. 2019. Find or classify? dual strategy for slot-value predictions on multi-domain dialog state tracking. CoRR, abs/1910.03544.
Yongfeng Zhang, Xu Chen, Qingyao Ai, Liu Yang, and W. Bruce Croft. 2018. Towards conversational search and recommendation: System ask, user respond. In Proceedings of the 27th ACM International Conference on Information and Knowledge Management, CIKM 2018, Torino, Italy, October 2226, 2018, pages 177-186. ACM.
Victor Zhong, Caiming Xiong, and Richard Socher. 2018. Global-locally self-attentive encoder for dialogue state tracking. In Proceedings of the 56th Annual Meeting of the Association for Computational Linguistics, ACL 2018, Melbourne, Australia, Jul. 15-20, 2018, Volume 1: Long Papers, pages 1458-1467. Association for Computational Linguistics.

### APPENDIX A: MODEL IMPLEMENTATION AND TRAINING DETAILS

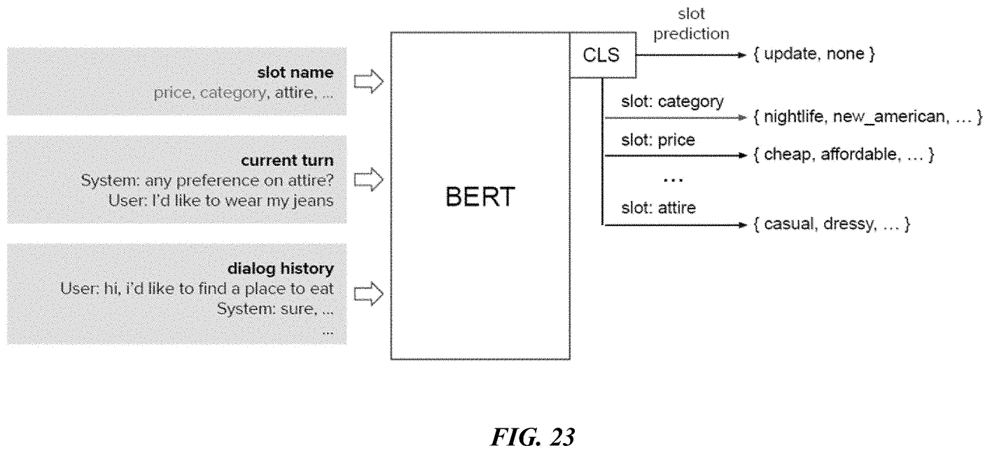

FIG. 23 illustrates an example architecture of the BERT baseline. For each turn, we concatenate each slot with the current turn and the dialogue context as the input. On the [CLS] output, we add one head for slot prediction as binary classification, i.e., whether the input slot is updated in the current turn. For each slot, we add a specific head for value prediction. We use cross entropy loss for slot prediction and mean squared loss for value distribution prediction. The overall loss is a weighted combination of the two losses. We set the weight for value prediction as 20.0. We use BERT-base from the official release; The learning rate is set as 3e-5, batch size as 32. We take the results based on the performance on validation set.

Note that for the slot “food category”, some values are commonly observed in the dataset such as “American food”, “nightlife”, while some others are less frequently such as “Thai”. During training we employ up-sampling for the less frequent ones.

In the construction of NUANCED, we sample a subset of the user history and aggregate to get the ground truth preference distributions. Because the number of viable values of each slot is different, for those slots with relatively more values the distribution generally presents ‘long tail’, we only take the top 3 value distributions for each slot. Correspondingly, during the model evaluation, we also take the top 3 predicted value distributions to calculate the MAE.

### APPENDIX B: CASE STUDIES

### Example 1

Dialogue turn(s):
Assistant: any preference on attire?
User: I like shorts and a loose tee shirt in this heat.
NUANCED
Gold distributions:
attire (casual=1.00, dressy=0.00, formal=0.00)
BERT predictions:
attire (casual=0.99, dressy=0.01, formal=0.00)
NUANCED-reduced
Gold labels:
attire (casual=1.00, dressy=0.00, formal=0.00)
BERT predictions:
attire (casual=1.00, dressy=0.00, formal=0.00)

### Example 2

Dialogue turn(s):
Assistant: any preference on alcohol?
User: I really want a G&T or a Riesling, but I could also have a tonic water.
NUANCED
Gold distributions:
alcohol (full bar=0.78, beer and wine=0.33, don't serve=0.11)
BERT predictions:
alcohol (full bar=0.55, beer and wine=0.47, don't serve=0.09)
NUANCED-reduced
Gold labels:
alcohol (full bar=1.0, beer and wine=1.0, don't serve=1.0)
BERT predictions:
alcohol (full bar=1.0, beer and wine=1.0, don't serve=1.0)

### Example 3

Dialogue turn(s):
Assistant: what parking option would you like?
User: I need something fuss-free and out of the rain for my car, Also, I really want a gin and tonic, but it's not a complete deal-breaker if I can't have it.
NUANCED
Gold distributions:
parking (garage=0.86, valet=0.00, validated=0.00)
alcohol (full bar=0.93, beer and wine=0.21, don't serve=0.14)
BERT predictions:
parking (garage=0.78, valet=0.41, lot=0.34)
alcohol (full bar=0.79, beer and wine=0.17, don't serve=0.12)
NUANCED-reduced
Gold labels:
parking (garage=1.0, valet=0.0, validated=0.0)
alcohol (full bar=1.0, beer and wine=1.0, don't serve=1.0)
BERT predictions:
parking (garage=1.0, valet=1.0, lot=1.0)
alcohol (full bar=1.0, beer and wine=1.0, don't serve=1.0)
(after some turns)
Assistant: here're the recommendations
User: You know what, if it's going to be a fancier place then I don't mind dealing with more complicated parking after all.
NUANCED
Gold distributions:
parking (garage=0.86, valet=0.64, validated=0.21)
BERT predictions:
parking (garage=0.67, valet=0.48, lot=0.40)
NUANCED-reduced Gold labels:
parking (garage=1.0, valet=1.0, validated=1.0)
BERT predictions:
parking (garage=1.0, lot=1.0, validated=1.0).
   Product Identification with Pixel-Level Segmentation Masks

In particular embodiments, the assistant system 140 may be configured to perform product identification with pixel-level segmentation masks by utilizing a co-reference resolution technique together with an unsupervised segmentation algorithm in order to accurately and efficiently identify specific products within images. For particular image datasets, existing product identification techniques may fail to achieve sufficient accuracy (e.g., generating a bounding box for an object that may include background clutter or other objects) or may be prohibitively expensive (e.g., generating pixel-level segmentation masks and manual labels). In particular embodiments, the assistant system 140 may process an image using an unsupervised region proposal generator to identify proposed segmentation masks, apply an image encoder to the segmentation masks to determine region features associated with each segmentation mask, apply a language encoder to text associated with a referenced object within the image along with any relevant metadata to determine text features associated with the object, and identify the correct segmentation mask associated with the referenced object based at least in part on the determined text features and region features. In particular embodiments, the assistant system 140 may train an end-to-end object identification model by constructing unsupervised segmentation loss based on the proposed segmentation masks, construct vision-text loss based on the visual features and text features, and jointly train the model on the constructed supervised segmentation loss and vision-text loss to iteratively improve the accuracy of the object identification model.

In particular embodiments, the assistant system 140 may assist users with image search queries in online platforms having large datasets of images in which each image is associated with a particular object and is accompanied by descriptive text referencing the object. Specifically, the assistant system 140 may identify and associate objects of interest depicted in the images and described by corresponding text captions in order to build comprehensive search indices that permit similar object searches to be conducted on the image dataset. For example, a user of an online marketplace that is interested in identifying and purchasing a particular product may input a text query with keywords related to that product. In response, the assistant system 140 may conduct a similar object search based on the input keywords, identify product listings determined to have images and corresponding descriptive captions related to the product sought by the user, and display the relevant product listings to the user in response to the input query.

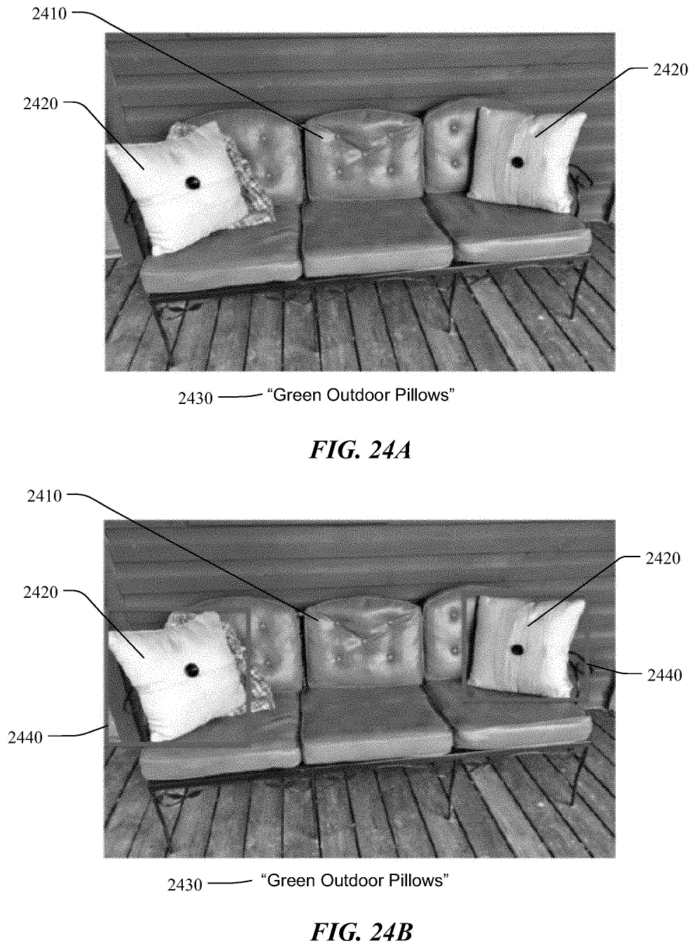

FIGS. 24A and 24B illustrate an example of conventional bounding box annotation techniques. As illustrated in the example image shown in FIGS. 24A and 24B, traditional approaches for identifying objects referenced in a given image typically involve generating a predicted bounding box for an entire object, extracting visual features from the image content within the predicted bounding box, and comparing the extracted visual features to the corresponding text description. However, this approach may also result in extraction of undesired features related to other objects or noise within the predicted bounding box, which may in turn negatively affect the object determination process (e.g., inaccurate entity resolution). For example, FIG. 24A depicts a sample product listing including an image depicting a couch 2410 with green pillows 2420, which is accompanied by the text caption 2430 (“green outdoor pillows”). In this example, the green outdoor pillows 2420 may be an object of interest to users searching for product listings related to outdoor pillows. As shown in FIG. 24B, existing annotation techniques may predict approximate bounding boxes 2440 corresponding to each of the green outdoor pillows 2420 shown within the image. However, it can be observed in FIG. 24B that the approximated bounding boxes 2440 encompass portions of the couch 2410 and surrounding environment in addition to the green outdoor pillows 2420. As a result, extraction of visual features from the image content within the bounding boxes 2440 may produce undesirable data unrelated to the green outdoor pillows 2420.

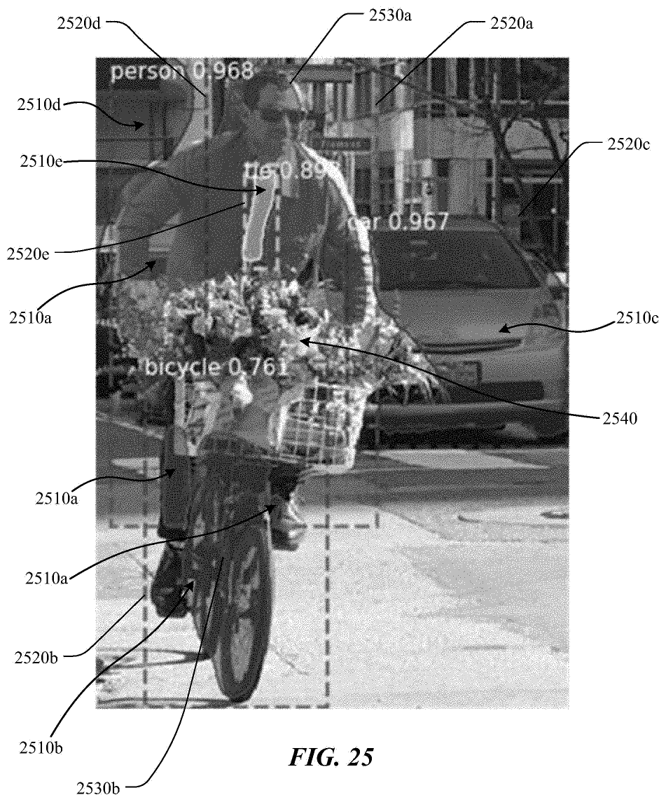

FIG. 25 illustrates an example comparison of bounding box techniques and segmentation mask techniques. In particular embodiments, the problems associated with bounding box techniques as described above may be addressed by utilizing models for generating segmentation masks corresponding to objects depicted in the images. The example image shown in FIG. 25 provides a comparison of how segmentation masks 2510 more accurately identify the pixels in an image that correspond to particular objects 2530 relative to the bounding boxes 2520 generated with conventional annotation techniques. For example, bounding box 2520a corresponding to the rider of the bicycle includes a substantial amount of pixels corresponding to objects in the image other than the rider (e.g., the flowers 2540). In contrast, the three sections of segmentation mask 2510a more accurately capture only the pixels corresponding to the rider of the bicycle, in part by cropping out pixels corresponding to other objects (e.g., the flowers 2540) and other segmentation masks (e.g., segmentation mask 2510b corresponding to the bicycle).

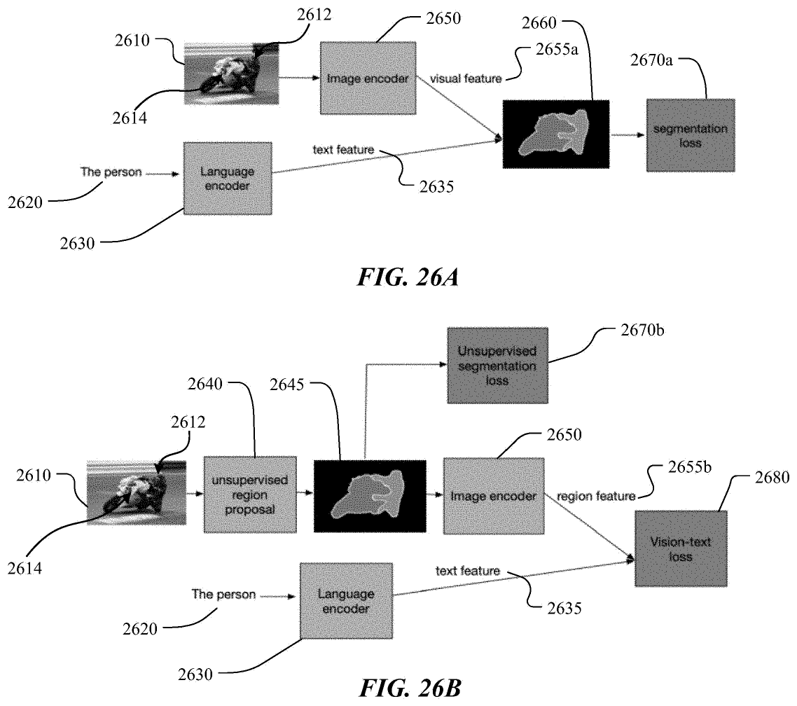

FIGS. 26A and 26B illustrate example processes for performing product identification with pixel-level segmentation masks. In particular, FIG. 26A illustrates an example object identification process which generates segmentation masks for objects depicted in images having corresponding text referencing an object within the image. Image 2610 may depict multiple objects including a motorcycle rider 2612 and a motorcycle 2614, and image 2610 may have a corresponding caption 2620 (“The person”) which is intended to be a reference to the rider 2612 shown in the image. An image encoder 2650 and language encoder 2630 may be respectively utilized to extract visual features 2655a and text features 2635 from the image 2610 and descriptive text 2620. The resulting visual features 2655a and text features 2635 may then be input to a decoder (not shown) in order to predict a segmentation mask 2660 for the referenced object 2612. This segmentation process is made possible due to the model having access to ground truth segmentation masks for at least a subset of the image dataset, which enables the model to determine a segmentation loss 2670a for the predicted segmentation mask 2660 against the ground truth segmentation mask.

In particular embodiments, the segmentation process described above in relation to FIG. 26A may not be viable due to the difficulty or cost of accessing or generating ground truth segmentation masks for particular large datasets, which precludes the ability to determine segmentation loss 2670a and train an effective segmentation model. Thus, without reasonable access to ground truth segmentation masks, to effectively train a model to identify objects in these types of large image datasets, it is necessary to implement techniques focused on performing unsupervised segmentation on the input images. As illustrated in the example process of FIG. 26B, particular implementations may employ an unsupervised region proposal generator 2640 to propose regions 2645 in an unsupervised grid corresponding to image 2610. In particular embodiments, the unsupervised region proposal module 2640 may generate proposed regions 2645 by first utilizing existing bounding box techniques to generate approximate bounding boxes for each object depicted within the image. In this example, unsupervised region proposal module 2640 may be generate bounding boxes for both the motorcycle 2614 and the rider 2612. The unsupervised region proposal module 2640 may then generate proposed segmentation outlines for each of the objects by cropping portions of the generated bounding boxes (e.g., where bounding boxes overlap with each other, the overlapping portions may be cropped from one or more of the overlapping bounding boxes). In this example, a segmentation outline for the rider 2612 is shown in pink, and a segmentation outline for the motorcycle 2614 is shown in green. The resulting output of unsupervised region proposal module 2640 may be the proposed regions 2645 defined by the generated segmentation outlines for each of the objects. In particular embodiments, the object identification model may construct an unsupervised segmentation loss model 2670b based at least in part on the proposed regions 2645 for image 2610 in conjunction with any suitable data accessible to the object identification model (e.g., previously proposed regions 2645 for similar images 2610, subsequently determined accuracy of the object identification for image 2610). In this manner, the object identification model may be trained to predict segmentation masks for images 2610 without relying on any ground truth labels. In particular embodiments, determination of the proposed regions 2645 may not be entirely unsupervised since the object identification model may have access to object labels based on the captioned text 2620 describing the object of interest (and by proxy the proposed region 2645 associated with the object of interest).

In particular embodiments, the proposed regions 2645 output from unsupervised region proposal module 2640 may then be input into image encoder 2650, which may extract one or more visual region feature vectors 2655a for each of the proposed regions 2645 based on image content within the respective proposed region 2645. Separately or concurrently, the descriptive text 2620 may be input into language encoder 2630, which may extract one or more text features 2635 associated with the descriptive text 2620.

In particular embodiments, multiple visual feature vectors 2655b extracted from the proposed regions 2645 and the text feature vector 2635 extracted from the descriptive text 2620 may then be input into a vision-text loss model 2680 to determine, for each extracted visual region feature 2655b, a vision-text loss representing a degree of similarity or difference between the extracted text feature 2635 and the extracted visual region feature 2655b. In particular embodiments, the vision-text loss for a given input feature pair (i.e., a visual feature vector 2655b paired with a text feature vector 2635) may be determined based on a dot product between the visual feature vector 2655b and the text feature vector 2635. The dot product for an input feature pair may represent a normalized distance between the two feature vectors. As a result, the dot product for a positive feature pair (i.e., a feature pair corresponding to the correctly referenced object) may be smaller than the dot product for a negative feature pair. Thus, the vision-text loss determined for each feature pair may be used to determine which proposed region 2645 correctly corresponds to the object 2612 referenced in the captioned text. The vision-text loss model 2680 may be iteratively trained by repeating this process on a large image dataset. In particular embodiments, the unsupervised segmentation loss model 2670b and the visual-text loss model 2680 may be trained jointly, resulting in an end-to-end model for accurately identifying textually referenced products within a given image.

In particular embodiments, the object identification techniques described above may be implemented in conjunction with multi-model input processing scenarios associated with the assistant system 140. For example, a user wearing a camera-enabled smart device (e.g., A/R glasses) may direct their line of sight towards an individual riding a motorcycle and vocalize a request based on an object or entity within their field of vision (e.g., “hey Facebook/assistant, who is the driver?” or “hey assistant, what brand of motorcycle is that?”). The object identification techniques may be utilized in a similar manner as described above by proposing regions and extracting visual region features from the captured video data, extracting text features from the vocalized request, and inputting the feature pairs into a similar vision-text loss model.

In particular embodiments, the object identification techniques described above may be used to improve multi-level text-based image queries in which users add or subtract textual query attributes to iteratively refine their image query to identify pertinent image search results. For example, a user of an online marketplace may input a textual image search for “red dress.” A set of displayed results may include a sleeveless red dress, which may be similar to the product sought by the user. The user may then iteratively modify their image query by adding or subtracting narrowing terms to the existing query. In this example, the user may sequentially append the terms “sleeveless” and then “strapless” to their original image search query for “red dress.” Implementing the object identification techniques described above in this scenario may enable users to better identify images satisfying their changing search criteria (e.g., differentiating between sleeveless and sleeved dresses) because it would limit potentially confounding variables caused by background noise (e.g., other content in the background of the images) that may negatively influence the image search results. Instead, integration of the disclosed object identification techniques would more accurately identify the exact pixels corresponding to the object of interest.

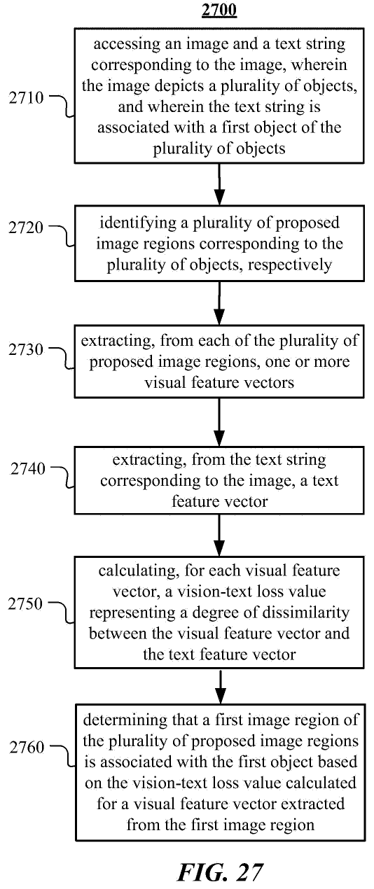

FIG. 27 illustrates an example method 2700 for identifying products with pixel-level segmentations masks. The method may begin at step 2710, where the assistant system 140 may access an image and a text string corresponding to the image, wherein the image depicts a plurality of objects, and wherein the text string is associated with a first object of the plurality of objects. At step 2720, the assistant system 140 may identify a plurality of proposed image regions corresponding to the plurality of objects, respectively. At step 2730, the assistant system 140 may extract, from each of the plurality of proposed image regions, one or more visual feature vectors. At step 2740, the assistant system 140 may extract, from the text string corresponding to the image, a text feature vector. At step 2750, the assistant system 140 may calculate, for each visual feature vector, a vision-text loss value representing a degree of dissimilarity between the visual feature vector and the text feature vector. At step 2760, the assistant system 140 may determine that a first image region of the plurality of proposed image regions is associated with the first object based on the vision-text loss value calculated for a visual feature vector extracted from the first image region. Particular embodiments may repeat one or more steps of the method of FIG. 27, where appropriate. Although this disclosure describes and illustrates particular steps of the method of FIG. 27 as occurring in a particular order, this disclosure contemplates any suitable steps of the method of FIG. 27 occurring in any suitable order. Moreover, although this disclosure describes and illustrates an example method for identifying products with pixel-level segmentation masks including the particular steps of the method of FIG. 27, this disclosure contemplates any suitable method for identifying products with pixel-level segmentation masks including any suitable steps, which may include all, some, or none of the steps of the method of FIG. 27, where appropriate. Furthermore, although this disclosure describes and illustrates particular components, devices, or systems carrying out particular steps of the method of FIG. 27, this disclosure contemplates any suitable combination of any suitable components, devices, or systems carrying out any suitable steps of the method of FIG. 27.

### Fuzzing to Assess Security Properties in Secure Enclaves

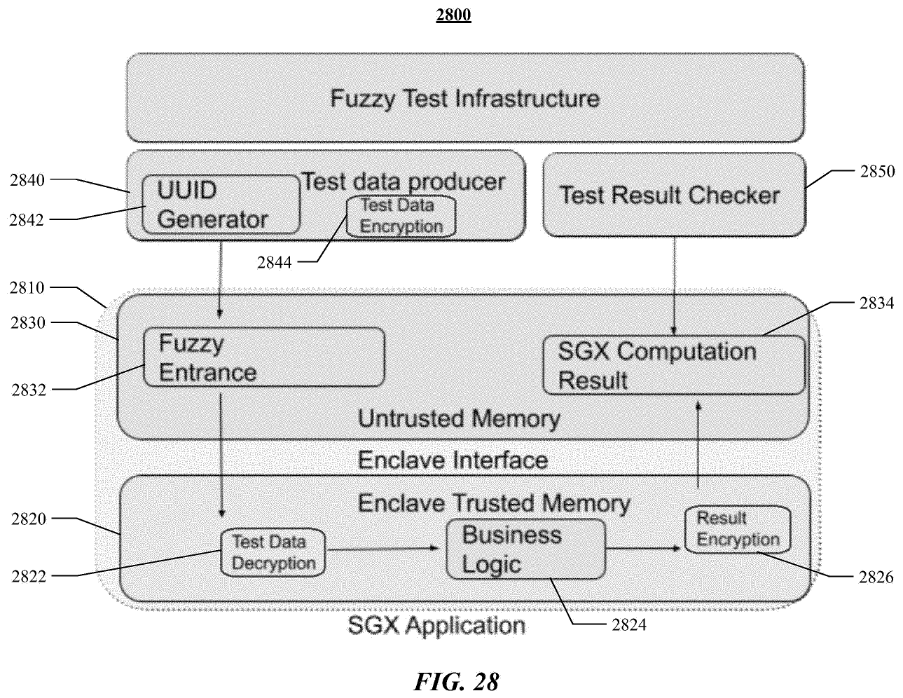

In particular embodiments, the assistant system 140 may implement methods for adapting “fuzzing” automated software testing techniques in software guard extensions (SGX) applications to identify potential privacy violations. FIG. 28 illustrates an example framework for implementing a fuzzy testing infrastructure 2800 to certify privacy protections in an SGX application 2810. In particular embodiments, the fuzzy testing infrastructure 2800 may adapt particular fuzzy testing techniques to ensure that sensitive user data is processed by SGX application 2810 in a privacy-preserving manner. SGX application 2810 may include a “secure enclave” 2820 (i.e., a trusted memory region) and an untrusted memory region 2830. The secure enclave 2820 may use on-the-fly decryption/encryption techniques to ensure that processing within the secure enclave 2820 is secure and private. However, since the secure enclave inputs and outputs are encrypted, existing testing techniques may be unable to determine whether sensitive data (e.g., private user identification information) is being leaked in a readable form within the secure enclave outputs. Particular implementations of this application disclose a fuzzy testing infrastructure 2800 that utilizes universally unique identifiers (UUID) together with generated test data as secure enclave inputs in an SGX application 2810. The fuzzy testing infrastructure 2800 may encrypt the test data and UUID before passing it into the SGX application 2810. The resulting outputs from SGX application 2810 may then be analyzed to determine whether the UUID is detectable within the SGX application outputs in order to determine whether the SGX application 2810 is secure.

In current data center computation models, data is typically encrypted and protected in transit between server and client systems to protect client data (e.g. personal identification information). However, received data generally needs to be decrypted before it can be processed and utilized as intended. As such, received data typically must exist in an unprotected form for some period of time while in the memory of the computing system processing the data. As a result, certain computing models may leave open opportunities for malicious actors to access or otherwise manipulate the computing infrastructure and/or related aspects of the computing process to obtain sensitive user data without authorization. In some cases, this type of privacy violation can be avoided by performing data computations “on-device” (i.e., using computing resources of a user's personal device). However, a user's personal device may have limited computational resources (e.g., CPU, RAM, and storage capacity) which may limit the scope and complexity of on-device computations that can be performed by the user's personal device. For example, certain types of computations may consume undesirable levels of battery power and may generate unacceptable levels of heat. As a result, some types of computations are naturally or necessarily a better fit for data-center computation. These types of computations and processing may include backing up and restoring data, processing large volumes of data, processing involving coordination of multiple cloud-based services, and processing tasks associated with complex machine learning models. Thus, there is a wide range of computational tasks that may involve sensitive user data which need to be processed in a privacy-preserving manner in data-center computing infrastructures.

To address this need, hardware-protected models were developed to protect sensitive data while being processed in data-center computing infrastructures. In particular, SGX applications 2810 were developed to include a secure enclave 2820 which ensured that data within the secure enclave 2820 would be protected and unreadable by processes and entities external to the secure enclave 2820 (e.g., applications running in untrusted memory region 2830). The content of the secure enclave 2820 may be decrypted on the fly exclusively within the secure enclave 2820. This technique allows for highly sensitive client data to be sent to data-centers to be securely processed in a privacy-preserving manner, and is intended to prevent malicious actors from accessing, obtaining, and/or recreating sensitive user data, even in cases where the malicious actor may have back-end access to the data-center infrastructure. In particular embodiments, SGX application 2810 may require API calls to be defined such that data exchanges takes place through a fuzzy entrance 2832 of the untrusted memory region 2830 for data input to the secure enclave 2820, and through SGX computation result module 2834 of the untrusted memory region 2830 for data output from the secure enclave 2820.

Although secure enclave techniques significantly improve the privacy protections for sensitive user data, certain types of data computations may still risk memory security problems in which sensitive data may be indirectly and/or inadvertently leaked from the secure enclave 2820 to the untrusted memory region 2830. For example, the secure enclave 2820 may need to make a call to the untrusted memory region 2830 to share some data (e.g., fetch bookkeeping information from untrusted memory). During this type of data exchange, it's possible that a boundary issue (e.g., step overflow) occurs, resulting in the data being inadvertently written to the untrusted memory region 2830. As another example, an accidental data leak may occur when a process running inside the secure enclave 2820 has a particular library dependency. If the dependency call is reliant on a particular I/O string, a malicious actor may monitor the pertinent library and print or log the file after the data is decrypted in secure enclave 2820. Alternatively, if the dependency call is a function to perform a memory copy, it may be possible for a malicious actor to modify the memory copying function in a manner that compromises the privacy protections for the data processed in secure enclave 2830. As yet another example, in processes involving pointers to a structure containing multiple fields, an overflow issue may result in additional data being written to the pointer without being explicitly checked. Specifically, a buffer may be intended, for example, to only contain 100 bytes, and only a constant number of counters is intended to be written the buffer. In this case, if the length of the pointer is not specified, it's possible that an arbitrary length of counters is written to the buffer and returned to the untrusted memory region 2830 without being flagged by the SGX application 2810 as a potential privacy breach.

The potential privacy violations in secure enclave environments described above can in some cases be addressed based on how the business logic 2824 within the secure enclave 2820 is implemented (i.e., how the business logic 2824 is coded). Specifically, even if sensitive data is protected while being processed within the secure enclave 2820, SGX application 2810 still needs to ensure that the encrypted processed data output from secure enclave 2820 does not inadvertently contain any unencrypted data. To address this issue, a certification process may be implemented to establish a high confidence that the code running inside the secure enclave 2820 is not leaking unprotected data.

Particular embodiments disclosed herein adapt a certification technique known as “fuzzy testing” (aka “fuzzing”) to determine whether secure enclave 2820 may be leaking sensitive data. Fuzzy testing is an existing automated software testing technique that typically involves providing invalid, unexpected, or random data as inputs to a computer program. The program is then monitored for exceptions such as crashes, failing built-in code assertions, or potential memory leaks. A conventional application of fuzzy testing is for programs that take structured inputs in a specified format or protocol, and distinguishes valid inputs from invalid inputs. Fuzzy testing implementations for these types of programs are typically intended to generate semi-valid inputs that are sufficiently valid as to not be directly rejected by the program, which, if accepted, may expose unexpected behaviors and corner cases to be resolved.

In particular embodiments, the assistant system 140 may implement a fuzzy testing infrastructure 2800 to adapt particular fuzzy testing techniques in secure enclave environments by creating a variety of input formats for input test data for secure enclave 2810 in order to identify unprotected output data in untrusted memory region 2830. Specifically, as illustrated in the example framework of FIG. 28, the fuzzy test infrastructure 2800 includes a test data producer 2840 with a universal unique identifier (“UUID”) generator 2842 and a test data encryption module 2844. The test data producer 2840 may generate large volumes of test data inputs which may each be embedded with a distinct universal unique identifier (e.g., a four-digit string “1234”) generated by UUID generator 2842. Each test data input may then be encrypted by test data encryption module 2843 and sent to SGX application 2810. Encrypted test data inputs may be received by fuzzy entrance 2832 in the untrusted memory region 2830 of SGX application 2810, and then transmitted from fuzzy entrance 2832 to the secure enclave 2820 for processing. Encrypted test data inputs may then be decrypted by test data decryption module 2822 using a private key which may be stored within secure enclave 2820. The decrypted test data may then be processed by business logic unit 2824, and then re-encrypted by result encryption module 2826 of the secure enclave 2820. The re-encrypted test data may then be output to a SGX computation module 2834 in the untrusted memory region 2830. The encrypted test data output may then be analyzed in the untrusted memory region 2830 by a test result checker module 2850 of the fuzzy test infrastructure 2800 to ensure that the UUID originally embedded in the corresponding test data input is not detectable within the untrusted memory region 2830. SGX application 2810 may be certified as secure if test result checker module 2850 fails to detect any of the UUIDs generated by UUID generator 2842 within the untrusted memory region 2830.

In particular embodiments, the assistant system 140 may implement fuzzy testing infrastructure 2800 to certify privacy protections in particular secure enclave environments associated with the assistant system 140. In particular embodiments, the assistant system 140 may utilize secure enclaves in applications based on federated learning techniques that use decentralized training methods for machine learning models. At a high level, federated learning leverages on-device machine learning model training across large amounts of user devices together with data-center processing resources to iteratively train machine learning models. Federated learning protects user privacy by transmitting, aggregating, and averaging gradient updates from each user device rather than any sensitive user data. In this case, the fuzzy testing infrastructure 2800 may be implemented by generating large volumes of test gradient data and the corresponding UUIDs may be randomly generated user identifiers. More information on federated learning techniques may be found in U.S. patent application Ser. No. 16/815,2860 and U.S. patent application Ser. No. 16/815,28280, each of which is incorporated by reference. In particular embodiments, the assistant system 140 may utilize secure enclaves in applications utilizing automatic speech recognition module 208 by transmitting encrypted transcriptions from user devices to be processed in a secure enclave of a data-center computing infrastructure. In this case, the fuzzy testing infrastructure 2800 may be implemented by generating large volumes of randomly generated audio test data and the corresponding UUIDs may be randomly generated user identifiers. Although this disclosure describes implementing particular fuzzy testing techniques in particular secure enclave applications for processing particular types of sensitive user data, this disclosure contemplates implementing any suitable fuzzy testing techniques in any suitable secure enclave applications for processing any type of sensitive user data.

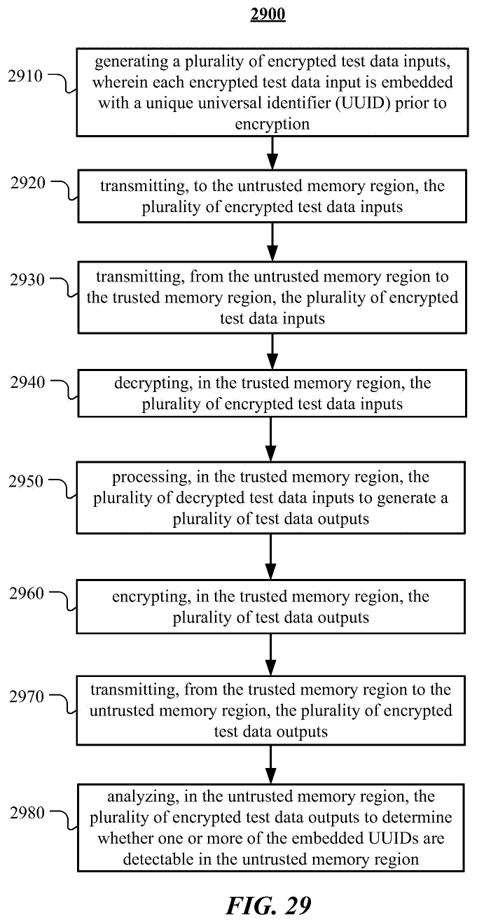

FIG. 29 illustrates an example method 2900 for implementing a fuzzy testing infrastructure to certify privacy protections in a secure enclave application. The method may begin at step 2910, where the assistant system 140 may generate a plurality of encrypted test data inputs, wherein each encrypted test data input is embedded with a unique universal identifier (UUID) prior to encryption. At step 2920, the assistant system 140 may transmit, to the untrusted memory region, the plurality of encrypted test data inputs. At step 2930, the assistant system 140 may transmit, from the untrusted memory region to the trusted memory region, the plurality of encrypted test data inputs. At step 2940, the assistant system 140 may decrypt, in the trusted memory region, the plurality of encrypted test data inputs. At step 2950, the assistant system 140 may process, in the trusted memory region, the plurality of decrypted test data inputs to generate a plurality of test data output. At step 2960, the assistant system 140 may encrypt, in the trusted memory region, the plurality of test data outputs. At step 2970, the assistant system 140 may transmit, from the trusted memory region to the untrusted memory region, the plurality of encrypted test data outputs. At step 2980, the assistant system 140 may analyze, in the untrusted memory region, the plurality of encrypted test data outputs to determine whether one or more of the embedded UUIDs are detectable in the untrusted memory region. Particular embodiments may repeat one or more steps of the method of FIG. 29, where appropriate. Although this disclosure describes and illustrates particular steps of the method of FIG. 29 as occurring in a particular order, this disclosure contemplates any suitable steps of the method of FIG. 29 occurring in any suitable order. Moreover, although this disclosure describes and illustrates an example method for adapting “Fuzzing” automated software testing techniques in secure enclave applications including the particular steps of the method of FIG. 29, this disclosure contemplates any suitable method for adapting “Fuzzing” automated software testing techniques in secure enclave applications including any suitable steps, which may include all, some, or none of the steps of the method of FIG. 29, where appropriate. Furthermore, although this disclosure describes and illustrates particular components, devices, or systems carrying out particular steps of the method of FIG. 29, this disclosure contemplates any suitable combination of any suitable components, devices, or systems carrying out any suitable steps of the method of FIG. 29.

### Identifying Coverage Gaps in Assistant Testing

In particular embodiments, the assistant system 140 may identify coverage gaps in end-to-end (E2E) testing by running a small number of fixed inputs into the assistant system 140 and checking for their expected outputs. Each such gap may represent either an omission in the testing regime or an unexpected user behavior, in which both classes may be useful to planning improvements. The coverage gaps may be useful for determining whether the test behaviors are similar to real user behaviors in distribution. The assistant system 140 may use a generalized extraction engine that observes voice assistant traffic and extracts families of symbol elements that trace the decisions made by the assistant system 140 in carrying out the conversation. The assistant system 140 may extract the same families of symbol-elements from the testing suites and identify the high-frequency (in user-traffic) elements that are not present in the testing-suite symbol-extraction. A set of distinct decision symbols extracted from each interaction in live traffic and a census (distributional estimate) of which decisions are taken by the assistant system 140 may be recorded. The identified coverage gaps may be provided to assistant developers, who may either add new examples to end-to-end testing or adjust the behavior of the assistant system 140. Although this disclosure describes identifying particular coverage gaps by particular systems in a particular manner, this disclosure contemplates identifying any suitable coverage gap by any suitable system in any suitable manner.

The assistant system 140 (e.g., working as voice assistants) may have many interacting parts, each making a complex decision based on inputs from several other subsystems, in a decision tower of interdependent machine-learning parts. Understanding the interactions in this tower of decisions is challenging when working on individual components. This complexity may be more challenging as the contents of the decision tower change over time, with new implementations of existing components and with entirely new components entering the system. Voice assistants may be very complicated pieces of software, involving multiple services, machine learning models, and data-stores operating in close interaction cycles. Testing of the voice assistant may check that the voice assistant responds to expected inputs with expected outputs, but it is difficult to gauge whether the test behaviors are similar to real user behaviors in distribution.

For coverage computations in testing, one may be most interested in determining the most common observatory fingerprint objects in live traffic. But in the coverage universe, one may be even more interested in those fingerprint objects that appear with high frequency and live traffic and do not appear in the test traffic. In general, one may want to know what fraction of live traffic tokens are also found in the test traffic and which are the high-frequency live traffic fingerprints that are not found in the test traffic.

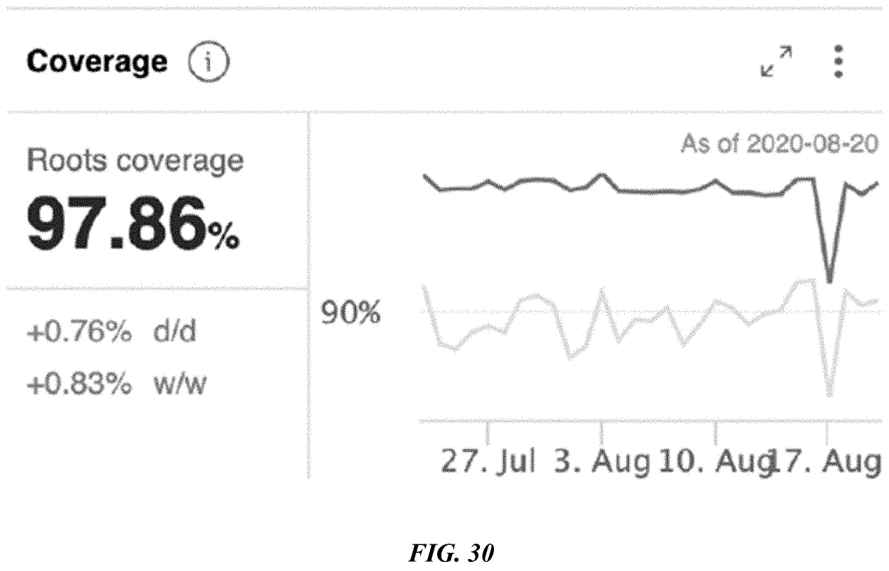

FIG. 30 illustrates an example scoreboard. For a given scorecard (a suite of live-traffic and tests to compare), one may expect to see something illustrated in FIG. 30. This scorecard indicates that 97.86% of the {intent, agent, dialog_act} soot fingerprint tokens in this traffic scorecard had a corresponding fingerprint token appear somewhere in the tests. This summary statistic may be the harmonic mean of the intent.root coverage, agent.root coverage, and dialog_act.root coverage, so the English summary is slightly inaccurate.

The table layout for coverage may comprise:

ao_coverage_by_fingerprint, which indicates, for each fingerprint, what fraction of live traffic (per scorecard) uses that fingerprint and which traffic covers it;

observatory_coverage_scorecard, which is associated with rollups on how well coverage is doing by perspective (key); and

observatory_coverage_rollup, which calculates means across keys (where the roots values come from).

The pipeline may also produce two auxiliary data tables that provide context for (and make it easier to act on) coverage problems:

ao_oracle_coverage_scorecard, which specifies what upper-bound coverage could be with fixed number of symbols; and

ao_coverage_gaps, which indicates highish-volume fingerprints that are missing the coverage.

This pipeline may also produce one upstream input, which is really a set of configuration values:

ao_coverage_scorecard_templates, which specifies how scorecards are calculated.

The scorecards may focus on calculating coverage for all distinct key values. In particular embodiments, the coverage fraction, i.e., what we track as a single scalar for a given component, may represent a statistic of what fraction of the fingerprints in a given traffic stream, that have a given key (e.g. intent.root), and are also observed in a given covering set.

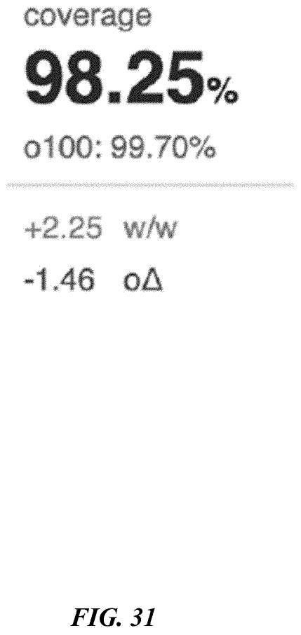

FIG. 31 illustrates an example coverage scorecard. For example, the following from the coverage scorecard dashboard indicates that 98.25% of all the traffic fingerprints that have the intent.root key share that particular intent.root fingerprint with at least one test from the standard tests.

For each key, value, we may calculate coverage with a numerator (the covering distribution) and a denominator (the traffic distribution). When calculating coverage, we may want to compute the covering set, i.e., all those fingerprint symbols that appear in the appropriate test sets. Any particular value of fingerprint from the denominator that also appears in the covering set may be considered covered. To do the calculation of a batch selection, we may want to choose which batches are considered as covering in the calculation. We may use the last run of the day for the designated batches to calculate the covering set for coverage. The pipelines may use a 7-day trailing window from the servers for computation.

Denominator (“to be covered”) distributions may be weighted by how often they appear in a designated traffic sub-stream of the live traffic. Total counts may be interesting, but may be also normalized as a percentage of traffic by key. For intent.root-keyed fingerprints, their daily fraction may be the count of their particular intent.root payload divided by the number of intent.root fingerprints observed in the same stream. These counts and proportions may be usually calculated daily.

The fingerprint key or perspective (e.g. intent.root or dialog_act.skeleton) may represent the particular class of decision recorded in the particular fingerprint. The remainder of the fingerprint object may be the payload, and the distinct values there may represent a low-dimensional abstraction of the particular decision made at that perspective.

To identify coverage gaps, the assistant system 140 may use a generalized extraction engine that observes voice assistant traffic, records interpretable records of the voice-assistant's decisions (decision symbols) from multiple points in the voice-assistant's decision tower, and extracts families of symbol elements that trace the decisions made by the voice assistant in carrying out the conversation. The decision symbols at each point may be extracted into a shared data-store.

Symbols from different parts of the tower may be grouped together as a composed signature (recording the joint behaviors of different parts of the system). This compositional ability may enable data-driven exploration of the interactions (statistical, and by inspection) among disparate tower components without having to introduce logging specific to the particular interaction groups. The symbol language may be extensible, in that new classes of records may be recorded into the same table. When a new component is introduced or an existing component adds decision-symbol logging, the infrastructure may need only record the new decision symbol class, and downstream composition and analytics infrastructure may need no additional work to start to explore this decision symbol class (and its interaction with others).

In particular embodiments, the assistant system 140 may extract the same families of symbol-elements from the testing suites (both manual and automated testing), and identify the high-frequency (in user-traffic) elements that are not present in the testing-suite symbol-extraction. These coverage gaps may be provided to triage and engineering teams. In particular embodiments, each such gap may represent either an omission in the testing regime or an unexpected user behavior, both classes may be useful to planning improvements.

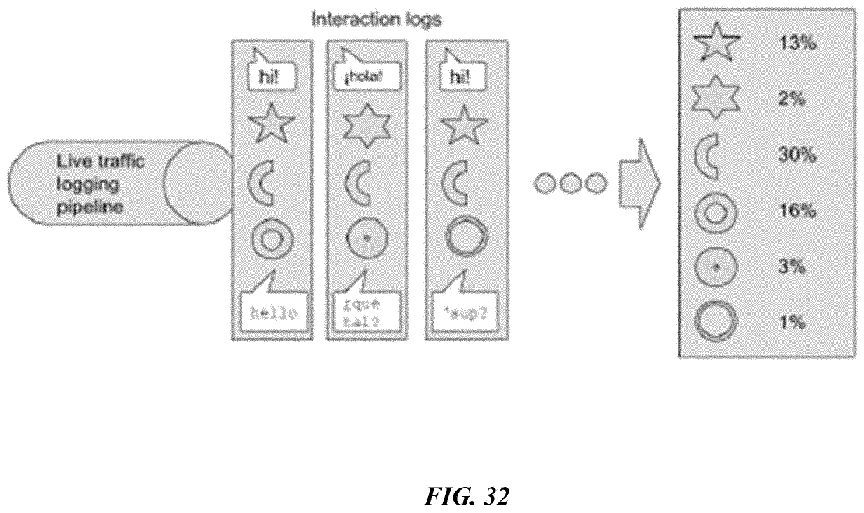

FIG. 32 illustrates example symbol-counts extracted from interaction logs. As suggested by FIG. 32, one can extract a set of distinct decision symbols from each interaction in live traffic and record a census (distributional estimate) of which decisions are taken by the voice assistant.

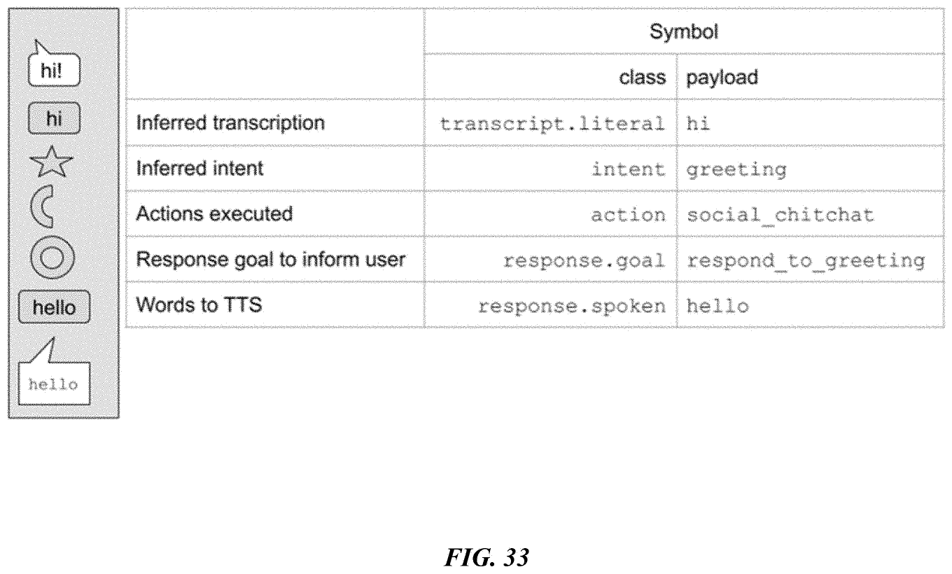

FIG. 33 illustrates example decision symbols. The symbols may represent decisions taken by the voice assistant in the process of a performed interaction. The symbols may be interpretable because they encode both a symbol class and a symbol payload. Each symbol may represent a single internal decision outcome, even though the end-user can only observe the output. Note that the payloads may be discrete symbols themselves (with a definition of legal payload that depends on the class.)

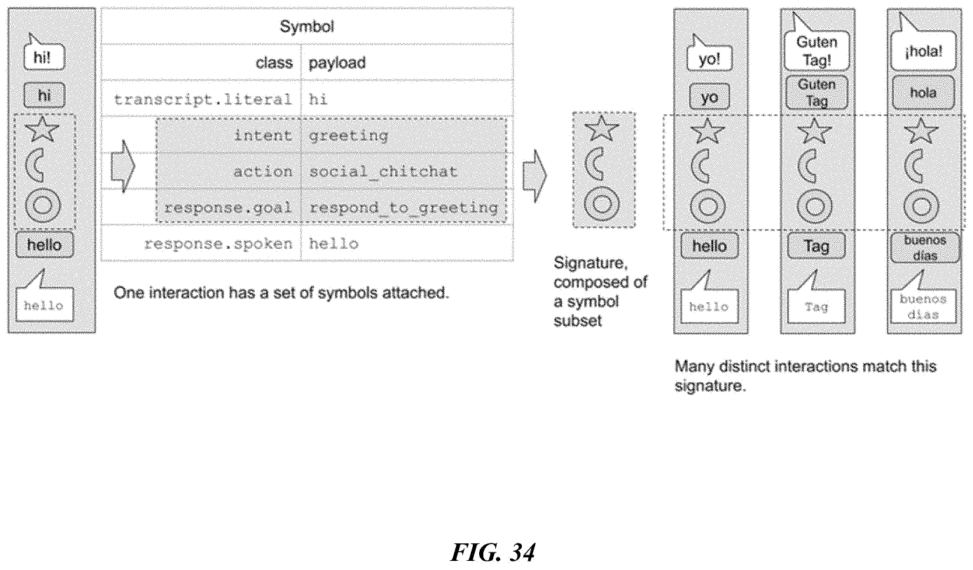

FIG. 34 illustrates an example composing of decision symbols. In particular embodiments, the assistant system 140 may compose decision symbols to represent component interactions. Grouping decision symbols together (composing the symbols) may represent a signature, or a set of decisions that happens together in the same task. This grouping may be used to instrument more than one component of the voice assistant to look for a behavior dependent on more than one decision function.

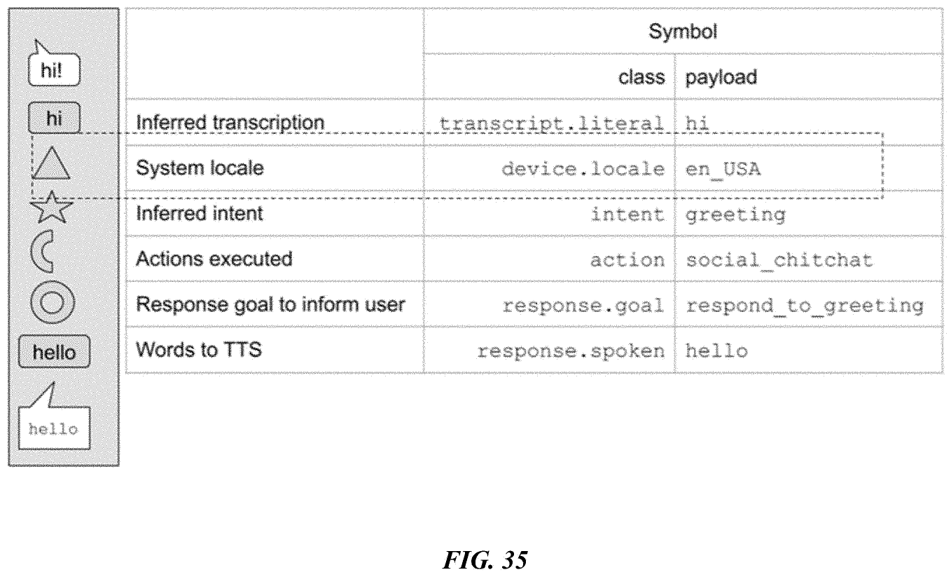

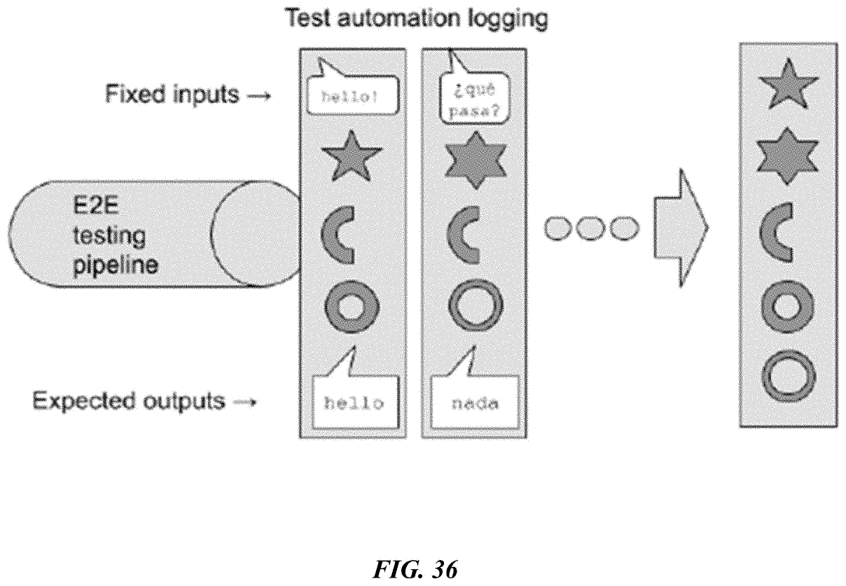

Extending the set of symbols may require introducing a new decision class and defining the shape of that class's payloads. Introducing a new decision class may not interfere with the continued functioning of the existing decision classes (and signatures derived from them), but it may open the door to analyses of other combinations of decision symbols. FIG. 35 illustrates an example extensible set of decision symbols. In FIG. 35, system locale (payload value en_USA) may be also recorded as a new symbol in the same interaction.

FIG. 36 illustrates an example covering inventory from end-to-end tests. In particular embodiments, the assistant system 140 may extract a covering inventory from end-to-end tests. As suggested by FIG. 35, we may perform end-to-end testing by running a small number of fixed inputs into the voice assistant and checking for their expected outputs. We may use the same logging automation used in live traffic to build up an inventory of observed decision symbols.

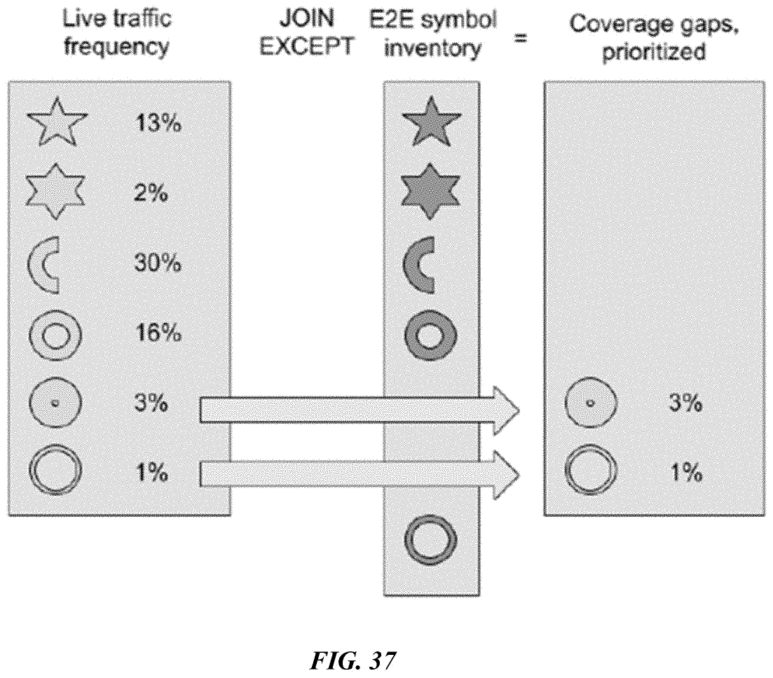

FIG. 37 illustrates an example combination of symbol-counts with covering inventory. Such combination may compute coverage gaps. We may combine these two symbol sets through set subtraction (“JOIN EXCEPT”) to calculate the decision symbols from live traffic that are not exercised by the end-to-end testing.

These coverage gaps may be useful indicators of holes in the testing data, i.e., behaviors that are being induced by live users but not exercised by the end-to-end testing. Voice assistant developers may prioritize the gaps by the decision symbols evoked the most often. To close a gap, a developer may either add new examples to end-to-end testing or adjust the behavior of the assistant system 140 to avoid that decision symbol.

In particular embodiments, a test coverage gap detector tool powered by the assistant system 140 may be provided to users. Using this coverage tool may detect assistant-based messaging behaviors in geographic regions and/or languages that don't seem to be tested server side.

The default settings for the gap detector may be domain=music, locale=en_US, surface=smart_phone. Note that “smart_phone” may be an assistant-based client device. The tool may allow users to update domain, and surface settings. One may reset these to the target messaging, en_US, smart_phone settings with the drop-downs.

The tool may show observed coverage by including internal values, other internal values, and end-to-end testing values. The tool may also show observed coverage by must-pass tests. Many of the tests for smart_phone may be tagged with smart_phone but they may be not yet flagged with must-pass because some of them are still flaky. Users may update the tags by including all the other tags and see updated observed coverage.

The tool may show uncovered fingerprints. For example, a table may be shown listing which fingerprints are not mentioned in the tests, in descending order by weekly percentage of domain/surface/locale/key. Users may select to view details of one of those fingerprints. User may further explore the reach of the fingerprint. With a selected fingerprint, a pane of the tool may show how common that fingerprint is across the selected pools (and also in external traffic).

### Real-Time Parsing of Automatic Speech Recognition

In particular embodiments, the assistant system 140 may implement methods for real-time automatic speech recognition parsing to identify partial intents as a user is speaking and render partial inputs responsive to the identified partial intents. Existing assistant systems typically use end-point detection techniques to determine when a user has finished speaking before processing and executing tasks vocalized by the user. However, waiting to begin processing a user's verbal input until they are finished speaking can result in dissatisfying responsiveness and a discordant user experience. Particular implementations of this application disclose continuous voice comprehension techniques to identify incremental user intents in real-time while a user is speaking. As each partial user intent is identified, the assistant system may respond in real-time by invoking partial tasks and rendering partial outputs. For example, a user may (1) invoke the assistant system 140 with a wake-word, (2) instruct the assistant system 140 to send a message, (3) identify a particular recipient, and (4) dictate the message to be sent (e.g., “Hey Assistant, send a message to Lloyd that I'm running late”). In response, the assistant system 140 may sequentially respond in real-time to each partial input, respectively, by (1) displaying a conversation layer associated with the assistant system 140, (2) rendering a message composition interface, (3) populating the message composition interface with references to possible recipients, and (4) display a real-time transcription of the dictated message. By utilizing continuous voice comprehension to quickly understand the user's intents, the most computationally expensive processing tasks may be performed while the user is speaking, thereby eliminating end-point based response delays and facilitating more organic interactions between the user and the assistant system 140.

Conventionally, assistant systems are perceived as agents configured to complete specific types of tasks once it is invoked. For example, after a conventional assistant system is invoked, the assistant system may receive a complete user request, perform comprehension processing on the complete request to determine a user intent for the assistant system to perform a given task, and then execute the task based on information provided by the user in the complete request. For example, a voice input from a user may be “send a message to John saying ‘Where are you?’” The conventional assistant system may first determine that the user has finished speaking (e.g., by waiting a predetermined time after receiving the last word), perform comprehension processing to determine that the user intent is to send a message that the user has dictated to a contact named John, identify a contact matching the name John in the user's contact list, invoke a message sending agent, provide the message sending agent with a bundled input including the dictated message “Where are you?” and indicating the user intent to send a message to the identified contact, execute the task by sending “Where are you?” to the identified contact, and displaying a user interface associated with the message sending agent which indicates that the dictated message has been sent.

While this is a simple and effective structured method which only requires a single complete input, this approach often results in a negative user experience relative to typical human interactions and conversations. Typical human conversations are often reliant on dynamic indicators to provide the speaker with sufficient grounding (i.e., continuous feedback indicating comprehension). Without adequate grounding, a speaker may assume that the listener is not following the conversation and may naturally stop speaking to confirm whether the listener understands, or worse, may start over again from the beginning. As a task is being spoken, a human listener may intuitively and dynamically understand and respond while someone is speaking based on contextual indicators and interactions, and may indicate their understanding with verbal affirmations that they're still listening (e.g., “uh-huh”, “ok”, “got it”) or employ other subtle forms of grounding (e.g., head nods, body gestures, eye contact) during and/or after the task is spoken. Additionally, humans often already know and have queued up an answer, but only delays until the speaker finishes as a formality or form of social grace. Lastly, humans are naturally able to filter out background noise more effectively than existing assistant systems. For example, a human listener could supplement their understanding of what a speaker is saying based on situational context and non-audio indicators (e.g., hand gestures, lip movement).

In contrast, a first issue with existing assistant system solutions is that, given that the nature of end-pointing is to wait until a complete voice input has been identified before acting on that voice input, without more, existing assistant systems may fail to provide dynamic affirmation that the user's voice input is being received and understood and therefore may not provide users with sufficient grounding that they are being heard and understood. A second issue is that existing assistant systems struggle to perform end-pointing (i.e., determining when a user has finished speaking before responding) as accurately or as quickly as human listeners. Existing end-pointing techniques may simply wait a static period of time after the last utterance or wait a dynamic period of time after the last utterance based on an analysis of intonation of the last utterance (e.g., detecting question-like inflections). In some cases, these techniques can be further improved using existing machine-learning techniques. However, these solutions are generally reliant on timing and/or contextual thresholds, which may contribute to undesirable delays before the assistant system can respond to the user. A third issue is that even after identifying an end-point, assistant systems still need to subsequently determine a user intent, which may further delay the assistant system's response time, especially for long and/or complex voice inputs (e.g., “Send a message to Mary on her home phone in ten minutes and let her know that ‘Dinner is ready’”). For example, existing assistant systems may need to incrementally chunk and process a complex voice input, determine possible user intents for the voice input chunks, and then determine a measure of confidence for the potential user intents before it can even begin to execute the user request. The time needed to perform this processing may further contribute to undesirable delays before the assistant system can respond to the user. Thus, there is a need for an assistant system 140 which can dynamically respond in real-time to streaming input received from a user in order to provide users with grounding and avoid unnecessary response time delays.

In particular embodiments disclosed herein, the assistant system 140 may be configured to dynamically respond to streaming input received from a user. Specifically, the assistant system 140 may continuously monitor and process received voice input from a user, and may determine when a partial vocal input has a sufficiently high measure of confidence that the user intends to invoke and engage with the assistant system 140 (e.g., through detection of a wake word). Following the wake word detection and invocation of the assistant system 140, reasoning module 212a or 212b may cause a visual indicator to be displayed to inform the user that the assistant system 140 is listening to the user's input audio. A new ASR session may then be initiated by ASR 208a or ASR 208b and audio bytes may be continuously streamed from a microphone of the client device into ASR 208a or 208b. ASR 208a or 208b may then quickly output incrementally updated transcriptions of the user's voice input. The output is typically generated within half a second (e.g., ˜400 milliseconds) after the end of a spoken word. The output from ASR 208a or ASR 208b is immediately input to NLU 210a or 210b for comprehension, which quickly determines, if applicable (e.g., for a verbal command to send a message), a user intent (i.e., a representation of the user's desired action). The intent is typically determined within a few milliseconds after receiving the output from ASR 208a or ASR 208b. This disclosure also contemplates utilizing machine learning techniques to further expedite the comprehension processing by NLU 210a or 210b. In particular embodiments, when the assistant system 140 has determined a user intent which lacks a threshold measure of certainty, the assistant system 140 may use communicative indicators to convey that the user intent is still uncertain (e.g., by incrementally phasing in alpha values of the user interface). The assistant system 140 may then continue to monitor and process input received from the user to dynamically update, modify, and improve the response (e.g., transcription of the user's dictated message) generated by the assistant system 140.

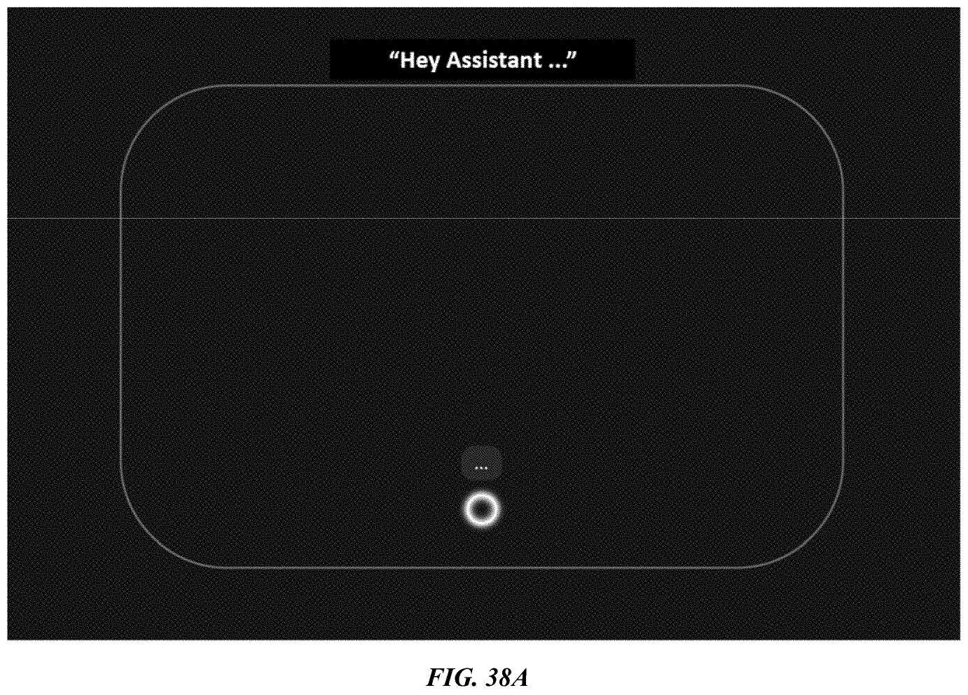

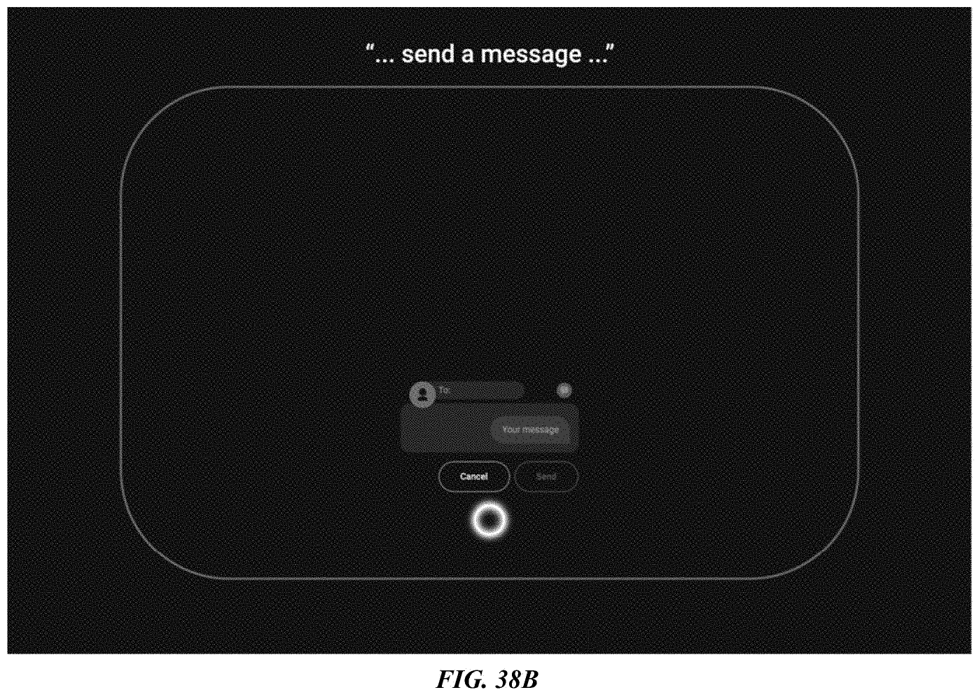

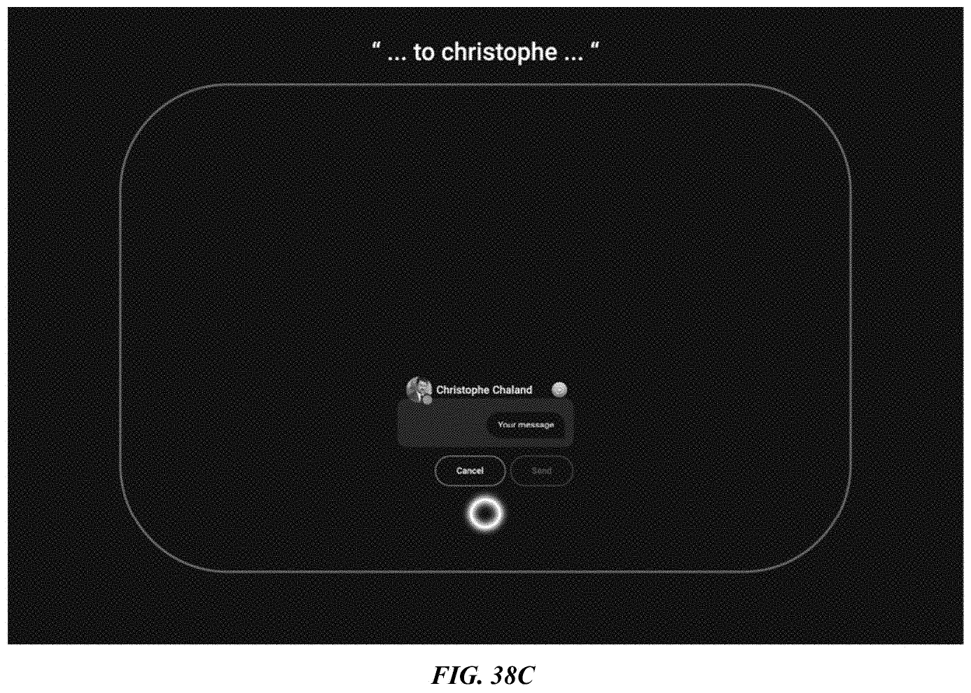

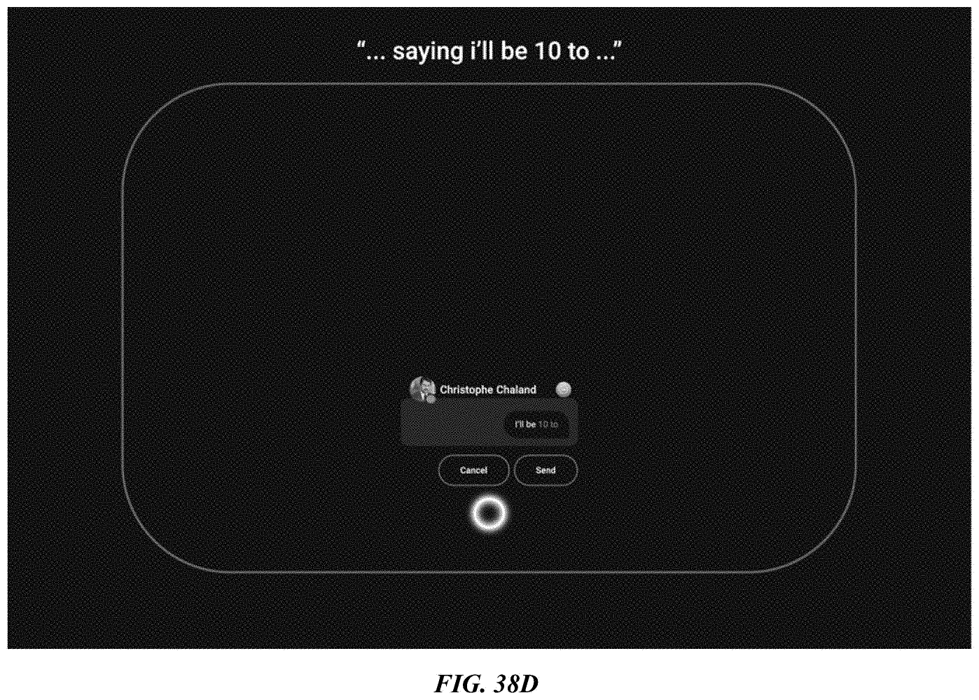

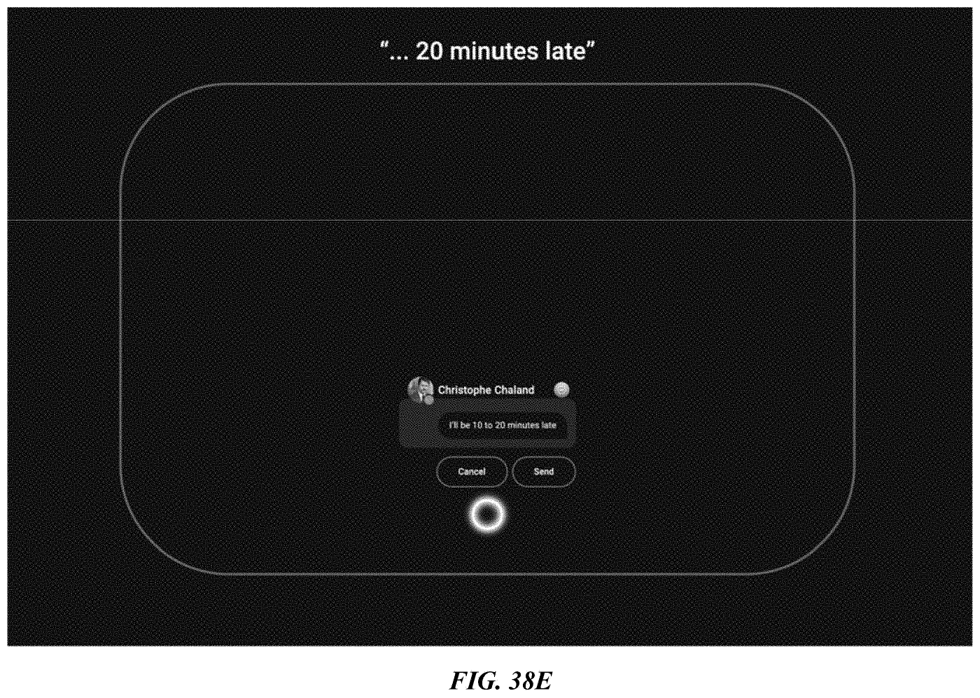

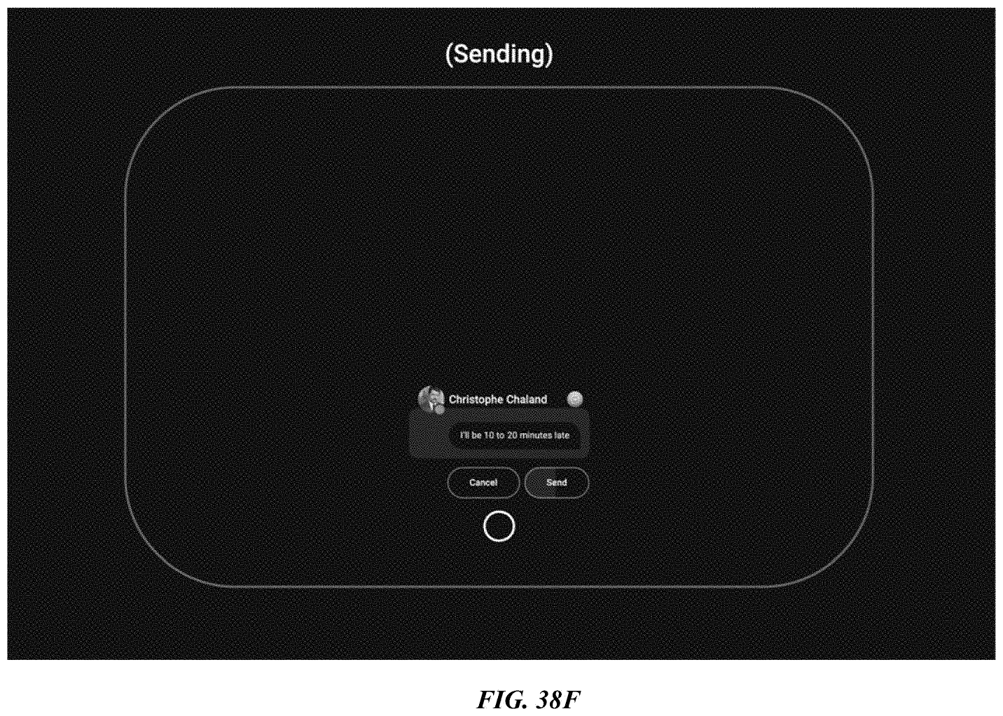

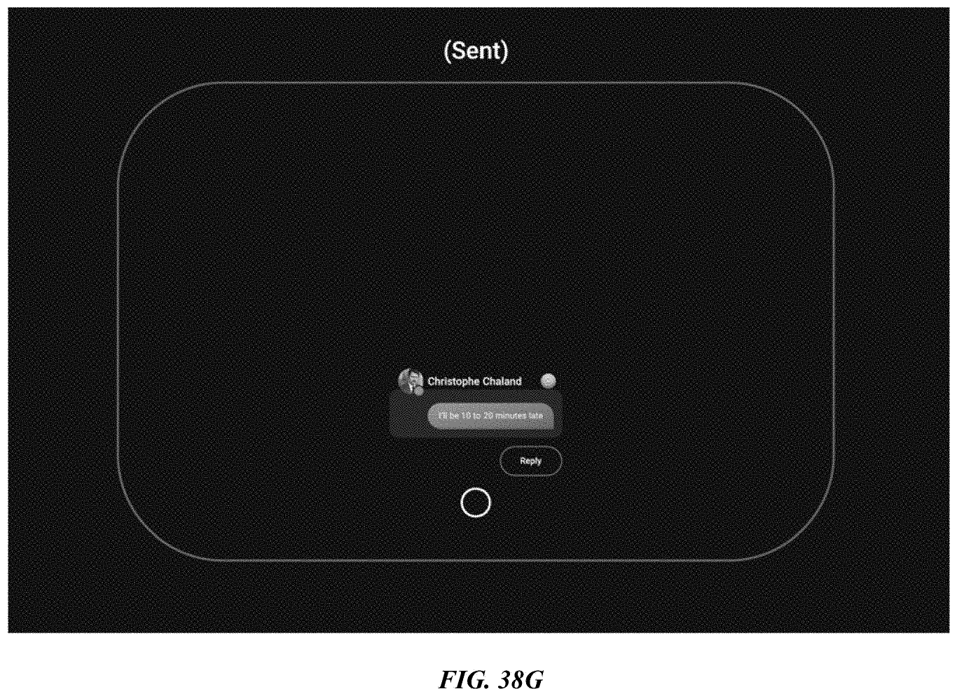

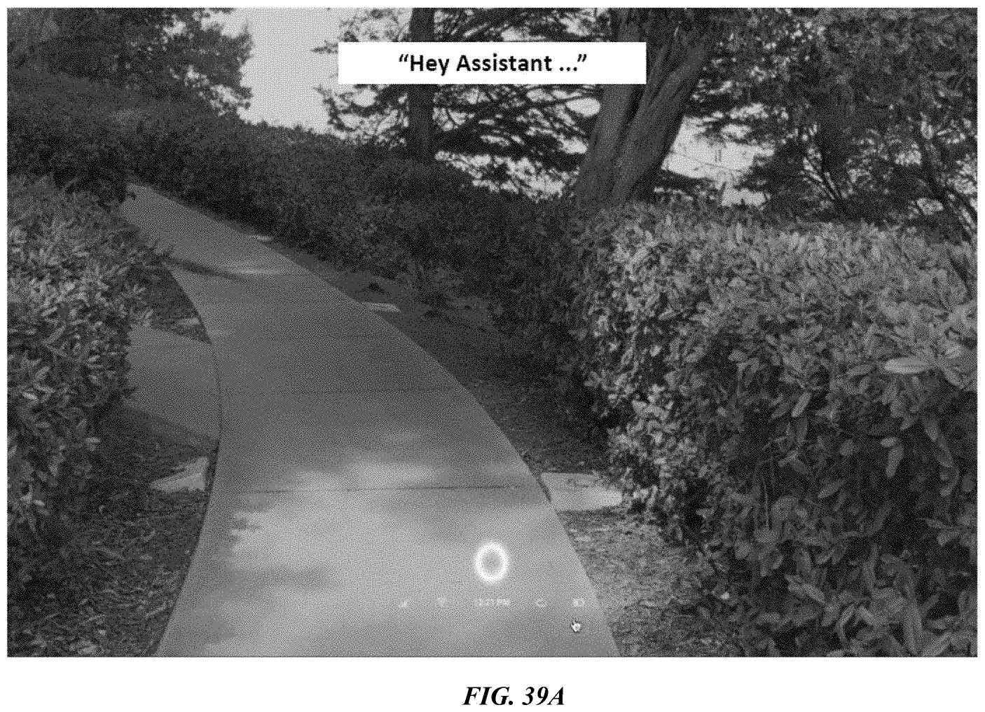

FIGS. 38A-38G illustrate example user interface displays for real-time ASR parsing. In this example, a user's full verbal input may be “Hey Assistant, send a message to Christophe saying ‘I'll be 10 to 20 minutes late.’” As shown in FIG. 38A, when the assistant system 140 detects the wake word in the first portion of the voice input “Hey Assistant . . . ” the assistant system 140 may determine that the user intent is to invoke the assistant system 140. In response, the assistant system 140 may display a conversation layer associated with the assistant system 140. As shown in FIG. 38B, when the assistant system 140 then receives and processes the second portion of the voice input “ . . . send a message . . . ,” the assistant system 140 may determine with a sufficient measure of certainty that the user intent is to invoke a message composition functionality and compose a message to another user. In response or after a short period of time (e.g., 400 ms), the assistant system 140 may display a message composition interface. As shown in FIG. 38C, when the assistant system 140 then receives and processes the third portion of the voice input “ . . . to Christophe . . . ”, the assistant system 140 may perform entity resolution to identify an intended recipient. Identification of the intended recipient may be performed prior to, in parallel with, and/or after the dictated message is transcribed. For example, the assistant system 140 may identify a contact from the user's contact list named Christophe, and display that contact's corresponding image in the message composition interface. Displaying the recipient's full name and profile picture provides the user with implicit entity recognition which allows them to confirm or correct the message recipient. In response, the assistant system 140 may update the message composition interface to indicate the identified contact matching “Christophe.” As shown in FIG. 38D, when the assistant system 140 then receives and processes the fourth portion of the voice input “ . . . saying I'll be 10 to . . . ,” the assistant system 140 may, in real-time, transcribe, and update the message composition interface to display “I'll be 10 to . . . ”. As shown in FIG. 38E, when the assistant system 140 then receives and processes the fifth portion of the voice input “ . . . 20 minutes late,” the assistant system 140 may, in real-time, transcribe, and update the message composition interface to display “I'll be 10 to 20 minutes late.” As shown in FIG. 38F, the assistant system 140 may subsequently determine that the user has finished speaking using any suitable end-pointing technique. In response, the assistant system 140 may update the message composition interface to display a real-time indicator (e.g., filling the “Send” button over time) that the message will be sent shortly. As shown in FIG. 38G, unless the user indicates that they do not wish to send the message (i.e., by activating the “Cancel” button), the assistant system 140 may send the message and display a message interface indicating that the message has been successfully sent as requested. The example user interface display images in FIGS. 38A-38G illustrate the real-time ASR processing, real-time intent comprehension (and/or prediction), real-time transcription, and continuous grounding (e.g., affirmative user interface indicators) that may be implemented and provided by the assistant system 140 to facilitate interactions with users.

Although this disclosure describes and illustrates receiving, processing, and displaying information in a particular manner for particular assistant-related tasks using particular devices, this disclosure contemplates receiving, processing, and displaying information in any suitable manner for any suitable assistant-related tasks on any suitable devices. For example, the techniques disclosed above may be used for tasks unrelated to message composition. In this example, a user's full verbal input may be “What time is it in Denver?” When the assistant system 140 receives and processes “What time . . . ” or “What time is it . . . ”, the assistant system 140 may determine with a sufficient measure of certainty that the user intent is to invoke a time telling functionality and display a current time. In response, the assistant system 140 may display a user interface which indicates a local time. Upon receiving and processing “ . . . in Denver”, the assistant system 140 may modify the previously determined user intent and update the user interface to display the time in Denver in place of or in addition to the local time.

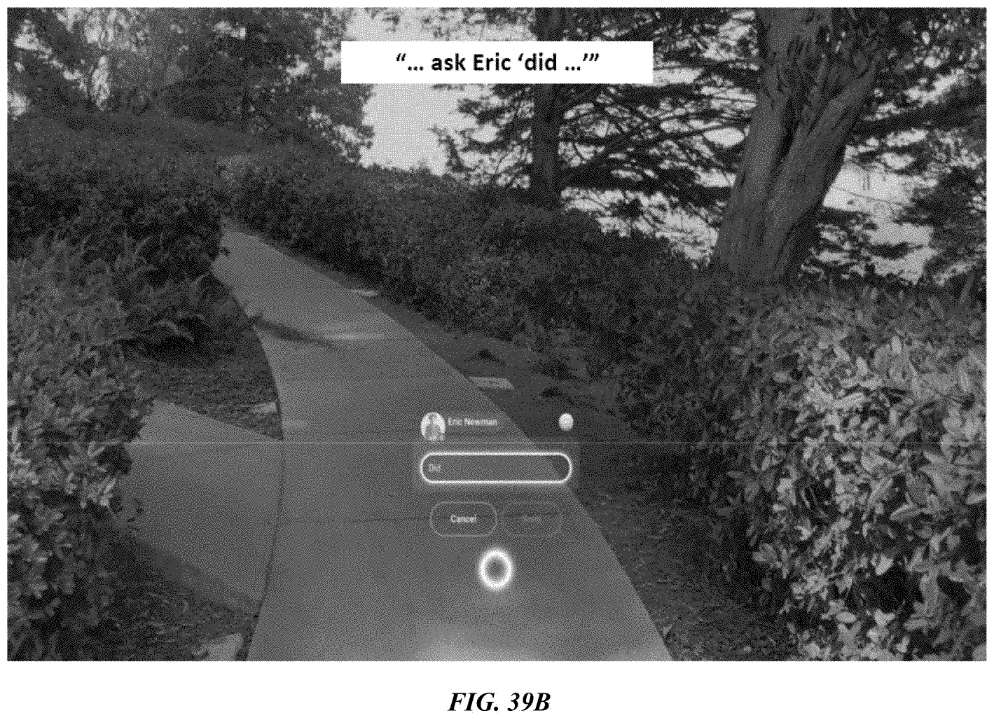

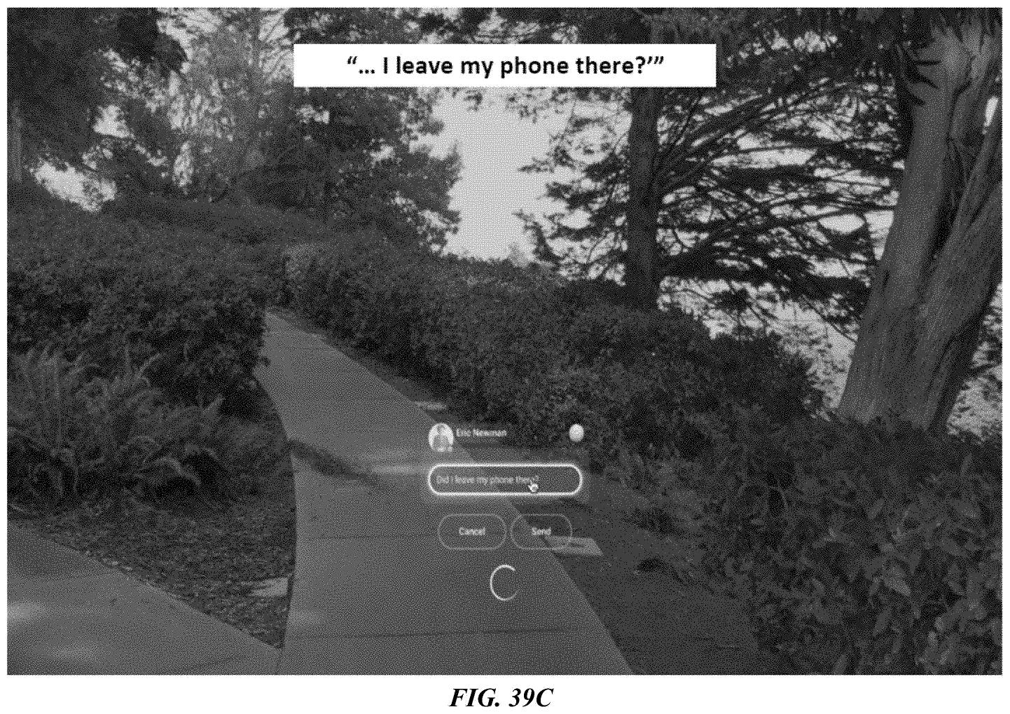

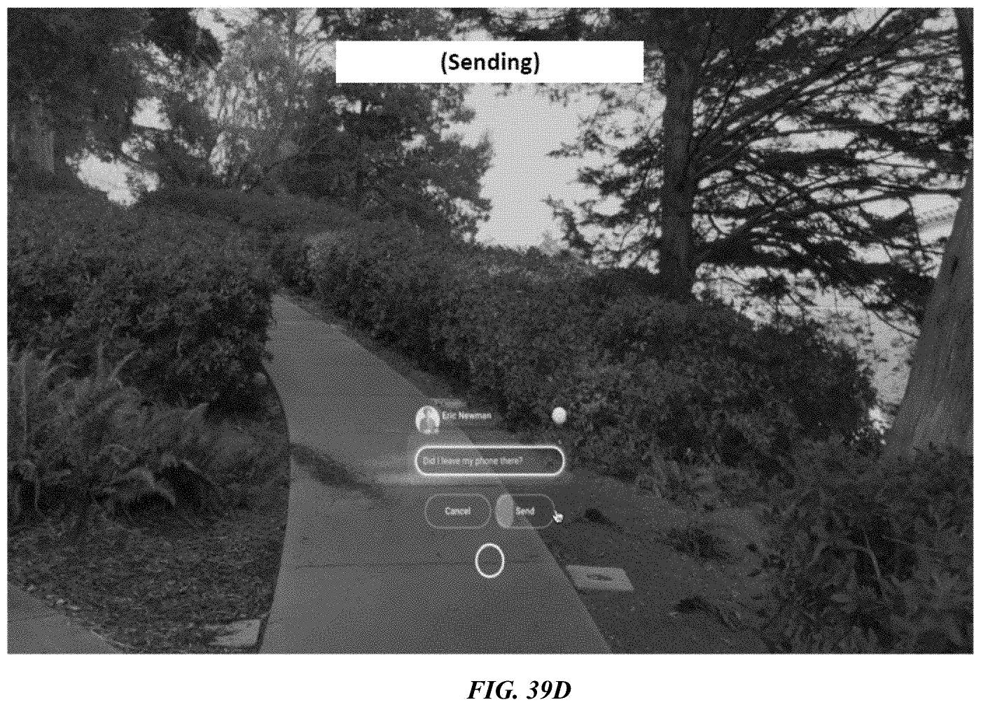

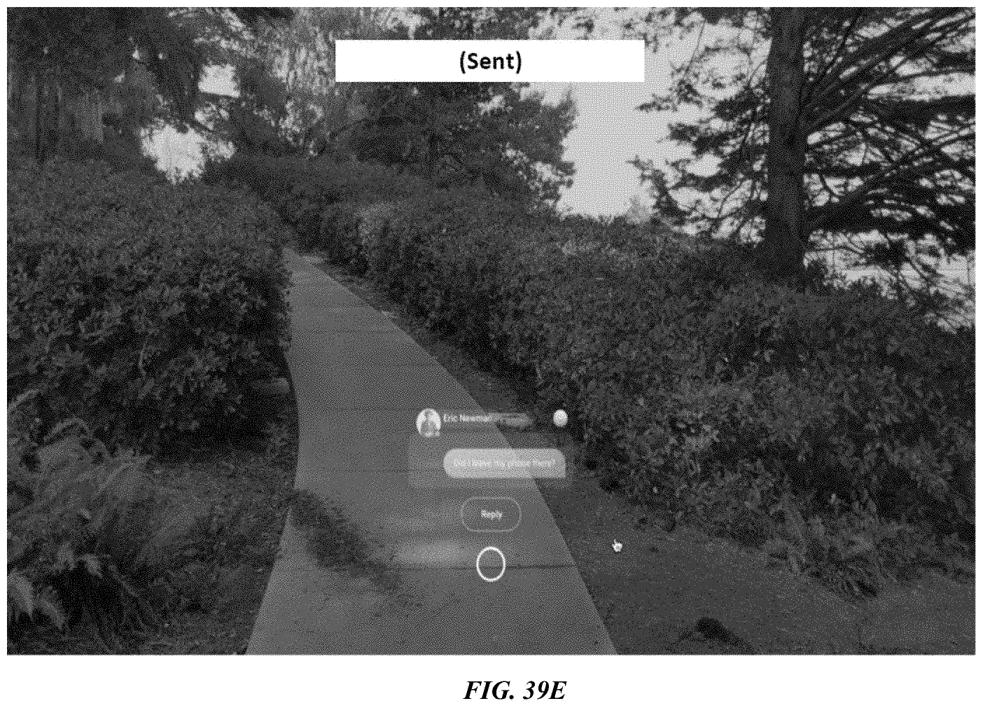

FIGS. 39A-39E illustrate example user interface displays for real-time ASR parsing using multiple devices associated with the assistant system 140. In this example, voice inputs may be received from the user via a first user device (e.g., a smartphone associated with the user) and responsive user interfaces may be dynamically displayed on a second user device (e.g., augmented-reality glasses worn by the user) using similar techniques to those described in relation to FIGS. 38A-38G. As shown in FIG. 39A, when the assistant system 140 detects the wake word in the first portion of the voice input “Hey Assistant . . . ” the assistant system 140 may determine that the user intent is to invoke the assistant system 140. In response, the assistant system 140 may display a conversation layer associated with the assistant system 140. As shown in FIG. 39B, when the assistant system 140 then receives and processes the second portion of the voice input “ . . . ask Eric did . . . ,” the assistant system 140 may determine with a sufficient measure of certainty that the user intent is to invoke a message composition functionality and compose a message to another user. In response or after a short period of time (e.g., 400 ms), the assistant system 140 may display a message composition interface. As further shown in FIG. 39B, the assistant system 140 may perform entity resolution to identify an intended recipient and may update the message composition interface to indicate the identified contact matching “Eric.” As additionally shown in FIG. 39B, the assistant system 140 may, in real-time, transcribe, and update the message composition interface to display “ . . . Did . . . ”. As shown in FIG. 39C, when the assistant system 140 then receives and processes the third portion of the voice input “ . . . I leave my phone there?” the assistant system 140 may, in real-time, transcribe, and update the message composition interface to display “Did I leave my phone there?” As shown in FIG. 39D, the assistant system 140 may subsequently determine that the user has finished speaking using any suitable end-pointing technique. In response, the assistant system 140 may update the message composition interface to display a real-time indicator (e.g., filling the “Send” button over time) that the message will be sent shortly. As shown in FIG. 39E, unless the user indicates that they do not wish to send the message (i.e., by activating the “Cancel” button), the assistant system 140 may send the message and display a message interface indicating that the message has been successfully sent as requested. The example user interface display images in FIGS. 39A-39E illustrate the real-time ASR processing, real-time intent comprehension (and/or prediction), real-time transcription, and continuous grounding (e.g., affirmative user interface indicators) that may be implemented and provided by the assistant system 140 to facilitate interactions with users in a multi-device environment.

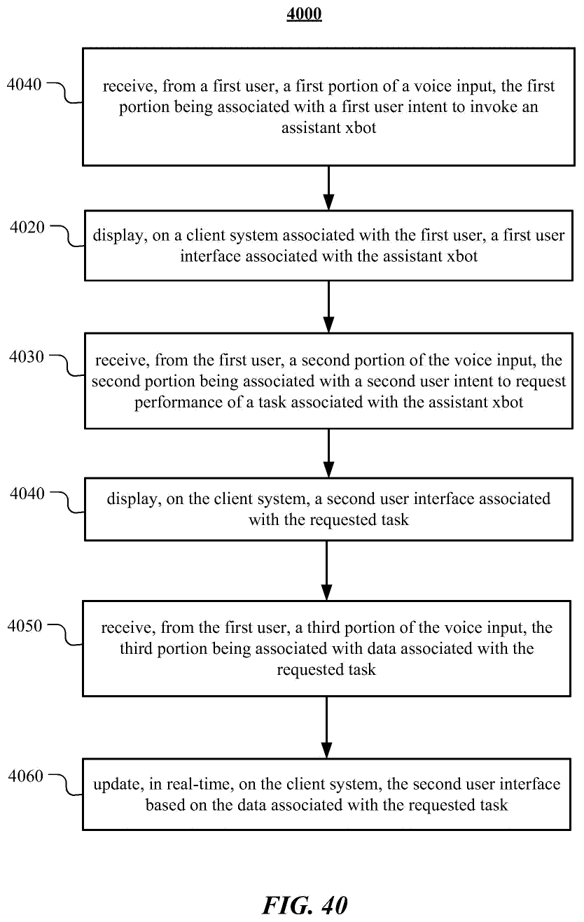

FIG. 40 illustrates an example method 4000 for real-time ASR parsing. The method may begin at step 4010, where the assistant system 140 may receive, from a first user, a first portion of a voice input, the first portion being associated with a first user intent to invoke an assistant xbot. At step 4020, the assistant system 140 may display, on a client system associated with the first user, a first user interface associated with the assistant xbot. At step 4030, the assistant system 140 may receive, from the first user, a second portion of the voice input, the second portion being associated with a second user intent to request performance of a task associated with the assistant xbot. At step 4040, the assistant system 140 may display, on the client system, a second user interface associated with the requested task. At step 4050, the assistant system 140 may receive, from the first user, a third portion of the voice input, the third portion being associated with data associated with the requested task. At step 4060, the assistant system 140 may update, in real-time, on the client system, the second user interface based on the data associated with the requested task. Particular embodiments may repeat one or more steps of the method of FIG. 40, where appropriate. Although this disclosure describes and illustrates particular steps of the method of FIG. 40 as occurring in a particular order, this disclosure contemplates any suitable steps of the method of FIG. 40 occurring in any suitable order. Moreover, although this disclosure describes and illustrates an example method for real-time ASR parsing including the particular steps of the method of FIG. 40, this disclosure contemplates any suitable method for real-time ASR parsing including any suitable steps, which may include all, some, or none of the steps of the method of FIG. 40, where appropriate. Furthermore, although this disclosure describes and illustrates particular components, devices, or systems carrying out particular steps of the method of FIG. 40, this disclosure contemplates any suitable combination of any suitable components, devices, or systems carrying out any suitable steps of the method of FIG. 40.

### Social Graphs

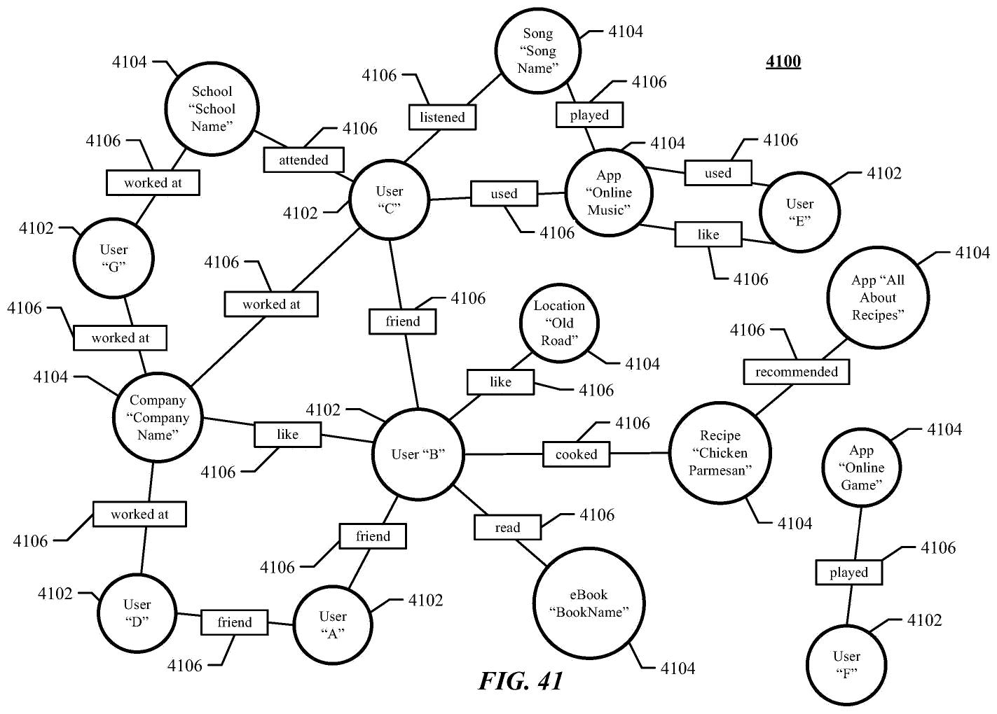

FIG. 41 illustrates an example social graph 4100. In particular embodiments, the social-networking system 160 may store one or more social graphs 4100 in one or more data stores. In particular embodiments, the social graph 4100 may include multiple nodes—which may include multiple user nodes 4102 or multiple concept nodes 4104—and multiple edges 4106 connecting the nodes. Each node may be associated with a unique entity (i.e., user or concept), each of which may have a unique identifier (ID), such as a unique number or username. The example social graph 4100 illustrated in FIG. 41 is shown, for didactic purposes, in a two-dimensional visual map representation. In particular embodiments, a social-networking system 160, a client system 130, an assistant system 140, or a third-party system 170 may access the social graph 4100 and related social-graph information for suitable applications. The nodes and edges of the social graph 4100 may be stored as data objects, for example, in a data store (such as a social-graph database). Such a data store may include one or more searchable or queryable indexes of nodes or edges of the social graph 4100.

In particular embodiments, a user node 4102 may correspond to a user of the social-networking system 160 or the assistant system 140. As an example and not by way of limitation, a user may be an individual (human user), an entity (e.g., an enterprise, business, or third-party application), or a group (e.g., of individuals or entities) that interacts or communicates with or over the social-networking system 160 or the assistant system 140. In particular embodiments, when a user registers for an account with the social-networking system 160, the social-networking system 160 may create a user node 4102 corresponding to the user, and store the user node 4102 in one or more data stores. Users and user nodes 4102 described herein may, where appropriate, refer to registered users and user nodes 4102 associated with registered users. In addition or as an alternative, users and user nodes 4102 described herein may, where appropriate, refer to users that have not registered with the social-networking system 160. In particular embodiments, a user node 4102 may be associated with information provided by a user or information gathered by various systems, including the social-networking system 160. As an example and not by way of limitation, a user may provide his or her name, profile picture, contact information, birth date, sex, marital status, family status, employment, education background, preferences, interests, or other demographic information. In particular embodiments, a user node 4102 may be associated with one or more data objects corresponding to information associated with a user. In particular embodiments, a user node 4102 may correspond to one or more web interfaces.

In particular embodiments, a concept node 4104 may correspond to a concept. As an example and not by way of limitation, a concept may correspond to a place (such as, for example, a movie theater, restaurant, landmark, or city); a website (such as, for example, a website associated with the social-networking system 160 or a third-party website associated with a web-application server); an entity (such as, for example, a person, business, group, sports team, or celebrity); a resource (such as, for example, an audio file, video file, digital photo, text file, structured document, or application) which may be located within the social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 4104 may be associated with information of a concept provided by a user or information gathered by various systems, including the social-networking system 160 and the assistant system 140. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 4104 may be associated with one or more data objects corresponding to information associated with concept node 4104. In particular embodiments, a concept node 4104 may correspond to one or more web interfaces.

In particular embodiments, a node in the social graph 4100 may represent or be represented by a web interface (which may be referred to as a “profile interface”). Profile interfaces may be hosted by or accessible to the social-networking system 160 or the assistant system 140. Profile interfaces may also be hosted on third-party websites associated with a third-party system 170. As an example and not by way of limitation, a profile interface corresponding to a particular external web interface may be the particular external web interface and the profile interface may correspond to a particular concept node 4104. Profile interfaces may be viewable by all or a selected subset of other users. As an example and not by way of limitation, a user node 4102 may have a corresponding user-profile interface in which the corresponding user may add content, make declarations, or otherwise express himself or herself. As another example and not by way of limitation, a concept node 4104 may have a corresponding concept-profile interface in which one or more users may add content, make declarations, or express themselves, particularly in relation to the concept corresponding to concept node 4104.

In particular embodiments, a concept node 4104 may represent a third-party web interface or resource hosted by a third-party system 170. The third-party web interface or resource may include, among other elements, content, a selectable or other icon, or other inter-actable object representing an action or activity. As an example and not by way of limitation, a third-party web interface may include a selectable icon such as “like,” “check-in,” “eat,” “recommend,” or another suitable action or activity. A user viewing the third-party web interface may perform an action by selecting one of the icons (e.g., “check-in”), causing a client system 130 to send to the social-networking system 160 a message indicating the user's action. In response to the message, the social-networking system 160 may create an edge (e.g., a check-in-type edge) between a user node 4102 corresponding to the user and a concept node 4104 corresponding to the third-party web interface or resource and store edge 4106 in one or more data stores.

In particular embodiments, a pair of nodes in the social graph 4100 may be connected to each other by one or more edges 4106. An edge 4106 connecting a pair of nodes may represent a relationship between the pair of nodes. In particular embodiments, an edge 4106 may include or represent one or more data objects or attributes corresponding to the relationship between a pair of nodes. As an example and not by way of limitation, a first user may indicate that a second user is a “friend” of the first user. In response to this indication, the social-networking system 160 may send a “friend request” to the second user. If the second user confirms the “friend request,” the social-networking system 160 may create an edge 4106 connecting the first user's user node 4102 to the second user's user node 4102 in the social graph 4100 and store edge 4106 as social-graph information in one or more of data stores 164. In the example of FIG. 41, the social graph 4100 includes an edge 4106 indicating a friend relation between user nodes 4102 of user “A” and user “B” and an edge indicating a friend relation between user nodes 4102 of user “C” and user “B.” Although this disclosure describes or illustrates particular edges 4106 with particular attributes connecting particular user nodes 4102, this disclosure contemplates any suitable edges 4106 with any suitable attributes connecting user nodes 4102. As an example and not by way of limitation, an edge 4106 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 4100 by one or more edges 4106. The degree of separation between two objects represented by two nodes, respectively, is a count of edges in a shortest path connecting the two nodes in the social graph 4100. As an example and not by way of limitation, in the social graph 4100, the user node 4102 of user “C” is connected to the user node 4102 of user “A” via multiple paths including, for example, a first path directly passing through the user node 4102 of user “B,” a second path passing through the concept node 4104 of company “CompanyName” and the user node 4102 of user “D,” and a third path passing through the user nodes 4102 and concept nodes 4104 representing school “SchoolName,” user “G,” company “CompanyName,” and user “D.” User “C” and user “A” have a degree of separation of two because the shortest path connecting their corresponding nodes (i.e., the first path) includes two edges 4106.

In particular embodiments, an edge 4106 between a user node 4102 and a concept node 4104 may represent a particular action or activity performed by a user associated with user node 4102 toward a concept associated with a concept node 4104. As an example and not by way of limitation, as illustrated in FIG. 41, a user may “like,” “attended,” “played,” “listened,” “cooked,” “worked at,” or “read” a concept, each of which may correspond to an edge type or subtype. A concept-profile interface corresponding to a concept node 4104 may include, for example, a selectable “check in” icon (such as, for example, a clickable “check in” icon) or a selectable “add to favorites” icon. Similarly, after a user clicks these icons, the social-networking system 160 may create a “favorite” edge or a “check in” edge in response to a user's action corresponding to a respective action. As another example and not by way of limitation, a user (user “C”) may listen to a particular song (“SongName”) using a particular application (a third-party online music application). In this case, the social-networking system 160 may create a “listened” edge 4106 and a “used” edge (as illustrated in FIG. 41) between user nodes 4102 corresponding to the user and concept nodes 4104 corresponding to the song and application to indicate that the user listened to the song and used the application. Moreover, the social-networking system 160 may create a “played” edge 4106 (as illustrated in FIG. 41) between concept nodes 4104 corresponding to the song and the application to indicate that the particular song was played by the particular application. In this case, “played” edge 4106 corresponds to an action performed by an external application (the third-party online music application) on an external audio file (the song “SongName”). Although this disclosure describes particular edges 4106 with particular attributes connecting user nodes 4102 and concept nodes 4104, this disclosure contemplates any suitable edges 4106 with any suitable attributes connecting user nodes 4102 and concept nodes 4104. Moreover, although this disclosure describes edges between a user node 4102 and a concept node 4104 representing a single relationship, this disclosure contemplates edges between a user node 4102 and a concept node 4104 representing one or more relationships. As an example and not by way of limitation, an edge 4106 may represent both that a user likes and has used at a particular concept. Alternatively, another edge 4106 may represent each type of relationship (or multiples of a single relationship) between a user node 4102 and a concept node 4104 (as illustrated in FIG. 41 between user node 4102 for user “E” and concept node 4104 for “online music application”).

In particular embodiments, the social-networking system 160 may create an edge 4106 between a user node 4102 and a concept node 4104 in the social graph 4100. As an example and not by way of limitation, a user viewing a concept-profile interface (such as, for example, by using a web browser or a special-purpose application hosted by the user's client system 130) may indicate that he or she likes the concept represented by the concept node 4104 by clicking or selecting a “Like” icon, which may cause the user's client system 130 to send to the social-networking system 160 a message indicating the user's liking of the concept associated with the concept-profile interface. In response to the message, the social-networking system 160 may create an edge 4106 between user node 4102 associated with the user and concept node 4104, as illustrated by “like” edge 4106 between the user and concept node 4104. In particular embodiments, the social-networking system 160 may store an edge 4106 in one or more data stores. In particular embodiments, an edge 4106 may be automatically formed by the social-networking system 160 in response to a particular user action. As an example and not by way of limitation, if a first user uploads a picture, reads a book, watches a movie, or listens to a song, an edge 4106 may be formed between user node 4102 corresponding to the first user and concept nodes 4104 corresponding to those concepts. Although this disclosure describes forming particular edges 4106 in particular manners, this disclosure contemplates forming any suitable edges 4106 in any suitable manner.

### Vector Spaces and Embeddings

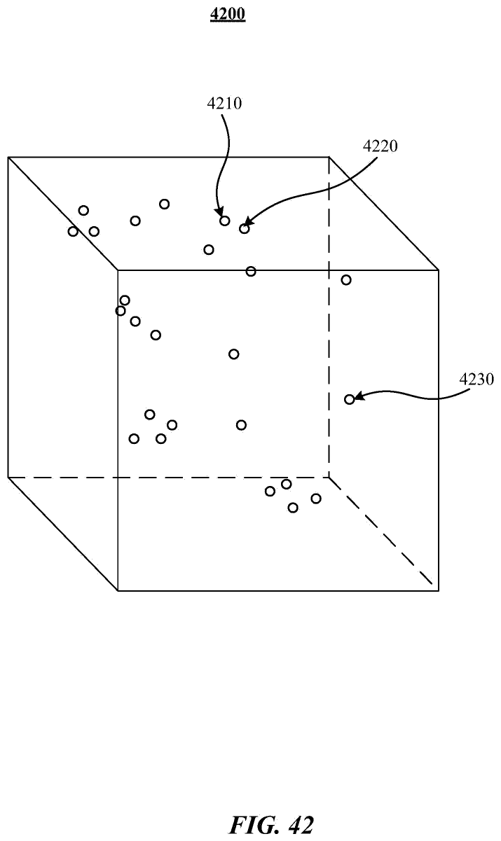

FIG. 42 illustrates an example view of a vector space 4200. In particular embodiments, an object or an n-gram may be represented in a d-dimensional vector space, where d denotes any suitable number of dimensions. Although the vector space 4200 is illustrated as a three-dimensional space, this is for illustrative purposes only, as the vector space 4200 may be of any suitable dimension. In particular embodiments, an n-gram may be represented in the vector space 4200 as a vector referred to as a term embedding. Each vector may comprise coordinates corresponding to a particular point in the vector space 4200 (i.e., the terminal point of the vector). As an example and not by way of limitation, vectors 4210, 4220, and 4230 may be represented as points in the vector space 4200, as illustrated in FIG. 42. An n-gram may be mapped to a respective vector representation. As an example and not by way of limitation, n-grams t₁ and t₂ may be mapped to vectors [symbol] and [symbol] in the vector space 4200, respectively, by applying a function [symbol] defined by a dictionary, such that [symbol] = [symbol] (t₁) and [symbol] = [symbol] (t₂). As another example and not by way of limitation, a dictionary trained to map text to a vector representation may be utilized, or such a dictionary may be itself generated via training. As another example and not by way of limitation, a word-embeddings model may be used to map an n-gram to a vector representation in the vector space 4200. In particular embodiments, an n-gram may be mapped to a vector representation in the vector space 4200 by using a machine leaning model (e.g., a neural network). The machine learning model may have been trained using a sequence of training data (e.g., a corpus of objects each comprising n-grams).

In particular embodiments, an object may be represented in the vector space 4200 as a vector referred to as a feature vector or an object embedding. As an example and not by way of limitation, objects e₁ and e₂ may be mapped to vectors [symbol] and [symbol] in the vector space 4200, respectively, by applying a function [symbol] , such that [symbol] = [symbol] (e₁) and [symbol] = [symbol] (e₂). In particular embodiments, an object may be mapped to a vector based on one or more properties, attributes, or features of the object, relationships of the object with other objects, or any other suitable information associated with the object. As an example and not by way of limitation, a function [symbol] may map objects to vectors by feature extraction, which may start from an initial set of measured data and build derived values (e.g., features). As an example and not by way of limitation, an object comprising a video or an image may be mapped to a vector by using an algorithm to detect or isolate various desired portions or shapes of the object. Features used to calculate the vector may be based on information obtained from edge detection, corner detection, blob detection, ridge detection, scale-invariant feature transformation, edge direction, changing intensity, autocorrelation, motion detection, optical flow, thresholding, blob extraction, template matching, Hough transformation (e.g., lines, circles, ellipses, arbitrary shapes), or any other suitable information. As another example and not by way of limitation, an object comprising audio data may be mapped to a vector based on features such as a spectral slope, a tonality coefficient, an audio spectrum centroid, an audio spectrum envelope, a Mel-frequency cepstrum, or any other suitable information. In particular embodiments, when an object has data that is either too large to be efficiently processed or comprises redundant data, a function i may map the object to a vector using a transformed reduced set of features (e.g., feature selection). In particular embodiments, a function i may map an object e to a vector [symbol] (e) based on one or more n-grams associated with object e. Although this disclosure describes representing an n-gram or an object in a vector space in a particular manner, this disclosure contemplates representing an n-gram or an object in a vector space in any suitable manner.

In particular embodiments, the social-networking system 160 may calculate a similarity metric of vectors in vector space 4200. A similarity metric may be a cosine similarity, a Minkowski distance, a Mahalanobis distance, a Jaccard similarity coefficient, or any suitable similarity metric. As an example and not by way of limitation, a similarity metric of [symbol] and [symbol] may be a cosine similarity

$$\frac{\vec{{v}_{1}} \cdot \vec{{v}_{2}}}{‖ \vec{{v}_{1}} ‖ ‖ \vec{{v}_{2}} ‖} .$$

As another example and not by way of limitation, a similarity metric of [symbol] and [symbol] may be a Euclidean distance ∥ [symbol] − [symbol] ∥. A similarity metric of two vectors may represent how similar the two objects or n-grams corresponding to the two vectors, respectively, are to one another, as measured by the distance between the two vectors in the vector space 4200. As an example and not by way of limitation, vector 4210 and vector 4220 may correspond to objects that are more similar to one another than the objects corresponding to vector 4210 and vector 4230, based on the distance between the respective vectors. Although this disclosure describes calculating a similarity metric between vectors in a particular manner, this disclosure contemplates calculating a similarity metric between vectors in any suitable manner.

More information on vector spaces, embeddings, feature vectors, and similarity metrics may be found in U.S. patent application Ser. No. 14/949,436, filed 23 Nov. 2015, U.S. patent application Ser. No. 15/286,315, filed 5 Oct. 2016, and U.S. patent application Ser. No. 15/365,789, filed 30 Nov. 2016, each of which is incorporated by reference.

### Artificial Neural Networks

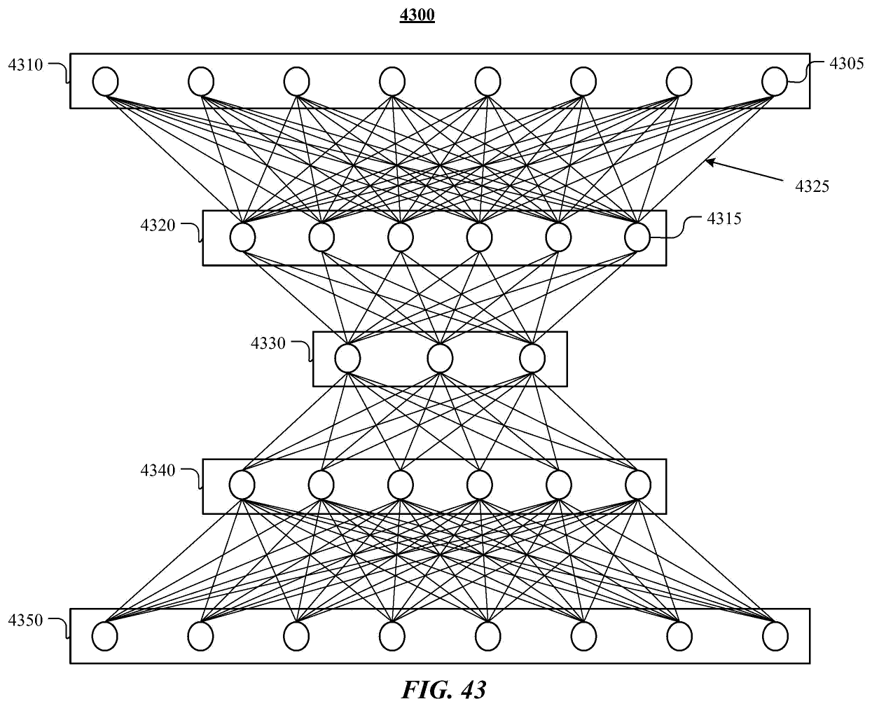

FIG. 43 illustrates an example artificial neural network (“ANN”) 4300. In particular embodiments, an ANN may refer to a computational model comprising one or more nodes. Example ANN 4300 may comprise an input layer 4310, hidden layers 4320, 4330, 4340, and an output layer 4350. Each layer of the ANN 4300 may comprise one or more nodes, such as a node 4305 or a node 4315. In particular embodiments, each node of an ANN may be connected to another node of the ANN. As an example and not by way of limitation, each node of the input layer 4310 may be connected to one of more nodes of the hidden layer 4320. In particular embodiments, one or more nodes may be a bias node (e.g., a node in a layer that is not connected to and does not receive input from any node in a previous layer). In particular embodiments, each node in each layer may be connected to one or more nodes of a previous or subsequent layer. Although FIG. 43 depicts a particular ANN with a particular number of layers, a particular number of nodes, and particular connections between nodes, this disclosure contemplates any suitable ANN with any suitable number of layers, any suitable number of nodes, and any suitable connections between nodes. As an example and not by way of limitation, although FIG. 43 depicts a connection between each node of the input layer 4310 and each node of the hidden layer 4320, one or more nodes of the input layer 4310 may not be connected to one or more nodes of the hidden layer 4320.

In particular embodiments, an ANN may be a feedforward ANN (e.g., an ANN with no cycles or loops where communication between nodes flows in one direction beginning with the input layer and proceeding to successive layers). As an example and not by way of limitation, the input to each node of the hidden layer 4320 may comprise the output of one or more nodes of the input layer 4310. As another example and not by way of limitation, the input to each node of the output layer 4350 may comprise the output of one or more nodes of the hidden layer 4340. In particular embodiments, an ANN may be a deep neural network (e.g., a neural network comprising at least two hidden layers). In particular embodiments, an ANN may be a deep residual network. A deep residual network may be a feedforward ANN comprising hidden layers organized into residual blocks. The input into each residual block after the first residual block may be a function of the output of the previous residual block and the input of the previous residual block. As an example and not by way of limitation, the input into residual block N may be F(x)+x, where F(x) may be the output of residual block N−1, x may be the input into residual block N−1. Although this disclosure describes a particular ANN, this disclosure contemplates any suitable ANN.

In particular embodiments, an activation function may correspond to each node of an ANN. An activation function of a node may define the output of a node for a given input. In particular embodiments, an input to a node may comprise a set of inputs. As an example and not by way of limitation, an activation function may be an identity function, a binary step function, a logistic function, or any other suitable function. As another example and not by way of limitation, an activation function for a node k may be the sigmoid function

$${F}_{k} ( {s}_{k} ) = \frac{1}{1 + {e}^{- {s}_{k}}} ,$$

the hyperbolic tangent function

$${F}_{k} ( {s}_{k} ) = \frac{{e}^{{s}_{k}} - {e}^{- {s}_{k}}}{{e}^{{s}_{k}} + {e}^{- {s}_{k}}} ,$$

the rectifier Fₖ(Sₖ)=max (0, sₖ), or any other suitable function Fₖ(sₖ), where sₖ may be the effective input to node k. In particular embodiments, the input of an activation function corresponding to a node may be weighted. Each node may generate output using a corresponding activation function based on weighted inputs. In particular embodiments, each connection between nodes may be associated with a weight. As an example and not by way of limitation, a connection 4325 between the node 4305 and the node 4315 may have a weighting coefficient of 0.4, which may indicate that 0.4 multiplied by the output of the node 4305 is used as an input to the node 4315. As another example and not by way of limitation, the output yₖ of node k may be yₖ=Fₖ(Sₖ), where Fₖ may be the activation function corresponding to node k, sₖ=Σⱼ(wⱼxⱼ) may be the effective input to node k, xⱼ may be the output of a node j connected to node k, and wⱼₖ may be the weighting coefficient between node j and node k. In particular embodiments, the input to nodes of the input layer may be based on a vector representing an object. Although this disclosure describes particular inputs to and outputs of nodes, this disclosure contemplates any suitable inputs to and outputs of nodes. Moreover, although this disclosure may describe particular connections and weights between nodes, this disclosure contemplates any suitable connections and weights between nodes.

In particular embodiments, an ANN may be trained using training data. As an example and not by way of limitation, training data may comprise inputs to the ANN 4300 and an expected output. As another example and not by way of limitation, training data may comprise vectors each representing a training object and an expected label for each training object. In particular embodiments, training an ANN may comprise modifying the weights associated with the connections between nodes of the ANN by optimizing an objective function. As an example and not by way of limitation, a training method may be used (e.g., the conjugate gradient method, the gradient descent method, the stochastic gradient descent) to backpropagate the sum-of-squares error measured as a distances between each vector representing a training object (e.g., using a cost function that minimizes the sum-of-squares error). In particular embodiments, an ANN may be trained using a dropout technique. As an example and not by way of limitation, one or more nodes may be temporarily omitted (e.g., receive no input and generate no output) while training. For each training object, one or more nodes of the ANN may have some probability of being omitted. The nodes that are omitted for a particular training object may be different than the nodes omitted for other training objects (e.g., the nodes may be temporarily omitted on an object-by-object basis). Although this disclosure describes training an ANN in a particular manner, this disclosure contemplates training an ANN in any suitable manner.

### Privacy

In particular embodiments, one or more objects (e.g., content or other types of objects) of a computing system may be associated with one or more privacy settings. The one or more objects may be stored on or otherwise associated with any suitable computing system or application, such as, for example, a social-networking system 160, a client system 130, an assistant system 140, a third-party system 170, a social-networking application, an assistant application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system 160 or assistant system 140 or shared with other systems (e.g., a third-party system 170). Although this disclosure describes using particular privacy settings in a particular manner, this disclosure contemplates using any suitable privacy settings in any suitable manner.

In particular embodiments, privacy settings may be based on one or more nodes or edges of a social graph 4100. A privacy setting may be specified for one or more edges 4106 or edge-types of the social graph 4100, or with respect to one or more nodes 4102, 4104 or node-types of the social graph 4100. The privacy settings applied to a particular edge 4106 connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system 160. The object may be associated with a concept node 4104 connected to a user node 4102 of the first user by an edge 4106. The first user may specify privacy settings that apply to a particular edge 4106 connecting to the concept node 4104 of the object, or may specify privacy settings that apply to all edges 4106 connecting to the concept node 4104. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system 160 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system 160 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems 170, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers 162 may be authorization/privacy servers for enforcing privacy settings. In response to a request from a user (or other entity) for a particular object stored in a data store 164, the social-networking system 160 may send a request to the data store 164 for the object. The request may identify the user associated with the request and the object may be sent only to the user (or a client system 130 of the user) if the authorization server determines that the user is authorized to access the object based on the privacy settings associated with the object. If the requesting user is not authorized to access the object, the authorization server may prevent the requested object from being retrieved from the data store 164 or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system 160, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system 160 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system 160 or assistant system 140 may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system 160 or assistant system 140 may access such information in order to provide a particular function or service to the first user, without the social-networking system 160 or assistant system 140 having access to that information for any other purposes. Before accessing, storing, or using such objects or information, the social-networking system 160 or assistant system 140 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system 160 or assistant system 140.

In particular embodiments, a user may specify whether particular types of objects or information associated with the first user may be accessed, stored, or used by the social-networking system 160 or assistant system 140. As an example and not by way of limitation, the first user may specify that images sent by the first user through the social-networking system 160 or assistant system 140 may not be stored by the social-networking system 160 or assistant system 140. As another example and not by way of limitation, a first user may specify that messages sent from the first user to a particular second user may not be stored by the social-networking system 160 or assistant system 140. As yet another example and not by way of limitation, a first user may specify that all objects sent via a particular application may be saved by the social-networking system 160 or assistant system 140.

In particular embodiments, privacy settings may allow a first user to specify whether particular objects or information associated with the first user may be accessed from particular client systems 130 or third-party systems 170. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system 160 or assistant system 140 may provide default privacy settings with respect to each device, system, or application, and/or the first user may be prompted to specify a particular privacy setting for each context. As an example and not by way of limitation, the first user may utilize a location-services feature of the social-networking system 160 or assistant system 140 to provide recommendations for restaurants or other places in proximity to the user. The first user's default privacy settings may specify that the social-networking system 160 or assistant system 140 may use location information provided from a client system 130 of the first user to provide the location-based services, but that the social-networking system 160 or assistant system 140 may not store the location information of the first user or provide it to any third-party system 170. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, the social-networking system 160 or assistant system 140 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the social-networking system 160 or assistant system 140. The user's privacy settings may specify that such information may be used only for particular processes, such as authentication, and further specify that such information may not be shared with any third-party system 170 or used for other processes or applications associated with the social-networking system 160 or assistant system 140. As another example and not by way of limitation, the social-networking system 160 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any third-party system 170 or used by other processes or applications associated with the social-networking system 160. As another example and not by way of limitation, the social-networking system 160 may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such image may be used only for a limited purpose (e.g., authentication, tagging the user in photos), and further specify that such image may not be shared with any third-party system 170 or used by other processes or applications associated with the social-networking system 160.

### Systems and Methods

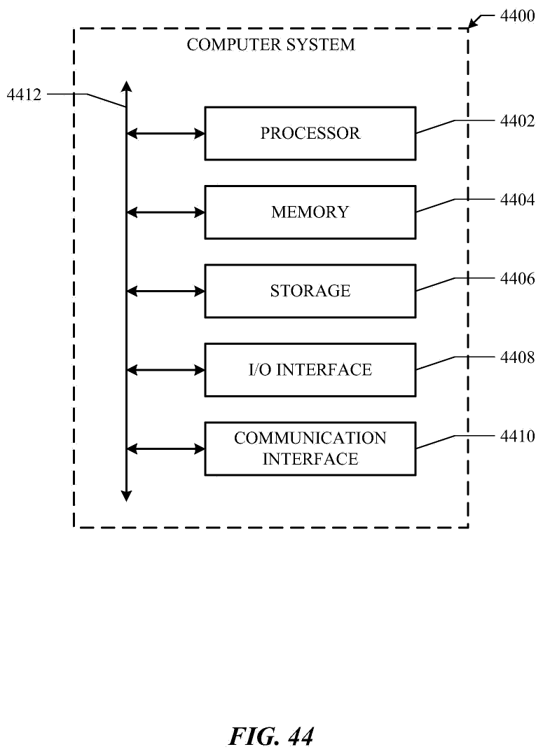

FIG. 44 illustrates an example computer system 4400. In particular embodiments, one or more computer systems 4400 perform one or more steps of one or more methods described or illustrated herein. In particular embodiments, one or more computer systems 4400 provide functionality described or illustrated herein. In particular embodiments, software running on one or more computer systems 4400 performs one or more steps of one or more methods described or illustrated herein or provides functionality described or illustrated herein. Particular embodiments include one or more portions of one or more computer systems 4400. Herein, reference to a computer system may encompass a computing device, and vice versa, where appropriate. Moreover, reference to a computer system may encompass one or more computer systems, where appropriate.

This disclosure contemplates any suitable number of computer systems 4400. This disclosure contemplates computer system 4400 taking any suitable physical form. As example and not by way of limitation, computer system 4400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 4400 may include one or more computer systems 4400; be unitary or distributed; span multiple locations; span multiple machines; span multiple data centers; or reside in a cloud, which may include one or more cloud components in one or more networks. Where appropriate, one or more computer systems 4400 may perform without substantial spatial or temporal limitation one or more steps of one or more methods described or illustrated herein. As an example and not by way of limitation, one or more computer systems 4400 may perform in real time or in batch mode one or more steps of one or more methods described or illustrated herein. One or more computer systems 4400 may perform at different times or at different locations one or more steps of one or more methods described or illustrated herein, where appropriate.

In particular embodiments, computer system 4400 includes a processor 4402, memory 4404, storage 4406, an input/output (I/O) interface 4408, a communication interface 4410, and a bus 4412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 4402 includes hardware for executing instructions, such as those making up a computer program. As an example and not by way of limitation, to execute instructions, processor 4402 may retrieve (or fetch) the instructions from an internal register, an internal cache, memory 4404, or storage 4406; decode and execute them; and then write one or more results to an internal register, an internal cache, memory 4404, or storage 4406. In particular embodiments, processor 4402 may include one or more internal caches for data, instructions, or addresses. This disclosure contemplates processor 4402 including any suitable number of any suitable internal caches, where appropriate. As an example and not by way of limitation, processor 4402 may include one or more instruction caches, one or more data caches, and one or more translation lookaside buffers (TLBs). Instructions in the instruction caches may be copies of instructions in memory 4404 or storage 4406, and the instruction caches may speed up retrieval of those instructions by processor 4402. Data in the data caches may be copies of data in memory 4404 or storage 4406 for instructions executing at processor 4402 to operate on; the results of previous instructions executed at processor 4402 for access by subsequent instructions executing at processor 4402 or for writing to memory 4404 or storage 4406; or other suitable data. The data caches may speed up read or write operations by processor 4402. The TLBs may speed up virtual-address translation for processor 4402. In particular embodiments, processor 4402 may include one or more internal registers for data, instructions, or addresses. This disclosure contemplates processor 4402 including any suitable number of any suitable internal registers, where appropriate. Where appropriate, processor 4402 may include one or more arithmetic logic units (ALUs); be a multi-core processor; or include one or more processors 4402. Although this disclosure describes and illustrates a particular processor, this disclosure contemplates any suitable processor.

In particular embodiments, memory 4404 includes main memory for storing instructions for processor 4402 to execute or data for processor 4402 to operate on. As an example and not by way of limitation, computer system 4400 may load instructions from storage 4406 or another source (such as, for example, another computer system 4400) to memory 4404. Processor 4402 may then load the instructions from memory 4404 to an internal register or internal cache. To execute the instructions, processor 4402 may retrieve the instructions from the internal register or internal cache and decode them. During or after execution of the instructions, processor 4402 may write one or more results (which may be intermediate or final results) to the internal register or internal cache. Processor 4402 may then write one or more of those results to memory 4404. In particular embodiments, processor 4402 executes only instructions in one or more internal registers or internal caches or in memory 4404 (as opposed to storage 4406 or elsewhere) and operates only on data in one or more internal registers or internal caches or in memory 4404 (as opposed to storage 4406 or elsewhere). One or more memory buses (which may each include an address bus and a data bus) may couple processor 4402 to memory 4404. Bus 4412 may include one or more memory buses, as described below. In particular embodiments, one or more memory management units (MMUs) reside between processor 4402 and memory 4404 and facilitate accesses to memory 4404 requested by processor 4402. In particular embodiments, memory 4404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 4404 may include one or more memories 4404, where appropriate. Although this disclosure describes and illustrates particular memory, this disclosure contemplates any suitable memory.

In particular embodiments, storage 4406 includes mass storage for data or instructions. As an example and not by way of limitation, storage 4406 may include a hard disk drive (HDD), a floppy disk drive, flash memory, an optical disc, a magneto-optical disc, magnetic tape, or a Universal Serial Bus (USB) drive or a combination of two or more of these. Storage 4406 may include removable or non-removable (or fixed) media, where appropriate. Storage 4406 may be internal or external to computer system 4400, where appropriate. In particular embodiments, storage 4406 is non-volatile, solid-state memory. In particular embodiments, storage 4406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 4406 taking any suitable physical form. Storage 4406 may include one or more storage control units facilitating communication between processor 4402 and storage 4406, where appropriate. Where appropriate, storage 4406 may include one or more storages 4406. Although this disclosure describes and illustrates particular storage, this disclosure contemplates any suitable storage.

In particular embodiments, I/O interface 4408 includes hardware, software, or both, providing one or more interfaces for communication between computer system 4400 and one or more I/O devices. Computer system 4400 may include one or more of these I/O devices, where appropriate. One or more of these I/O devices may enable communication between a person and computer system 4400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 4408 for them. Where appropriate, I/O interface 4408 may include one or more device or software drivers enabling processor 4402 to drive one or more of these I/O devices. I/O interface 4408 may include one or more I/O interfaces 4408, where appropriate. Although this disclosure describes and illustrates a particular I/O interface, this disclosure contemplates any suitable I/O interface.

In particular embodiments, communication interface 4410 includes hardware, software, or both providing one or more interfaces for communication (such as, for example, packet-based communication) between computer system 4400 and one or more other computer systems 4400 or one or more networks. As an example and not by way of limitation, communication interface 4410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 4410 for it. As an example and not by way of limitation, computer system 4400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 4400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 4400 may include any suitable communication interface 4410 for any of these networks, where appropriate. Communication interface 4410 may include one or more communication interfaces 4410, where appropriate. Although this disclosure describes and illustrates a particular communication interface, this disclosure contemplates any suitable communication interface.

In particular embodiments, bus 4412 includes hardware, software, or both coupling components of computer system 4400 to each other. As an example and not by way of limitation, bus 4412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 4412 may include one or more buses 4412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### MISCELLANEOUS

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing system:
receiving, from a client system associated with a first user, a user input by the first user;
determining, based on the user input, one or more slots associated with the user input;
determining, based on estimated distributions from a plurality of natural responses associated with a plurality of second users, a nuanced distribution for the one or more slots;
determining, based on the nuanced distribution for the one or more slots, one or more tasks; and
sending, to the client system, instructions for presenting execution results associated with one or more of the tasks.

2. A method comprising, by one or more computing systems:
accessing an image and a text string corresponding to the image, wherein the image depicts a plurality of objects, and wherein the text string is associated with a first object of the plurality of objects;
identifying a plurality of proposed image regions corresponding to the plurality of objects, respectively;
extracting, from each of the plurality of proposed image regions, one or more visual feature vectors;
extracting, from the text string corresponding to the image, a text feature vector;
calculating, for each visual feature vector, a vision-text loss value representing a degree of dissimilarity between the visual feature vector and the text feature vector; and
determining that a first image region of the plurality of proposed image regions is associated with the first object based on the vision-text loss value calculated for a visual feature vector extracted from the first image region.

3. A method comprising, by one or more computing systems comprising an untrusted memory region and a trusted memory region:
generating a plurality of encrypted test data inputs, wherein each encrypted test data input is embedded with a unique universal identifier (UUID) prior to encryption;
transmitting, to the untrusted memory region, the plurality of encrypted test data inputs;
transmitting, from the untrusted memory region to the trusted memory region, the plurality of encrypted test data inputs;
decrypting, in the trusted memory region, the plurality of encrypted test data inputs;
processing, in the trusted memory region, the plurality of decrypted test data inputs to generate a plurality of test data outputs;
encrypting, in the trusted memory region, the plurality of test data outputs;
transmitting, from the trusted memory region to the untrusted memory region, the plurality of encrypted test data outputs; and
analyzing, in the untrusted memory region, the plurality of encrypted test data outputs to determine whether one or more of the embedded UUIDs are detectable in the untrusted memory region.

4. A method comprising, by one or more computing systems:
extracting a first set of symbol-elements from a plurality of dialog sessions between an assistant system and a plurality of users;
extracting a second set of symbol-elements from a plurality of testing dialog sessions in a performance test for the assistant system;
identifying one or more coverage gaps based on a comparison between the first and second sets of symbol-elements; and
determining, based on the identified coverage gaps, a performance evaluation of the assistant system.

5. A method comprising, by a client system:
receiving, from a first user, a first portion of a voice input, the first portion being associated with a first user intent to invoke an assistant xbot;
displaying, on the client system associated with the first user, a first user interface associated with the assistant xbot;
receiving, from the first user, a second portion of the voice input, the second portion being associated with a second user intent to request performance of a task associated with the assistant xbot;
displaying, on the client system, a second user interface associated with the requested task;
receiving, from the first user, a third portion of the voice input, the third portion being associated with data associated with the requested task; and
updating, in real-time, on the client system, the second user interface based on the data associated with the requested task.
